(19) United States
(12) Patent Application Publication
(10) Pub. No.: US 2014/0074719 A1
(43) Pub. Date: Mar. 13, 2014

(54) SYSTEM AND METHOD FOR COMPUTERIZED NEGOTIATIONS BASED ON CODED INTEGRITY

(71) Applicant: Fortress GB Ltd., London (GB)

(72) Inventors: Carmi David Gressel, Mobile Post Negev (IL); Richard Daniel Pinnick, London (GB); Nicolas Tadeus Courtois, Ipswich (GB); Gabriel Vago, London (GB); Gregory Van Bard, Menomonie, WI (US); Ran Granot, Yavne (IL); Avi Hecht, Nesher (IL)

(21) Appl. No.: 13/945,616

(22) Filed: Jul. 18, 2013

Related U.S. Application Data
(63) Continuation of application No. PCT/IL2012/000028, filed on Jan. 17, 2012.
(60) Provisional application No. 61/461,244, filed on Jan. 18, 2011.

(51) Int. Cl. G06Q 20/38; H04L 29/06

(52) U.S. Cl. CPC G06Q 20/3827; H04L 63/0428
USPC 705/64; 713/168

(57) ABSTRACT

An accelerated transparent authenticated Data Exchange system wherein the chronology of alternating senders' and receivers' messages are authenticated typically at each step, with an easy to use provision for resending, in the event of faulty transmission, such that the final message hash value authenticates the negotiation chronologically from first to final message, wherein the final hash value is operative to enable a signature of an entity or entities which binds such entity to the whole data exchange, which signature can be in clear text, encoded, and/or encrypted with authentication integrity. The system is useful for managing computerized negotiations including client-initiated computerized negotiations and including computerized financial transactions.

### REFERENCE TO COPENDING PATENT APPLICATIONS

Priority is claimed from U.S. Ser. No. 61/461,244 filed 18 Jan. 2011 and entitled “System of Customer Generated Vouchers and Automated Negotiation . . . ”.
U.S. Ser. No. 11/578,929 describes the obtaining of multi-factor security using portable electronic devices.
U.S. Ser. No. 12/161,833 describes a system of accepting value from people in a closed group, easily identified by Token IDs.
U.S. Ser. No. 11/578,076 described a system for security profiling users in a closed system. Abandoned.
U.S. Ser. No. 12/439,556 describes a system for message authentication, with proven preclusion of modified messages, based on stream cipher architecture and orthogonal feedbacks.
U.S. Ser. No. 12/322,766 describes a loyalty incentive system wherein users' points determine user status, and where users benefit from incremented privileged status from accrued never spent points benefitting from sustained average purchasing.
PCT IL/2010/000075 describes a generic compact symmetric silicon Stream Cipher & Hash Generator format for simultaneous Encryption with Integrity

### FIELD OF THE INVENTION

The present invention relates generally to computerized systems and more particularly to methods for communicating network computerized data with integrity between users of computerized systems.

### BACKGROUND OF THE INVENTION

The following publications are believed to represent relevant prior and/or state of the art:
U.S. Pat. No. 7,827,232 and GB 2,430,593 describe a robust symmetric hardware stream cipher/RNG architecture.
U.S. Pat. No. 7,852,162 describes generation of True Random & Discrete Random Noise, operative to control 14 permutations in U.S. Pat. No. 7,827,232.
U.S. Pat. No. 6,360,321 describes a sealed socket in which are embedded a security chip controlling access and communications to a computer's CPU, the first chip activated by a trusted 3^{rd} party protected Public Key Smart Card.
U.S. Pat. No. 6,609,114 describes a “Kirchhoff” public key cryptographic payment scheme used to prevent fraudulent “printing” of money
U.S. Pat. No. 6,749,115 describes a dual processor secured architecture wherein the security chip accesses isolated and/or encrypted program and data memory.
E. Biham & O. Dunkelman, A Framework for Iterative Hash Functions, NIST Hash Forum 2006, Santa Barbara.
E. Biham & O. Dunkelman, Differential Cryptanalysis in Stream Ciphers, Technion CS 2007.
S. Vaudenay, A Classical Introduction to Cryptography, Springer, New York, 2006.
O. Dunkelman, A. Hecht, The ZK-Crypt Security Analysis, eSTREAM website, version 3, January 2007

The disclosures of all publications and patent documents mentioned in the specification, and of the publications and patent documents cited therein directly or indirectly, are hereby incorporated by reference.

### SUMMARY OF CERTAIN EMBODIMENTS OF THE INVENTION

The following terms may be construed either in accordance with any definition thereof appearing in the prior art literature or in accordance with the specification, or as follows:
All ‘5’ Word Encrypted Text HV/Tag Detect, All ‘5’ Word Count & Interrupt—during all valid TX/RX ZK-Crypt procedures, at each Primary Clock following Initialization, TX & RX Cipher Mask outputs (and all State Variables in the Engines, with the exception of the Message inputs and the Cipher/Clear Text output Words) are identical. Stated differently, as in conventional Stream Ciphering, the Deterministic Random Number generating engines of the sender and receiver, must, at each clock cycle be maintained with identical Chaining Values.
   An All ‘5’ Word sequence is the Hash Value/Tag generator of the ZK-Crypt. TX encrypts the Hash Value; if all is well, RX decrypts the Hash Value and detects the sequence of All ‘5’ Words. Therefore, when TX and RX are identically initialized, and Cipher Text and Clear Text are synchronized, wherein no bit or bits have been corrupted in transmission; RX will detect All ‘5’ Words (Hash Value) encrypted by TX.
   Stated differently, if a portion of a TX Message Input is an All ‘5’ Word sequence; then TX's output of said sequence is an encrypted All ‘5’ Word sequence; TX's Hash Value/Tag is TX's Cipher Mask Word output sequence XORed to the Message inputs of All‘5’ Words.
   Hence, RX inputs TX's Cipher Text outputs, and XORs the Cipher Text Words to RX's Cipher Mask outputs (decrypts); and outputs All ‘5’ Words.
   Likewise in a validly transmitted encrypted formatted financial message, any i'th encrypted All ‘5’ Message Word causes an All ‘5’ Word output into RX's enabled All ‘5’ Word Detector.
   The All ‘5’ RX output is then an indication that the data source key is shared with the receiver, the data is not easily repudiated; the communication channel is reliable; and that TX has inserted, as prescribed, an All ‘0’ i'th Message Word in the Message Input. One might call a formatted insertion of the All ‘5’ Word message an Intermediate Hash. In a long message, this may be useful to detect valid “null” portions of transmitted data.
   RX may find useful the opportunity to set the Page/Frame Counter's Equality Vector, to cause an Interrupt routine at a given known All ‘5’ Word transmitted position in the sent sequence. Such a test gives an indication of the quality of the transmission in Ciphering with Error Propagation, and/or of the integrity of the sender and TX's Message in conventional No Error Propagating Stream Ciphering for all Messaging up to and including the last Intermediate Hash Value.
Automaton, Asynchronous Circuit for Generating RDY Signals, Interrupts & Reconciling, Authenticated Chaining Values—a two part asynchronous Automaton circuit has been affixed to a new and to previous clocked status counters e.g. as described in any of the following:
   U.S. Pat. No. 7,827,232 entitled “Stream Cipher Architecture”, issued 2009.
   US 2009/0304179, Dual Feedback Precludes Message Modification, Sep. 7, 2006.
   U.S. Ser. No. 13/143,172, Encryption with Integrity Salted by 64 Bit HAIFA Counter, 2010.
   To this may be added an Interrupt signaling a faulty Hash Value, and especially for the CMV, where we assume instances where negotiating exchanges will be machine generated, an Automaton may be added, reconciling the Hash Value to the authentication function.
   For preferred embodiments of the negotiated computerized voucher (CMV) protocol in the Shadow Memory circuit, Automaton may be added which automatically saves the last Chaining Value of each successful Hash Value generation; i.e. the “launching” Chain Value, for the next text Hash Digest, in a Shadow Memory, where each variable bit in the Chaining Value is functionally linked to a variable bit in the Shadow Memory. A ZK-Crypt automaton saves “good” Chaining Values in the Shadow Memory, and replaces a “bad” Chaining Value with the previous “good” previously generated Chaining Value.
   In the event of a failed transmission; i.e., an unsuccessful authentication, the Automaton reconciles the previous “good” Chaining Value into all variables of a ZK-Crypt stream cipher engine; enabling a rerun of the last Hash Digest and the last Hash Value authentication.
Barcodes—a commonly used optically identifiable coding system consisting of varied width numerically identifiable black bars or small squares in a large square.
Buyer—computerized workstations which, typically after relevant research on the part of their human users, are prepared to motivate or initiate or participate in negotiation, typically to result in privileged purchase. “Buyer” and “Customer” and occasionally “recipient” are non-limiting examples of negotiation initiating clients.
Chaining Value; in the ZK-Crypt Cipher Feedback Mode (CFB) is always the Aggregate of all State Variables—in conventional hash functions, an input block is larger than the Chaining Value. Each new block is compressed, truncated and is combined into the previous Chaining Value; wherein typically the last Chaining Value in a session becomes the “Hash-Value/Tag”, HV/Tag.
   The ZK-Crypt Chaining Values of a Hash Digest and also the Hash Value Generation the Hash Value Generation/Authentication the Hash Value Generation/Authentication Chaining Value is the present value of all state variables into which each bit of the last message word in the last encoded Message Word derivation is diffused into at least 384 State Variable binary equations of the next 527 bit Chaining Values.
   Stated differently, in a ZK-Crypt stream cipher MAC or Hash or Initialization Cipher Feedback Mode, CFB, procedures, the 32 Message Word input (assuming a single 32 bit standalone engine) is expanded into the 527 bit Chaining Value, which includes all binary state variables in the Random Controller, the Register Bank, the Data Churn, the Result/Feedback Processor and the 64 bit “HAIFA” Counter, e.g. the counter described in E. Biham & O. Dunkelman, A Framework for Iterative Hash Functions, NIST Hash Forum 2006, Santa Barbara. The HAIFA Counter is randomly affected by the Initialization process; is not affected by Message input Words, but is also part of the Chaining Value. (For a parallel paired ZK-Crypt engine set, the Chaining Value is a delayed diffusion into 1054 bit Chaining Value.) Compare this to conventional hash devices, where the Chaining Value is typically a series of truncation/compressions.
Cipher Feedback Mode; CFB—in conventional Stream Ciphering Message Words do not affect (are not fed back into) TX or RX's Deterministic Random Number Generating crypto engine. This is especially advantageous in situations which can suffer minor transmission errors, as in synchronized systems, corrupted bits do not propagate. (A true Cipher Text input yields a true Clear Text output, conversely a false Cipher Text bit yields only one false Clear Text bit. Encryption and Decryption are identical operations.
   In conventional block ciphers, e.g., DES, increased security is attained in the Cipher Feedback Mode, CFB, of operation; wherein TX's Cipher Text Word is fed back into both TX and RX's crypto engines.
   As the encryption and decryption processes are identical, Cipher Feedback Mode (CFB) block cipher encryption is a Stream Cipher mode of encryption, wherein even one corrupted transmitted bit propagates subsequent random corrupted Clear Text output.
   Hash Value/Tag generation is typically based on pre-encrypted Message Words uniquely affecting State Variables which are truncated into Chaining Values which are fed back into the crypto engine; the final Chaining Value typically generates HV/Tags.
   In the ZK-Crypt Cipher Feedback Mode (CFB) Encryption with Authentication Integrity both process are identical encryption processes. Encryption and HV/Tag generation consist of encrypting Clear Text followed by the All ‘5’ Word sequence of HV/Tag generators. Decryption and HV/Tag validation are Stream Cipher type decryption processes. As in block cipher CFB, TX's cipher text is fed into both TX and RX's crypto engines.
Cipher Mask; Cipher Text—the Cipher Mask 32 bit pseudo-random output of the Data Churn. In the TRNG mode the Cipher Mask is typically the output of the ZK-Crypt; in all Stream Cipher modes the Cipher Mask is XORed to Clear Text/Cipher Text Message Words, to output the Resulting Cipher Text/Cipher Text; and,
   In Data Authentication mode the Tag/Hash Value is a concatenation of MAC mode output Cipher Masked All ‘5’ Words.
Collisions of Internal State Variables &/or Hash Value/Tags—the unexpected internal occurrence wherein an identical Chaining Value will occur more than once in a hash digest; or in two HV/Tag sequences of non-identical data, or the occurrence of Non-identical Chaining Values leading to an identical Hash Value/Tag for two different data files; e.g., identical hash values for an authentic contract, and a fraudulent replacement are considered non-existent in the ZK-Crypt.
   Identical Chaining Values provably cannot exist in two places in a sequence smaller than 2⁶⁴ bits, because of the unique HAIFA count included in every Chaining Value.
   In granted U.S. Ser. No. 12/439,556, the impossibility of Message Modification in (at least) short messages is pointed out; e.g., where a decimal point may be fraudulently moved, and where a following Chaining Value can be reconciled to a true value.
   Documents with less than 2⁶⁴ bits are immune to herding, and probably collisions, thanks to the affixed unique random count number included in every Chaining Value.
   Meaningful collisions are extremely hard to generate in good Hash or MAC functions, and exceptionally hard to contrive in the ZK-Crypt.
Concatenated Hash Values aka Concatenated HV/Tags—ZK-Crypt Encryption with Integrity, or simple ZK-Crypt Hash Value generation protocols are designed for sending authenticated masses of data with Intermediary Concatenated Hash Values. In the three embodiment of the negotiated computerized voucher (CMV) protocol, the resulting data stream consists of a concatenations of portions of text, (clear or cipher) where each portion of said text is Hash Digested into, i.e., followed by, a Hash Value. Each authentic Hash Value proves authenticity of all previous data in the data stream, in particular of the last portion of text.
   In the ZK-Crypt Cipher Feedback Mode, each hash digested data portion uniquely alters the previous state of all bits of the chaining value. Likewise, each Hash Value generation uniquely alters the previous state of all bits of the Chaining Value.
   In the ZK-Crypt, each Hash Value is a unique encryption of “All ‘5’ Words”. We say unique, because each Hash Value encryption is a function of the last pseudo random Chaining Value state (527 variable bits in all Zk-Crypt Engine Configurations) following the Hash Digest process on a text portion.
   In the described protocols, the Chaining Value at the end of the Hash Value encryption is the “launching” Chaining Value for the next portion of Hash Digested text, followed by the generated Hash Value.
   If a decrypted alleged Hash Value generates a sequence of “All ‘5’ Words”; we know that all previous text portions and this and all previous Hash Values in the sequence are authentic.
   However, if the decrypted Hash Value does not generate a sequence of “All ‘5’ Words”, we assume that at least one bit was corrupted in the transmission. In such an instant, the receiver must request a retransmit, which, if run from the previous “good” chaining value, enables a successful authentication, and a new “good launching” chaining value.
   One way to replicate the “good” re-launch Chaining Value would be to reprocess the whole processed data sequence, up to the end of the re-launchable Chaining Value. Going backward is not tractable, as the ZK-Crypt Cipher Feedback Mode (CFB) functions are all “One-Way” functions, with probably no possible tractable inverse. Note that several suggested hash functions are built around block ciphers with defined inverses.
   For preferred embodiments of the negotiated computerized voucher (CMV) protocol, a circuit automaton has been added in the negotiated computerized voucher (CMV) protocol which automatically saves the last chaining value of each successful Hash Value generation; i.e. the “launching” Chain Value, for the next text Hash Digest, in a Shadow Memory, where each variable bit in the chaining value is functionally linked to a variable bit in the Shadow Memory.
   In the event of a failed transmission; i.e., resulting in an unsuccessful authentication, the automaton reconciles the previous “good” chaining value into all variables of a ZK-Crypt stream cipher engine; thereby enabling a rerun of the last Hash Digest and Hash Value authentication.
   All or any portions of text optionally are sent in either clear text or in ZK-Crypt Cipher Feedback Mode (CFB) encrypted cipher text, as generated Hash Value/Tags are identical in both instances.
   Negotiated computerized voucher (CMV) vendors may choose the enciphered and hash authenticated correspondence, as negotiated sales and registered customers lists are typically confidential information.
   In a typical negotiation, if the first sequence of authenticated data is secured, or unknown or unavailable to an intruder, the intruder would not be able to authenticate transmitted clear or cipher text data, nor be able to decrypt cipher messages.
   Correlation Immunity—we say that an output is correlation immune, or maximum correlation immune, if practically no information is leaked from the input (either the stage of an nLFSR or a Message Word) to the output, (either the Cipher Mask output or to the XORed Message to Cipher Mask output).
   Fortress maintains that tests have shown that the Store & XOR internal function, where each bit output is a function of typically four or more consecutive disparate inputs, in practice eliminates correlation (and debiases).
Corrupt—because of the orthogonal feedback streams, and the high diffusion in the ZK-Crypt, a single bit change in a valid Message affects (corrupts), variable bit equations of more than 350 Binary State Variables in the 32 Bit Word Manipulator in two clocks, and all bit variable equations in the Cipher Mask, in the third Primary Clocks, irreconcilably; e.g., as described in Message Modification preclusion proof in issued US 2009/0304179, Dual Feedback Precludes Message Modification, Sep. 7, 2006. This proof of preclusion of modified Messaging is of utmost importance in unkeyed hashing, where the intruder knows all bits of the hash digest, and the hash algorithm.
Cryptanalysis—cryptanalysis is the sister of cryptography in the science of cryptology that deals with analyzing what cryptographers design, to find weaknesses or attributes that lead to finding weaknesses, in the processing of learning the secrets of a cipher.
Negotiation initiating client 3^{rd} Party Data (C3D)—registered sub-set of data entered into the Negotiation initiating client database (e.g. CA) and associated with a particular Negotiation initiating client that is generated from 3^{rd} parties.
Negotiation initiating client Account (CA)—the profile database of registered Negotiation initiating client s including members of the public or specific community, or persons associating themselves with a vendor by registering their details and opening an account on the negotiated computerized voucher transaction engine. This account may enable the Negotiation initiating client to create a draft negotiated computerized voucher as part of more efficient dealing process with a vendor.
Negotiation initiating client Database (CD)—typically including confidential, fiscal and other publically known profile data held within the negotiated computerized voucher transaction engine database relative to each Negotiation initiating client. The data held can be both qualitative—name, address, ID Number of Negotiation initiating client, date of birth, address and zip code, marital status, family and fiscal status etc, and quantitative; E.G., transaction data based on previous interactions with the seller. For instance, if the vendor is a retailer—then the prior transaction history of the Negotiation initiating client with the vendor (typically, such data can be accumulated from the vendor's own Negotiation initiating client Relationship Management (CRM) systems. This profiled socio/economic account data forms the basis of the analysis and negotiation process for each negotiated computerized voucher.
Negotiation initiating client Input Data (CID)—registered sub set of data stored in the Negotiation initiating client's own account Negotiation initiating client Account (CA) database, that is typically provided and input directly by the Negotiation initiating client themselves.
Negotiation initiating client Managed Voucher (negotiated computerized voucher) (CMV)—a voucher request for goods and/or services offered by the seller, where the original terms of the voucher are generated by the Negotiation initiating client. The voucher request from the Negotiation initiating client is negotiated by the negotiated computerized voucher transaction engine in the system on behalf of the vendor based on the Vendor's Rule Set (VRS) and database of product and Negotiation initiating client information created by the seller/supplier.
Negotiation initiating client Managed Voucher Generator (CMVG)—a computerised sub-system incorporated within the negotiated computerized voucher transaction engine that helps the Negotiation initiating client handle the creation of a negotiated computerized voucher by the registered Negotiation initiating client. Once this voucher is requested by the Negotiation initiating client, it is electronically transmitted to the Vendor's account and the negotiation engine of the negotiated computerized voucher transaction engine. The Negotiation initiating client Managed Voucher Generator (CMVG) may be incorporated within the Vendors Website.
Negotiation initiating client Managed Voucher Response (CMVR)—a computerized information receptacle e.g. file, email or other, storing the response to each negotiated computerized voucher. The response is generated by the vendor negotiation engine (VNE) using the vendor rule set (VRS) and the vendor's data base.
Negotiation initiating client Managed Voucher Terms (CMVT)—a document, file or other computerized information receptacle storing terms selected by the Negotiation initiating client as the basis of the negotiation of the Negotiation initiating client Managed Voucher. Such terms are vendor specific negotiable terms and apply to the relevant product or services. Typical negotiable terms for an offer include (but are not limited to) “set price”, “set discount”, “number of items”, “set term” (i.e. date of voucher validity) “message to vendor”. The vendor can dynamically pre determine the range of offers and terms (min/max) e.g. max discount based on loyalty, quantity or only a select % discount or even lock out prices and allow requests only for additional services.
Negotiation initiating client Managed Voucher Transaction Engine (CMVTE)—the fully computerised management system including all the elements herein for the creation, negotiation and fulfilment of the Negotiation initiating client initiated negotiated computerized voucher.
Negotiation initiating client Vendor Data Base (CVD)—the vendor's own Negotiation initiating client confidential management system.
Data Churn—that part of the ZK-Crypt e.g. as described in FIG. 21, which processes an unpredictably rotated and MAJ/3XOR filtered combined output from four 32 bit tiers of the Register Bank.
   The churning operations consist of two pseudo-randomly stepped 4 rule (Splash) Matrix displacements; Random Controller's (EVNN) MAJ regulated diffusion of two Matrix bit outputs XORed to two other Matrix bit outputs; and three Store & XOR décor relation filters.
Deterministic & True Random Noise—the Random Controller emits 14 noise signals which affect 61 permutations in the Register Bank and the Data Churn. In crypto functions the noise source is deterministic pseudo random keys and pseudo random data generated in the Data churn and fed back into the Random Controller and the deterministic Noise Source.
   In both instances the Noise Source outputs 3 “ideal” (checked by Repeated Words) noise bits at every clock—encoded in a PRF encoder, to drive permutations in the Register Bank and the Data Churn; i.e., there is no predictable sequence of permutations in the Bank and Churn.
Diffusion—the affect of one State Variable on a number of dependent State Variables; such that the source variables cause a linear and/or a non-linear change of output in a plurality of dependent variables; typically affecting disparate sourced changes.
   In the isolated Critical Paths of the implemented version of the ZK-Crypt; maximum first order diffusion (of an estimated over 380 diffused equations) occurs after three clocks.
Digest (verb), Message Digest, and Hash Digest—we call the process of pseudo-random expansion/diffusion of a stream of Message Words into the variables of the ZK-Crypt, a digesting or a Hash Digest process, a generally recognized definition.
   As opposed to virtually all contesting hash functions, the ZK-Crypt Hash Digest is a Cipher Feedback Mode expansion function, wherein each engine the 32 bit initialization Words, the Message Words and the HV Words of the input are expanded into the 527 bit chaining value. All other methods are compression functions with truncation. In the ZK-Crypt the chaining value is never truncated, every input bit affects literally all bits of the chaining value. The ZK-Crypt was rejected both by the eSTREAM contest and the NIST SHA-3 because of the multi-permutation Word and Random controller with the inherent architectures which cannot be easily analyzed. The mutual attacks of the finalists in the NIST SHA-3 Forum demonstrate a foreseeable life cycle of compression, truncated Hash Digest process.
Dual Track Orthogonal Feedback—conventional feedback procedures are shunned in RNG & PRF designs because of inferior statistics, generally attributed to forced correlation of output stages (the cipher masks); despite the fact that judicial feedback potentially increases crypto-complexity.
   In the ZK-Crypt, in both the Cipher Feedback and the MAC Feedback modes the feedback sources and permutations of each of the Feedback Words are diverse, and affect different portions of the Register Bank and Data Churn in grossly different ways. The MAC mode feedback streams are orthogonal.
Engine—refers to the interacting modules, i.e., the integrated Random Controller with 14 32 bit State Variables and the Message In Port as a single entity.
   Engines work singly as 32 bit cipher machines; or concatenated, where one engine's Lower Feedback is diverted to its neighbor. The simplest concatenation (64 bit) is an engine pair with swapped Lower Feedback.
   Theoretically, any number of engines can be concatenated in a circular configuration.
   When engines are concatenated, the concatenation to the Host resembles a single engine.
   Ports A (size of inputs), D (output states and statistics) and E (commands and configurations) are 32 bit ports. Message In, and Result Out Ports B and C are 32, 64 or 128 bit Words as configured, wherein in one clock cycle, one Message Word is input and one Result Word is output.
Encryption with Authentication Integrity—in the Zk-Crypt expansion function performs encryption and hash in Cipher Feedback Mode.
Exhaustive Search, Brute Force Search—a well designed stream cipher is most efficiently compromised (the secret key extracted, or at least the finding decryption of the confidential Clear Text), by conducting an orderly exhaustive (aka brute force or direct search}, over each of the possible secret keys (and known IVs and scrambles, if they exist).
   The Biham publication cited herein; E. Biham & O. Dunkelman, Differential Cryptanalysis in Stream Ciphers, Technion CS 2007-10, states that “a stream cipher that has no probability differentials (or even impossible differentials) is expected to be immune to resynchronization attacks, related key attacks, and re-keying attacks”.
   Fortress has run all of the standard random tests, and found that only the Repeated Word tests, accurately detect and proves that there are no differentials or impossible differentials, on internal variables in the Data Churn Manipulator, the Noise Source, or the Orthogonal Feedback Streams in the Zk-Crypt; precluding both differentials and impossible differentials, in the ZK-Crypt SHA-3 NIST Hash Version Contest entry version, (with 352 state variables in the 32 bit single engine configuration, 47 Random Controller bit variables—now 79, and without the additional 64 bit HAIFA Mersenne Counters randomly salting the feedback steams); after analyzing the simplest chunk in the Word Manipulator, estimated, from a complete mathematical solution, of the displacement matrices, there would be at least 5 million monomials in a straight forward single engine mathematical solution, a probability of about 55 million monomials in a 64 bit double engine configuration. An estimating of the monomial count in the 128 bit configuration would have been a wild guess. He also pronounced that for each resolution, one must know all Engine variables [n×527; n=number of interacting Engines], in order to resolve the next state. As the displacement matrices were dense, small scale minimization would have been irrelevant.
   In a confidential vendor presentation to a client, a prominent cryptanalyst stated that because of the immediate disparate diffusion of a single bit, into over 400 bits in each clock cycle, and the multi permutation combinations of internal variables; assuming Moore's Law progression of quantum computing, semiconductor designs, and analytical algorithms; more than 50 years would pass before an algorithmic solution would be viable. He asserted that a double Engine would probably take more than 200 years.
   The commercial implemented ZK-Crypt Ciphers (and associated MACs—Encryption with Integrity) with DMA input of Message Words, and output of Cipher Text, is an order of magnitude faster than virtually all other symmetric encryption and/or hash functions. Any exhaustive key search attack would therefore be unfeasible; the present industrially accepted, intractable work factor (the number of trials operations) stands at 2¹²⁸. A successful brute force attack on a long document would demand at least 2⁵¹² trial operations.
Errors, ZK-Crypt Transmit, Error Detection, Error Correction, and Error Propagation—modern semiconductor computation devices are deterministic and dependable, executing the most complex pseudo random functions without introducing computation errors. Storage devices and transmission networks are less trustworthy and depend on a plethora of hardware and software functions that are often designed for specific types of noisy digital signals, capable of detecting and correcting transmitted errors, stored single bit errors, burst errors (often dynamically regulated to the length and character of the bursts) and more complicated devices for correcting video streams and other digitized analog signals. These devices add redundant data bits to the stored or transmitted data, designed for detecting and/or correcting structured data, in specific situations.
   A detected error, with the asynchronous Hash Value detector Automaton of this patent, at least, will generate an interrupt to the Host, following a flawed Hash Value.
   The ZK-Crypt “one way” hardware Hash Value authenticator output is irreconcilably corrupted by any erroneous input data bit, three Engine cycles hence. (Therefore, we suggest the insertion of at least three Scramble Words to precede the total Hash Value authentication to assure diffusing errors into the recorded Hash Value, to assure error detection of the last words of transmitted data.)
   A single error bit in a transmitted or stored the hash digest, scramble or hash value in a ZK-Crypt stream cipher diffuses into the equations of about 400 of the 527 bits of chaining value and irreconcilably randomizes the Cipher Mask and Text or Hash Value output, after three machine cycles.
   It is advisable to take cost effective measures to assure that transmitted or stored errors are reconciled prior to executing said data in the ZK-Crypt.
   Hash Digesting (with linked Decryption) and Hash Value generation are enacted in Cipher Feedback Mode where the PRF output is corrupted by the first corrupted input, and all subsequent data is irreconcilably randomized. We say that the Error Propagates.
   In Conventional Stream Ciphering (see Switch @0), the feedback into the PRF is not a function of the Message input; therefore the Cipher Mask output is a deterministic sequence. An error bit in the transmitted Cipher Text, will cause a single error in the output sequence; hence, we say that in Conventional Stream Ciphering “Errors do not Propagate”. A secure negotiated computerized voucher (CMV) scheme conventionally implemented will optionally encrypt data with a conventional block cipher and conventionally hash with a conventional hash method.
FB, Feedback—in a closed loop system, any of a variety of functions which recycle output value into a function that will have an affect on an input value. See LFSRs (Linear Feedback Shift Registers), Lower Feedback, Super Tier Feedback, Cipher Feedback, and MAC Feedback, Cipher Feedback Mode.
Finite State Machine, FSM—a sequencing controlling mechanism consisting of combinational logic, a clock and memory elements determining a finite number of sequential states wherein given input states causes a transition to defined output states.
   The ZK-Crypt can be operated step by step by the host, using simple logic combinations defined in the interface, or by the FortressGB designed hardware FSMs with extended functionality necessary for most efficient single step direct memory access functions, which are external to the present core. The six FSMs each step the said simple logic combinations to perform Initialization, TX and RX encryption/hash digest, and Hash Value Generation and Detection.
   At the end of each process, i.e. initialization, message processing and authentication; a ZK-Crypt stream cipher Automaton generates asynchronous un-clocked Interrupts.
Flip-Flop (FF)—Types D, T & SR—an electronic memory cell, capable of maintaining two stable output states, ‘1’ or ‘0’ on outputs Q and Q NOT. Synchronous (clock activated) flip-flops used in the ZK-Crypt, are Data (D type) and Toggle (T type). In the D flip-flop, the input at the D connection appearing immediately before an activating clock cycle is Sampled and transferred to the output, Q. In the T (Toggle) flip-flop configuration, the output is a polarity change from the previous output. When the clock signal activates the flip-flop, the previous polarities of Q and Q NOT are reversed. Clock activation is activated by a rise in the voltage of the clock signal, denoted in the figures by a direct connection of the input to the clock connection; or by the fall in voltage of the input clock signal, denoted by a small circle adjacent to the clock input connection of the flip-flop. SR flip-flops are asynchronous devices, as they are activated at pseudo-random instants, and not stepped by a system Primary Clocking device. An activation voltage on the S input causes a stable one (a set) on the output, Q. Activation of the R input (often marked CLR or Clear), causes a stable zero (a reset) on the output, Q. Flip-flops have an optional second output Q Not, symbolized by a Q under a horizontal dash. A D type flip-flop, with the inverted Q NOT output connected to its D input serves as a T flip-flop, wherein the output is toggled at each activating clock signal. D, T and SR flip-flops are used in the ZK-Crypt Stream Cipher and Random Number Generator configurations. Emulation of such devices is immediate in software implementations.
   All ZK-Crypt binary variables are stored in flip-flops. Flip-flops account for almost one half of the electronic gates (NAND equivalent) in the ZK-Crypt.
   In non-secured difficult to test systems, the standard test method, JTAG, consists of a serial scan of all State Variable flip-flops, which entails an additional minimum of two gates on every flip-flop. Fortress' experience suggests that reputable manufacturers either do not allow scanning procedures in secured modules (or they provide for burning out of the scan line). Simple probes can often divulge all hidden secrets. The ZK-Crypt and similar devices are easily tested with a few tailored test sequences (starting from the Global Reset), because of the interaction of virtually all gates and variables after a maximum of 16 clock activations.
HAIFA Counter a 64 Bit Mersenne Prime LFSR (Linear Feedback Shift Register) based Unique Unpredictable 64 Bit Count Device Randomly Initialized—“A Framework for Iterative Hash Functions” suggested by Eli Biham and Orr Dunkelman, was designed essentially to strengthen conventional hash devices based on block ciphers with a conventional counter. The framework included “salt” aberrations, similar to IVs or non-secret encryption keys as seen in a ZK-Crypt stream cipher and a counter which differentiates and marks each Chaining Value uniquely.
   The ZK-Crypt HAIFA (inspired) double word counter consists of a concatenation of relatively prime Mersenne LFSR (Linear Feedback Shift Register)s, of cell lengths 7, 13, 17 and 19, and an 8 celled nLFSR (divisible by multiples of prime number 2); which are initialized by XOR summing of the Lower Feedback Salt and Super Tier Feedback Salt during the total Initialization input sequence consisting of any combination of key, or IV, with a scramble; unique for each Encryption with Authentication Integrity operation (not unique for each unkeyed-hash operation). In the ZK-Crypt, outputs bits of the 64 bit HAIFA Counter are disbursed and linearly summed into the Super Tier and Lower Feedback Words. The essential purpose of the HAIFA counter is to prevent multiple collisions, and herded sections of data with replicated sections of data. In all encryption and keyed-hash (MAC) operations wherein the HAIFA Counter is randomly initialized, the counter augments the Chaining Value with 64 State Variable bits that are not affected by either the Cipher or Clear Text of the Hash Value/Tag.
.Hash, Hash Digest, Hash Value/Tag aka HV/Tag ‘All 5’ Generator—a Hash function is typically an efficient one-way compression of longer binary strings into fixed length strings, typically called Hash-Values (for Hashes, Keyed Hashes or MACs), or Tags (typically for keyed hashes or MACs). In such data authentication systems, a user must be reasonably assured that any fraudulent change in the binary input string, large or small, will render a false Hash Value. Typically, hash functions do not involve secrets, are publicly known, and a potential attacker knows fully the process of compression, leading to the Hash Digest. The received assume true Hash Value, is checked against the single value previously known Hash Value of the original binary string, is designed to reasonably assure a user of the authenticity of the data. A hash function, in which a secret key is used to initiate the apparatus, enables a user who knows both the secret key and the true hash-value to determine the integrity and the origin of the “hashed” data.
   In a ZK-Crypt hashing operations, the Hash Digest and the generation of the HV/Tag generation and authentication are en/decryption operations utilizing the Cipher Feedback Mode inherent to a ZK-Crypt stream cipher Engine. Hence, authentication of the hash value can either be validation of the original clear text, or of the stored or transmitted cipher text.
   The HV/Tag is generated by TX's encrypting a string of hexadecimal ‘5’s. RX decrypts the encrypted ‘All 5’ string, and has detectors (in all Engines) operative to detect and count occurrences of ‘All 5’s. RX receives a Corrupt interrupt if the authentication fails. Optionally the RX Host can read the number of valid words in the authentication process on the output port. In all configurations, RX has a mechanism for recreating the start chaining value for the repeated message; such that TX can retransmit the string, hopefully overcoming the corrupted bits from the previous trial, and RX can ascertain the ‘All 5’ HV/Tag generator.
   The Hash Digest of incoming data into the ZK-Crypt, ideally prepares a final condition of the Engine (the final 527 bit Chaining Value of a single engine uncatenated, or n×527 where n is the number of catenated engines), which can then generate literally any length Hash Value/Tag to assure authenticity. The hash digest consists of encrypting (Cipher Mask Word XOR summed to each incoming Message Word) data, then dividing the encrypted Word into two orthogonal 32 bit streams each of which is uniquely, unpredictably salted, and XORed to a different 32 bit HAIFA unpredictable unique number prior to diffusing (6 32 bit streams—4 versions, via the Lower Feedback and Super Tier Feedback) the feedback “recycled” into the Register Bank and Data Churn. We say that each digest of a Message word is an expansion of 32 bits into the 527 State Variable Engine (an intermediate Chaining Value), and digesting a long message (plurality of Messages) into the final Chaining Value is a unique untruncated expansion.
   An apparatus with a secret key is typically classified as a MAC, a Message Authentication Code; or an HMAC, a Hashed MAC.
Initial Value, IV Initial Vector—an Initial Value extension of the Secret Key is mandatory for Conventional Stream Ciphering as the cipher mask en/decryption is same sequence for same key, for an infinite number of different message segments.
   Starting from an identical initial condition, in conventional Stream Cipher Mode, the Cipher Mask outputs a single valued deterministic sequence. An adversary who could record a cipher text transmission and could learn the value of the deciphered clear text could record the sequence of secret masked values, and later decipher all data sent using the same secret key IV combination. Hence, after loading secret keys, we encode a “nonce”, a one-time value per message/session as an IV, such that the each data file is uniquely encoded. When Encrypting with Integrity, where the Chaining Value is a function of the input data, the unique IV assures unpredictable initialization of the HAIFA Counter during the subsequent Scramble. The unique unpredictable IV is mandatory in the implementation of the Conventional Stream Cipher.
Intractable—the assumption that useful estimation or prediction is unfeasible using known methods; i.e., cracking a ZK-Crypt stream cipher by any method other than “Exhaustive Search” is probably an intractable exercise.
Linear Feedback Shift Register—LFSR—a clocked shift register device assembled from D type flip-flops with feedbacks taps drawn from defined pairs of flip-flops in the register, or in a second class, with XORs placed between flip-flops of the registers.
   The two general classes of LFSR (Linear Feedback Shift Register)s are, One to Many, (Galois) and Many to One (Fibonacci). In a Many to One sequence, outputs from a plurality of taps from a shift register are XORed to the output of the feedback flip-flop which is returned to the input of the first “left hand” flip-flop. In a One to Many configuration, the output of the last flip-flop of the register is fed into specific XOR gates (taps) placed between register flip-flops and also fed into the first leftmost flip-flop.
   The LFSR (Linear Feedback Shift Register) is a linear device, as for each configuration of the LFSR (Linear Feedback Shift Register), a given Word on the outputs of each of the registers leads to a next defined output of the register, such that the n bit word sequences are cyclically repeated, when the clock is continuously clocked. An all zero word is the unacceptable sequence in a pure LFSR (Linear Feedback Shift Register) configuration, as 0 XOR 0 equals zero. At the all zero stage the LFSR (Linear Feedback Shift Register) is stuck in a sequence syndrome (Stuck on Zero Syndrome) of zero in and zero out. The only input to an LFSR (Linear Feedback Shift Register) (after initialization) is the clock or stepper.
   An n bit LFSR (Linear Feedback Shift Register) has a cyclic sequence of 2n−1 n output bit words. An observer who learns an unaltered string of 2n bits of the LFSR (Linear Feedback Shift Register) output sequence can recreate the whole sequence and can learn the LFSR (Linear Feedback Shift Register) internal value at any “point” in time.
   Different feedback configurations from same length maximum sequence length (2n−1) registers produce all of the same elements of the sequence, but in a different sequential order.
   Adjacent stages of One to Many LFSR (Linear Feedback Shift Register) have more “local unpredictability” than adjacent stages of Many to One LFSR (Linear Feed-back Shift Register), to an observer who has no knowledge of the generating LFSR (Linear Feedback Shift Register) devices. A conventional LFSR (Linear Feedback Shift Register) does not include the all zero state (all cells output value is zero. In those instances wherein an LFSR (Linear Feedback Shift Register) is one time variably salted, e.g., the last salt of initiating a Mersenne LFSR (Linear Feedback Shift Register), an NFIX can insert a ‘1’ to reincarnate the sequence. The NFIX can also insert the all zero stage, lengthening a sequence from 2n from 2n−1.
MAC FB Enabled “1”/Shunt Switch “0” (Conventional Stream Ciphering)—ZK-Crypt Initialization Processes that include installing Keys and/or Initial Values and/or Scrambles, the Message Word inputs affect all State Variables; possible only when the Engine operates in MAC Mode. Likewise, un-keyed and keyed hash (MAC) during the Hash Digest and Hash Generation of a Stream Ciphering Process are also possible only when the Engine operates in MAC Mode. Encryption with Authentication Integrity is a process identical to keyed hash (MAC) with the exception that the en/decrypted Cipher/Clear Text is not read
   Conversely, in order to prevent propagation of transmission errors, Conventional Stream Ciphering, the Shunt 0AB Switch is set on 0, isolating the encrypted data from residually recorded data in the Hash MAC Store.
MAC Message Authentication Code—MAC or HMAC, Message Authentication Coding or to be more exact Data Authentication Coding is a secret keyed one way function process for uniquely compressing a large concatenation of binary Words into a shorter binary string, a Tag/Hash Value. The Tag/Hash Value is a unique trace on the contents, such that the chance of two inputs causing an identical Tag/Hash Value, a collision, caused by an adversary or fault, is practically non-existent. FortressGB claims that a ZK-Crypt stream cipher MAC function is far stronger than the NIST HMAC configuration; albeit, a ZK-Crypt stream cipher Hash function can enhance any other Hash configuration including the NIST HMAC.
MAJ Function—the MAJ function outputs a ‘1’ iff either 2 or 3 inputs are ones and a ‘0’ iff either 2 or 3 of the inputs are zeroes.
   The MAJ function reduces bias iff 2 of three inputs are unbiased. The non-linear MAJ function is more robust under analysis than the linear 3 input XOR function, iff all three input signals are unbiased but slightly correlated. Typically, the MAJ output leaves traces of input bias.
   The MAJ function uses half the number of gates used by the comparable 3 in XOR function, and typically has less propagation delay.
   The 2 of 3 MAJority gate is used in high security computing to obviate false outputs caused by malfunction of one of three parallel operating computing devices. In a high security encryption system, 3 low-power ZK-Crypt engines could be operated in parallel wherein only a result where at least 2 of the 3 engines agree would be accepted Read by the Host.
Mask, Cipher Mask—the pseudo-random, deterministic, intractably unpredictable output of the Bottom Store & XOR Non-Linear Correlation-Immunizing Combiner is the mask which encrypts the Message Word into cipher text when XORed to the plain text Message Word and decrypts the cipher text when XORed to the cipher text. The Mask encodes the Message in the Message Digest of Hash/Data Authentication, TX's Cipher Mask encrypts the Hash Generator All ‘5’ Word sequence to output the Hash Value/Tag. RX's Cipher Mask decrypts the encrypted All ‘5’ Word sequence to generate a string of detected All ‘5’ Words.
   The Mask is generated by the running key. In the MAC feedback mode, the Mask XORed to the Message is recycled into the Register Bank, and is diffused into subsequent Masks.
Mersenne Prime (Max Length, 2p−1) LFSR (Linear Feedback Shift Register) Counters

Concatenated to any Relatively Prime n celled nLFSR (Linear Feedback Shift Register) (2n) Counter—Any stand alone maximum length LFSR (Linear Feedback Shift Register) produces a unique pseudo-random sequence of all non-zero Words. Any p celled Mersenne Prime (MP) LFSR (Linear Feedback Shift Register) generates a prime number (2p−1) unique number of Words. There is an assumed short list of Mersenne Primes where both p and 2p−1 are prime numbers. If a counter composed of individual length MP LFSR (Linear Feedback Shift Register)s are concatenated, the combined sequence (regardless of the initial set value of each of the counters) length will be the multiple, M1, of the lengths of all of the (2p1−1) (2p2−1) . . . (2pn−1) counters; the reason being that the only common denominator of all MP counters is 1. Any maximum length n celled nLFSR (2n Word length—where n is any positive integer) which includes the all ‘0’ Word in the sequence is only divisible by 2s and therefore is relatively prime to the Mersenne Prime concatenation. The length M2 of the above described Mersenne concatenation chained to the nLFSR counter is (2n)·M1. The length of the H concatenation (H1) of the two unique 32 bit HAIFA Word sequence generated by relatively prime linear shift register sequences is 2⁶³<H1<2⁶⁴ 64 bit Words.
Message Word, message—we refer to a typically longer than 32 bit data input operand in a single Engine ZK-Crypt as a message (lower case “m”). We conventionally refer to the 32 bit operand that is encrypted for TX transmission and decrypted at RX reception, (XORed to the Cipher Mask) as a Message Word, (capital“M”). In the ZK-Crypt, all input data; i.e., keys, IVs, Scrambles, Cipher and Clear Text, HV/Tag generator and output via are input via the Message Word input, only.
Multi-permutation primitives—C. Schnorr and S. Vaudenay's concept for designing cryptographic primitives based on using a plurality of pseudorandom function building blocks, causing massive diffusion in the state space. We say that a ZK-Crypt stream cipher is an extension of the Schnorr/Vaudenay original 1995 concept. There are more than 60 permutations in the 32 bit Word Manipulator, 31 of which are regulated by unpredictable serial signals from the multi-permutation Random Controller.
Near Field, Near Field Communication, NFC—refers to ISO 14443 specification for close contact token communications Negotiate—to conduct a process or employ a protocol to prove entitlement, to assure transfer of value, or to prove identity. Negotiation is used by system tokens and devices.
Network—computerised ICT and communications infrastructure Internet, mobile phone, LAN (in a store, airport, etc.)
Network—the fixed line and wireless networking necessary for systematic regulation; e.g., statistical monitoring, and control of access to devices and closed areas.
Nonce—a nonce is a value used only once. The IV used in a conventional stream cipher should be a true random value nonce. We suggest using true random numbers, generated by a ZK-Crypt stream cipher to supply “nonces” when necessary for generating random challenges (must be unpredictable to the challenger or hacker) and Initial Values which may be a nonce to prevent copy of a known cipher text/clear text Cipher Mask sequence.
Non-linear Functions (in the ZK-Crypt)—the AND function is the simplest non-linear function, where the change of a single input into the AND logic gate may or may not change the gate output. The Carry (adder) gate is often used in older ciphers, but not in the present ZK-Crypt offering. The non-linear 2 of 3 MAJ function is the ubiquitous non-linear module in the ZK-Crypts. Non-linear functions MAJ, AND and Carry, typically exaggerate bias of input bits, in the output result.
   The MAJ filter is the principal non-linear function in the ZK-Crypts. The non-linearity of a ZK-Crypt stream cipher nLFSRs is provided by Slips, random Imaging, and erratic clocking.
One Way Function—a ZK-Crypt stream cipher could be a paradigm of a one way function as it is easy to compute y=f(x) for all x, but computationally infeasible to compute f(x)=y. We prefer to say that there is no tractable inverse for any ZK-Crypt configuration.
On-Line—the communicative state of a device of being connected to the operator's fixed or wireless network, at a specific time.
Permutations Multi-Permutations—permutations are regulated by pseudo-random functions and generators. The Generators include:
   The 11 of 12 (P)Random Clock (aka the missing pulse Pseudo (P)Random Clock);
   The Splash Matrix 4 Rule Stepper;
   The Double function Top, Middle and Bottom Control Units.
   The Permutation Encoder 17 non-linear feedback shift registers
   The unpredictable 2×32 bit Mersenne Prime based HAIFA Counter randomly initialized by Internal Salts during Scrambles.
      The Permutations include:
   The MAC MIX Result Displaced Feedback to the Super Tier;
   The SuperMIX S Boxes salting the Super Tier Feedback;
   The Right and Left nLFSR Slips;
      the pseudo-random activation of Tiers;
      the pseudo-random Image XOR of Tiers' outputs;
      the pseudo-random XORing of a Tier's concatenated nLFSRs' output Image to itself;
   The pseudo-random Splash displacements;
   Missing Clock activation of the Control Units & with Alternate permutations
   The MAJ diffusions of two left hand adjacent Splash output bits to the principal Splash output bit
   The non-linear 4 Tier Hybrid MAJ/XOR combiner;
   The bias balancing of the principal Splash output bit to its right hand adjacent Splash Output bit;
   The XOR combining of the last two EVNN outputs; and
   The Top, Intermediate and Bottom Store & XOR filters
   The unpredictable 64 bit output of the HAIFA Counter's 5 relatively prime nLFSRs.
      We Say Relatively Prime, because the 8 Bit LFSR (Linear Feedback Shift Register) Is Divisible by the XOR combining of the last two Result Words to be fed back into the three tiers; and more.
Parallelizing ZK-Crypt Engines—n ZK-Crypt engines can be parallelized to linearly increase total word size and “more than” exponentially increase crypto-complexity, without increasing energy per processed bit. The hardware link between adjacent cores is the Lower Feedback stream. For n=2, Lower Feedbacks are swapped; e.g., the generated left hand Lower Feedback stream is switched into the R/H Lower Feedback stream, and vice versa. The switched Lower Feedback is by far most effective in concatenated configurations; as neither the originating Engine of the Lower Feedback nor the receiving Engine of the Lower Feedback can attempt reconciling the corruption in either of the Engines' internal variables, without further corrupting all Engines in the concatenation.
   Likewise, for safe transmissions of multi-packet (multi-frame) messages wherein each packet is encrypted and simultaneously hash digested in Cipher Feedback Mode, CFB, there is a danger that one or more bits in one or more packets may be corrupted in transmission, each frame must be must be error-free before being decrypted in Cipher Feedback Mode (CFB) mode. (In Cipher Feedback Mode (CFB) mode, errors propagate—one false bit will preclude both further packet decryption and final Hash Value/Tag generation/authentication.) In FIGS. B04-B08 we describe a double engine protocol, wherein ENMAC TX and RX Engines operating in Cipher Feedback Mode (CFB) operates on the total message, generating a full length HV/Tag on the total message; while in parallel TX and RX Hash Engines are simply initialized, then do a Hash Digest on TX's encrypted Frame and then authenticate each TX encrypted frame. If the Frame was well received, RX will signal TX to proceed to transmit a new Frame.
   Note that TX's Hash Engine receives each encrypted Word with a single cycle Primary Clock delay.
PRF, Pseudo Random Function—we refer to a ZK-Crypt stream cipher as a large pseudo random function, because a hacker who is party to the known hardware algorithm, the IV, the Initialization sequence and the keys deterministically recovers Clear Text (and generates Cipher Feedback Mode (CFB)Tags). We assume that all adversaries know the silicon algorithm, and could perform all of a ZK-Crypt stream cipher functions, were they party to the shared secret key typically paired with a unique shared initial value IV. (The IV is mandatory in conventional Stream Ciphering.)
   Likewise, n bit length LFSR (Linear Feedback Shift Register) and nLFSRs, independently are called pseudo random functions, as there is an even likelihood that each of the 2n−1 or 2n possible n bit output words will occur. If the hacker knows the generating device, and has access to 2n bit output strings, he immediately can calculate the whole output string.
Random Controller—the Random Controller receives binary feedback signals from the Register Bank, and two feedback signals from the output of the Top Splash Matrix in the data churn. The Random Controller includes the three included Control Units driven by a Deterministic Noise Source which remotely alters which feed the permutation encoding logic;
Recipient or “negotiation initiating client”—workstation operated by e.g. one who wishes to participate in and typically to initiate a computerized negotiation e.g. to purchase, buy, own or otherwise receive goods and/or services, optionally at a privileged price, from by a vendor, typically operating a website on an information network. The negotiation initiating client creates and transmits a specific voucher request (negotiated computerized vouchers) to the seller for these goods and/or services via the negotiated computerized voucher transaction engine.
Reconciliation of a Chaining Value after a Modified Message—a classic attack on a hash function is to attempt modifying a Message Word, knowing that the modification will flip (complement) Chaining Value state variable bit(s) in a way that the attacker could not reinstate the Chaining Value to its original value, with another Message modification, most probably at the next Primary Clock.
   The attacker would have to be able to estimate which bits were flipped, and would try to reconcile future Chaining Values by flipping bits in subsequent Message Words. FortressGB has shown in US 2009/0304179, Dual Feedback Precludes Message Modification, Sep. 7, 2006, and in demo tests of all 2³² possible input words, that such a scheme cannot work.
Register Bank—FIG. 21 is an aggregate of non-linear LFSR (Linear Feedback Shift Register) with combining logic, each of which i variables are indelibly changed by each message Bit and each initialization bit.
Repeated Word Distinguisher—a test of the random distribution of 32 bit Words in a large set of consecutive samples. Typical tests check the distribution of nibbles and bytes.
   How many Repeated Words may we expect to find in each test?
   We take the naïve approach—because of the large size, and the assumption that there is an ideal distribution of pseudo random Words, that there is very low probability of expected finding a number in a close to ideal distribution in a 10M sample; the chance of finding a pair at each event is one half the chance of finding a specific number in a 32 bit Word, i.e., 1/(2³²×2).
   The number of pairs in n events is:
   n(n−1)/2
   so that the number of all repeated 32 bit words, RWs, (doubles, and extremely rare triples and quadruples) are:
   RW=n(n−1)/(2³²×2); and for large n's, on 32 bit words
   RW≈n2/2³³), for large n.
   We sample n=10 million Words, the estimated average number of expected Repeated Words in 10 million events, for a perfect distribution is 11,641.53.
   Note that these tests were done testing random distribution the Pseudo Random Function, without the randomizing affect of hashing in of uncorrelated Message Words. Testing on uncorrelated, non-trivial hashed messages gave better results. We assume, as the Chaining Value length was increased by the arbitrary Message Words.
   Bernstein's testing on his Linux RNG function, and our measures on RD5 (RC5 Block Cipher) yielded about 11,623 repeats, slightly better than the “ideal”.
Result/Feedback Processor—that component of a ZK-Crypt stream cipher engine that Processes the 3 function Results which emanate from the Data Churn and generates the Super Tier and Lower Feedback streams. The Processor also integrates the Lower FB Salt, the Super Tier FB Salt and the two HAIFA typically unpredictable Counter results into both FB streams.
   In MAC mode, the Lower FB is the XOR sum of the a previous Result (the Cipher Mask XORed to a Message) XORed to a present Result XORed to the designated Salt and one HAIFA count; wherein the Super Tier Feedback is a “salt” internally generated Word XORed to a reverse nibbled present Result Word and to a second HAIFA count.
   In the conventional Stream Cipher Mode the Result is the XOR sum of the Message and the Cipher Mask, and is not summed into either Feedback. Conventional cipher is not a cipher feedback mode operation. The Cipher Mode Lower Feedback is the XOR sum of the Lower FB Salt and 32 bits of the 64 Bit HAIFA Counter; and the conventional Stream Cipher Mode Super Tier Feedback output is the XOR sum of the SuperMIX rotated S Boxes and 32 bits of the HAIFA Counter. Stated simply, conventional Stream Cipher Result and feedbacks are not function of the message input.
   Initialization of the ZK-Crypt, following the Global Reset can only be implemented by feeding predefined Message Words into Port B, in MAC Mode.
Salt—a preprocessing feedback randomizing value, preferably pseudo random of hash function feedback streams In a ZK-Crypt Stream Cipher Result/Feedback processor, two uncorrelated streams generated in a ZK-Crypt stream cipher PRF (Pseudo Random Function) and the 64 bit HAIFA counter “salt” the two orthogonal ZK-Crypt feedback streams.
Scramble—the Scramble function in a ZK-Crypt stream cipher is a simple diffusion mechanism which we use to maximize crypto-complexity of initialization (hides weak keys) prior to ciphering, prior to Message Digesting, and prior to Hash Value/Tag generation, and to enable increased security in constrained hardware. Simply stated, a single Scramble is a single Primary Clocked procedure in MAC Mode, with the Message Word input locked to the All ‘5’ Word. During the Initialization Scramble cycles, the Lower Feedback Salt and the Super Tier Feedback Salt Words are XORed to the operating 32 bit Super Tier HAIFA Counter and to the 32 bit Lower Feedback HAIFA Counter, respectively.
Shadow Memory—for a preferred embodiment of the negotiated computerized voucher (CMV) protocol a Shadow Memory and a Shadow Memory circuit automaton have been added which automatically saves the last Chaining Value of each successful Hash Value generation; i.e. the “launching” Chain Value for the next text Hash Digest, in a Shadow Memory, where each variable bit in the Chaining Value is functionally linked to a variable bit in the Shadow Memory.
   The ZK-Crypt Shadow Memory automaton saves “good” Chaining Values in the Shadow Memory, and replaces a “bad” Chaining Value with the previous “good” Chaining Value, saved previously in the Shadow Memory.
   Having an Automaton controlled Shadow Memory simplifies and accelerates computerized negotiations.
Smart Card—a conventional paper or plastic configuration of substantially the same size as a conventional plastic credit card, with a semiconductor memory, with or without CPU or crypto-controllers, see “Token”.
Switch @—defines the Cipher Feedback Mode of operation.
   If Switch @A—the PRF (Pseudo Random Function) is configured in “Sender Cipher Feedback Mode”.
   If Switch @B—the PRF (Pseudo Random Function) is configured in “negotiation initiating client Cipher Feedback Mode” e.g. as per FIGS. 9-12 and FIG. 20.
Vendor—a computerized entity that negotiates with a negotiation initiating client and enables the negotiation initiating client to use a negotiation initiating client managed voucher generated through the negotiated computerized voucher transaction engine system.
Vendor Database—a sub-set of data within the negotiated computerized voucher transaction engine database that holds the vendor's account data and information.
Vendor Product Website—includes List Prices and standard terms of sale.
Vendor Rule Set (VRS)—the rules set in the system by each Vendor that are vendor specific and are used by the transaction engine to analyse and negotiate each negotiation initiating client drafted negotiated computerized voucher request. The rule set is typically managed by the vendor. Typically these rules are associated and tailored to specific products and services and to profiled classes of Negotiation initiating clients.
Vendors Website's—an e-commerce website of a vendor or one, which is associated with a vendor wherein a Negotiation initiating client can search for, and select vendor specific products/services of interest to them. A negotiated computerized voucher editor or generator is included in such a website wherein the Negotiation initiating client can opt to create a draft negotiated computerized voucher.
Voucher Formatted Token—a formats covering the methods in which the Redeemable Voucher/Token, the VRT, is delivered to the Negotiation initiating client. Typical Voucher Formatted Tokens include:
   (a) printed paper vouchers containing secured details of the voucher and a one or two dimensional barcode;
   (b) A print-at-home barcode vouchers. To increase security, the index number of the voucher may be forwarded to the selected point of delivery as in U.S. Pat. No. 8,056,802, or issued via email to the Negotiation initiating client and printed out by the Negotiation initiating client with the authorisation barcode.
   (c) An encoded or unencoded voucher code transferred via the vendor's website into the Negotiation initiating client e-commerce web-site;
   (d) virtual voucher using an activation mechanism of a smartcard; and/or,
   (e) a near field communication, NFC voucher whereby the NFC mobile device, typically a mobile phone, often with smart-phone features, is a safe virtual redeemable voucher delivery mechanism.
Voucher Negotiation Engine (VNE)—a computerised sub-system of the negotiated computerized voucher transaction engine incorporated within the negotiated computerized voucher transaction engine that handles the negotiation between the Negotiation initiating clients' generated negotiated computerized voucher and the vendor. The Voucher Negotiation Engine (VNE) applies the vendor's rule set (e.g. VRS), to each negotiated computerized voucher a process that may generate an “A”, “N”, or “R” voucher.
Voucher Reader—a physical computerised digital device that is designed to read the printed and/or digital authorisation code carried on the Voucher Redemption Token, and to enable the authorisation and single use redemption of the Negotiation initiating client managed voucher. The vendor can utilise a Voucher Reader either as a stand alone unit connected via TCP/IP to the negotiated computerized voucher transaction engine or point to point directly from a LAN gateway to the vendor's point of sale equipment. The unit reads the Voucher Redemption Token (VRT) and logs the redemption information into the negotiated computerized voucher transaction engine database.
Voucher Redemption Token (VRT)—an electronically generated medium whereby the Negotiation initiating clients draft voucher, once accepted by the vendor and deemed an “A-voucher” is transformed into a redeemable/usable medium that the Negotiation initiating client can utilise to obtain the good and services on the negotiated terms.
Voucher response the (CMVR)—can be either an acceptance—an “A-Voucher”, a refusal voucher—“N-Voucher” or a re-offer—“R-Voucher”. The vendor negotiation engine continues amending the terms of the response, until either an A-voucher (accepted) or N voucher (unaccepted) is generated preferably, the vendor's response are completely automated. The response is a function of the Negotiation initiating client's up dated profile held in the secure transaction engine database. Typically a known loyal Negotiation initiating client's request for a specific product receives a more positive response than a new Negotiation initiating client with no prior trading history with the vendor typically receives either a reduced discount or no discount.
ZK-Crypt—any stream cipher, e.g. as described herein or as described in patent documents cited herein, operative to generate Random Sequences, to encrypt and decrypt streams of binary Words, and to validate the unaltered status of a stream or file of binary data; wherein binary words display virtually no distinguishable or impossible distinguishable non-random words in the engine; and with very close to Zero Knowledge leakage from the Register Bank, the ZK-Crypt Sanctus Sanctorum.

Certain embodiments of the present invention seek to provide a computerized system and method for authenticated negotiation for vending or other applications.

Certain embodiments of the present invention seek to provide a Negotiation initiating client managed negotiation scheme for purchasing goods and a wide range of services from a seller.

Conventionally, it is the domain of the seller to make an offer, and the recipient to accept. In contrast certain embodiments of the present invention provide computerized voucher negotiation e.g. so as to digitally enable recipients to create a “recipient managed voucher”, including a computerized request to a specific computerized entity for a product (say) on specific terms. For the seller the engine automatically assesses this offer “the negotiation” and returns one of, say an “accept”, “reoffer” or “reject” response. This retailer response is automated and the resultant response is dependent upon a sophisticated rule based negotiation process incorporated into the Voucher Transaction tool.

Typically, the Negotiation initiating client will have an option to continue negotiation after receiving a “reoffer voucher”.

The Negotiation initiating client Managed Voucher (negotiated computerized voucher) is a computerized document typically created by the recipient, negotiated according to certain embodiments of the present invention typically according to a vendor's voucher rule set. The rules relate to a range prices, terms of delivery, and product specification. If the offer to buy fits in to the range, the seller accepts the offer. If the offer is in a defined close proximity, the seller prepares a counter offer. If the offer is outside the close proximity, the seller sends a rejection, i.e., an n-Voucher,

A recipient managed voucher transaction engine (CMVTE) or “negotiated computerized voucher transaction engine” typically comprises a computer based vendor functionality, typically protected by conventional hardware symmetric or asymmetric business level cryptography, that enables Negotiation initiating client Managed Vouchers to be requested by the recipient, negotiated and responded to by the seller. It is a secured computerised software process that may be incorporated as a distinct functional component into other software solutions such as a seller's website or e-commerce site, or can be run independently across multiple sellers.

Certain embodiments of the present invention seek to provide a system to enable a recipient to register his own user account. A system for each recipient to input and generate his/her own profile data (e.g. CID).

Certain embodiments of the present invention seek to provide a system where the recipient account (CA) can be associated with additional recipient data held by the vendor (e.g. CVD) or other 3^{rd} Parties (e.g. C3D).

Certain embodiments of the present invention seek to provide a system wherein a registered Negotiation initiating client is able to generate his/her own recipient managed voucher (negotiated computerized voucher).

Certain embodiments of the present invention seek to provide a system as above where the negotiated computerized voucher includes relevant terms (CMVT) typically defined by the vendor, whereby the recipient can adjust the value/parameters of such terms in order to negotiate more favourable terms for them as part of a negotiation process with the vendor.

Certain embodiments of the present invention seek to provide a system whereby each negotiated computerized voucher request is automatically evaluated and negotiated on behalf of the vendor and the recipient using a negotiation engine (VNE). The negotiation is determined based on a set of rules (VRS) predefined and updated by each vendor in the negotiated computerized voucher transaction engine and relevant data held on the recipient in the recipient data base (e.g. CD).

Certain embodiments of the present invention seek to provide a system whereby each negotiated computerized voucher interactive negotiation phase results in an automated response (CMVR) to the recipient from the vendor.

Certain embodiments of the present invention seek to provide a system whereby the recipient can continue to negotiate with the vendor by means of amended the negotiation initiating client managed voucher response (CMVR) until the CMVR is either an acceptance or rejection of the CMVR.

Certain embodiments of the present invention seek to provide a system whereby a recipient with an agreed negotiated computerized voucher (known as an “A” Voucher) can be issued with a physical or digital Voucher Redemption Token (VRT), a means of redeeming the negotiated computerized voucher.

Certain embodiments of the present invention seek to provide a system whereby the agreed Voucher Redemption Token (VRT), e.g. an agreed negotiated computerized voucher with acceptable terms can be redeemed by the recipient for goods and services under the agreed terms.

Certain embodiments of the present invention seek to provide a system which incorporates a Voucher Reader that provides vendors with an easy to use route of reading and redeeming the Voucher Redemption Token (VRT).

Certain embodiments of the present invention seek to provide a system that can interface with multiple sales channels—online and offline including point of sale systems to enable the A Voucher to be redeemed in as many places and in as many ways as possible.

Certain embodiments of the present invention seek to provide a system whereby the Voucher Redemption Token (VRT) can be delivered in multiple formats including but not limited to paper, digital, virtual (smartcard activation), mobile, NFC

Certain embodiments of the present invention seek to provide a recipient controlled system for voucher negotiation. This system digitally enables recipients to create their own promotion with a “recipient managed voucher”, enabling an efficient request to a specific vendor for a product or service on specific terms. For the seller the engine automatically assesses this offer “the negotiation” and returns an “accept”, “reoffer” or “reject” response. This vendor response is automated and the resultant response is dependent upon a sophisticated rule based negotiation process incorporated into the Voucher Transaction tool

Certain embodiments of the present invention seek to provide a secure network recipient managed purchasing of goods and or services voucher negotiation and payment system for networked purchases instigated by uniquely defined recipients in a recipient's uniquely selected sellers data base system:

wherein the recipient submits a seller acceptable format draft voucher to the seller; and/or wherein the draft voucher is subsequently used interactively in a negotiation process between the recipient and seller; and/or wherein in each negotiation stage the seller can return one of three formatted voucher; a reoffer voucher, a refuse i nvalidated voucher, an acceptance voucher; or following agreed upon payment, a final redeemable voucher, enabling delivery of cited goods by common carriers, for delivery via a specific retail outlet, for delivery via specific wholesale outlet, or for delivery in any one of many retail wholesale outlets.

Optionally, at point of delivery redeemable vouchers are invalidated.

Optionally, at retail wholesale point of delivery the deliverer will have a list of at least one unique expected recipient's voucher

Optionally, the redeemable voucher will have a keyed hash value, which is readable by the seller or the seller's proxy

Optionally, the redeemable voucher will contain sufficient information to identify the recipient Optionally, payment can be made using standard EMV, cash, stored value mobile phone devices or PayPal or similar mutually recipient seller, or seller proxy as agreed upon.

There is thus provided, in accordance with at least one embodiment of the present invention, wherein;

The present invention typically includes at least the following embodiments:

### Embodiment 1

A system for facilitating computerized negotiations between populations of computerized first and second entities, the system including:

a first entity-controlled joint venture processor enabling a first entity in a population of computerized first entities, to present to at least one second entity in a population of computerized second entities, a first version of a proposed joint venture between the first entity and at least one second entity, the first version including a first set of values for each of a corresponding set of joint venture parameters; and

a second entity-controlled joint venture processor enabling a second entity in the population of computerized second entities, to receive the first version of the proposed joint venture from the first entity and to communicate to the first entity, a selectable communication from among a joint venture acceptance communication and a joint venture modification communication including a change of at least one value in the first set of values, thereby to define a second version of the proposed joint venture including a second set of values for each of the corresponding set of joint venture parameters,

wherein the first entity-controlled joint venture processor is also operative to enable the first entity to receive the second version of the proposed joint venture from the second entity and to communicate to the second entity, a selectable communication from among a joint venture acceptance communication and a joint venture modification communication including a change of at least one value in the second set of values as most recently received from the second entity-controlled joint venture processor, thereby to define an additional version of the proposed joint venture including an additional set of values for each of the corresponding set of joint venture parameters.

### Embodiment 2

A system according to embodiment 1 and wherein at least one of the joint venture processors determines whether to communicate a joint venture acceptance communication or a joint venture modification message, using pre-programmed joint venture processor-specific accept vs. reoffer negotiating rules.

### Embodiment 3

A system according to embodiment 1 wherein at least one of the joint venture processors is operative to communicate to the other of the joint venture processors, a selectable communication from a joint venture acceptance message, a joint venture modification message, and a joint venture refusal message.

### Embodiment 4

A system according to embodiment 1 and wherein at least one of the joint venture processors determines whether and how to change at least one of the parameter values as most recently received from the other of the joint venture processors, using pre-programmed joint venture processor-specific re-offer generation rules.

### Embodiment 5

A system according to embodiment 4 and wherein the pre-programmed re-offer generation rules comprise joint venture processor-specific rules for:

determining a joint venture partner desirability score based at least partly on parameter values as most recently received from the other of the joint venture processors;

determining weights of unit gaps between values presented by the first and second joint venture processors for each of the parameters, and

at least reducing gaps between values most recently presented by the first and second joint venture processors such that a sum of resulting gap reductions, over all parameters, respectively weighted by the weights, corresponds to the desirability score.

### Embodiment 6

A system according to embodiment 5 wherein the sum of resulting gap reductions, over all parameters, respectively weighted by the weights, corresponds to the joint venture partner desirability score in that the greater the joint venture partner desirability score of an individual joint venture processor, computed using rules of a negotiating joint venture processor negotiating with the individual joint venture processor, the greater the gap reduction between values most recently presented by the individual and negotiating joint venture processors, that is mandated by the rules used by the negotiating joint venture processor.

### Embodiment 7

A system according to embodiment 5 and wherein the pre-programmed re-offer generation rules comprise joint venture processor-specific rules for

determining a joint venture partner desirability score of a specific joint venture processor based at last partly on prior knowledge regarding the specific joint venture processor.

### Embodiment 8

A system according to embodiment 1 wherein the first entity-controlled joint venture processor interfaces with human users via a website including presenting information to and receiving information from, the human users.

### Embodiment 9

A system according to embodiment 1 wherein the joint venture includes provision of a resource from a provider to a recipient and wherein the first entity, who presents the first version, comprises the recipient and the second entity comprises the provider.

### Embodiment 10

A computerized method for facilitating computerized negotiations between populations of computerized first and second entities, the method including:

providing a first entity-controlled joint venture processor enabling a first entity in a population of computerized first entities, to present to at least one second entity in a population of computerized second entities, a first version of a proposed joint venture between the first entity and at least one second entity, the first version including a first set of values for each of a corresponding set of joint venture parameters; and

providing a second entity-controlled joint venture processor enabling a second entity in the population of computerized second entities, to receive the first version of the proposed joint venture from the first entity and to communicate to the first entity, a selectable communication from among a joint venture acceptance communication and a joint venture modification communication including a change of at least one value in the first set of values, thereby to define a second version of the proposed joint venture including a second set of values for each of the corresponding set of joint venture parameters,

wherein the first entity-controlled joint venture processor is also operative to enable the first entity to receive the second version of the proposed joint venture from the second entity and to communicate to the second entity, a selectable communication from among a joint venture acceptance communication and a joint venture modification communication including a change of at least one value in the second set of values as most recently received from the second entity-controlled joint venture processor, thereby to define an additional version of the proposed joint venture including an additional set of values for each of the corresponding set of joint venture parameters.

### Embodiment 11

A computerized method according to embodiment 10 wherein the providing a first entity-controlled joint venture processor comprises maintaining data integrity of an exchange of at least one computerized frame, each frame including at least one message, each message including at least one word, between at least first and second exchange participants, the method comprising:

computing a first, non-transmitted, hash value from at least one first frame generated by the first exchange participant;

computing a second, transmitted hash value from at least the first frame and the first, non-transmitted hash value, and

transmitting at least the first frame and the second hash value to at least the second participant.

### Embodiment 12

A computerized method according to embodiment 10 wherein the providing a second entity-controlled joint venture processor comprises maintaining data integrity of an exchange of at least one computerized frame, each frame including at least one message, each message including at least one word, between first and second exchange participants, the method comprising:

receiving at least a first message frame and a second hash value from the first participant;

reconstructing a first hash value from the at least first message frame and the second hash value; and

using the first hash value as a secret key for continued exchange of at least one frame with the first participant.

### Embodiment 13

A computerized method according to embodiment 12 wherein the secret key is used for hashing at least one frame to be transmitted to the first exchange participant.

### Embodiment 14

A computerized method according to embodiment 12 wherein the secret key is used for hashing at least one additional frame received from the first exchange participant.

### Embodiment 15

A computerized method according to embodiment 12 wherein the continued exchange comprises the receiving and the reconstructing and wherein a resulting first hash value is used as an additional secret key for even further continued exchange of at least one more frame with the first participant.

### Embodiment 16

A computerized method according to embodiment 15 wherein the additional secret key is used for hashing at least one additional frame to be transmitted to the first exchange participant.

### Embodiment 17

A computerized method according to embodiment 11 or embodiment 12 wherein at least one the participant comprises a Cipher Feedback Mode based pseudorandom hardware device.

### Embodiment 18

A computerized method according to embodiment 17 wherein each Cipher Feedback Mode based pseudorandom hardware device is programmable to alternate between serving as a generator and transmitter of data operative to generate a hash digest of at least one frame and serving as a receiver including generating a hash digest of received data.

### Embodiment 19

A computerized method according to embodiment 18 wherein each Cipher Feedback Mode based pseudorandom hardware device is programmable to alternate randomly between serving as a generator and transmitter of data operative to generate a hash digest of at least one frame and serving as a receiver including generating a hash digest of received data.

### Embodiment 20

A computerized method according to embodiment 18 and also comprising using the second hash value to verify the hash digest and the first hash value.

### Embodiment 21

A computerized method according to embodiment 11 wherein the at least first and second exchange participants includes the first participant and a plurality of second exchange participants and wherein the transmitting comprises transmitting at least the first frame and the second hash value to the plurality of second exchange participants.

### Embodiment 22

A computerized method according to embodiment 11 wherein computing the first, non-transmitted, hash value comprises computing a hash digest of at least the first frame.

### Embodiment 23

A computerized method according to embodiment 11 wherein at least the first frame is transmitted as a commercial-level encoded frame.

### Embodiment 24

A computerized method according to embodiment 22 wherein the hash digest comprises first frame, encoded at a commercial-level.

### Embodiment 25

A computerized method according to embodiment 11 wherein the transmitting comprises transmitting a concatenation of at least the first frame and the second hash value to the second participant.

### Embodiment 26

A computerized method according to embodiment 12 wherein a final hash value is generated by the continued exchange and wherein the final hash value is digitally signed by the participants.

### Embodiment 27

A computerized method according to embodiment 26 wherein at least one frame represents at least one characteristic of a proposed transaction and wherein the final hash value represents at least one characteristic of a transaction agreed between the participants and wherein the method also comprises:

storing, in a computerized database, final hash values digitally signed by participants in a multiplicity of exchanges; and

storing indications of consummation of transactions represented by final hash values in the database such that authorization of transactions by accessing the database prevents transactions from being consummated more than once.

### Embodiment 28

A computerized method according to embodiment 26 or embodiment 27 wherein a public key signature process is employed to digitally sign the final hash value.

### Embodiment 29

A computerized method according to embodiment 12 and also comprising using the second hash value to verify the first hash value and the first message.

### Embodiment 30

A computerized method according to embodiment 15 wherein a final hash value is generated by the even further continued exchange and wherein the final hash value is digitally signed by the participants.

### Embodiment 31

A computerized method according to embodiment 15 wherein the additional secret key is used for hashing at least one frame, other than the first frame, received from the first exchange participant.

### Embodiment 32

A computerized system for maintaining data integrity of an exchange of at least one computerized frame, each frame including at least one message, each message including at least one word, between first and second exchange participants, the system comprising:

a receiver operative for receiving at least a first message frame and a second hash value from the first participant;

a hasher operative for reconstructing a first hash value from the at least first message frame and the second hash value; and

an encoder operative for using the first hash value as a secret key for continued exchange of at least one frame with the first participant.

### Embodiment 33

A computerized system for maintaining data integrity of an exchange of at least one computerized frame, each frame including at least one message, each message including at least one word, between at least first and second exchange participants, the system comprising:

a hasher operative for computing a first, non-transmitted, hash value from at least one first frame generated by the first exchange participant and for computing a second, transmitted hash value from at least the first frame and the first, non-transmitted hash value, and

a transmitter receiving from the hasher, and transmitting to at least the second participant, at least the first frame and the second hash value.

### Embodiment 34

A computerized method for maintaining data integrity of an exchange of at least one computerized frame, each frame including at least one message, each message including at least one word, between at least first and second exchange participants, the method comprising:

computing a first, non-transmitted, hash value from at least one first frame generated by the first exchange participant;

computing a second, transmitted hash value from at least the first frame and the first, non-transmitted hash value, and

transmitting at least the first frame and the second hash value to at least the second participant.

### Embodiment 35

A computerized method for maintaining data integrity of an exchange of at least one computerized frame, each frame including at least one message, each message including at least one word, between first and second exchange participants, the method comprising:

receiving at least a first message frame and a second hash value from the first participant;

reconstructing a first hash value from the at least first message frame and the second hash value; and

using the first hash value as a secret key for continued exchange of at least one frame with the first participant.

### Embodiment 36

A computer program product, comprising a computer usable medium having a computer readable program code embodied therein, the computer readable program code adapted to be executed to implement a method for maintaining data integrity of an exchange of at least one computerized frame, each frame including at least one message, each message including at least one word, between at least first and second exchange participants, the method comprising:

computing a first, non-transmitted, hash value from at least one first frame generated by the first exchange participant;

computing a second, transmitted hash value from at least the first frame and the first, non-transmitted hash value, and

transmitting at least the first frame and the second hash value to at least the second participant.

### Embodiment 37

A computer program product, comprising a computer usable medium having a computer readable program code embodied therein, the computer readable program code adapted to be executed to implement a method for maintaining data integrity of an exchange of at least one computerized frame, each frame including at least one message, each message including at least one word, between first and second exchange participants, the method comprising:

receiving at least a first message frame and a second hash value from the first participant;

reconstructing a first hash value from the at least first message frame and the second hash value; and

using the first hash value as a secret key for continued exchange of at least one frame with the first participant.

Optionally, the first hash value tag authenticator detects a faulty hash value on a data section, RX requests a repeat of the transmission.

Optionally, the chaining value generated at the end each authenticated section is stored in a shadow memory of the complete chaining value, such that the stored in shadow memory values can reconcile the chaining value of the device ready to receive the perfect transmission which produces the true authentication.

Optionally, each section, after the first section of data of authenticated data consists of a data section concatenation where the first portion is a hash value/tag from the previous data section.

Optionally, each section, after the first section of data of authenticated data consists of a data section concatenation where the first portion is a first hash value/tag generated by both TX and RX, from the previous data section, and a second hash value/tag digested from concatenated data and the first hash value, transmitted by TX to and authenticated by RX.

Optionally, the first data section is initialized with a secret key wherein all subsequent encrypted data cannot be feasibly decrypted, and all subsequent hash value/tags cannot feasibly be authenticate the data sections by an entity who does not have access to the secret key and does not have the resources to make a successful brute force search of the original secret key.

Optionally, any first continuous sections of authenticated data can be deleted without eliminating the efficacy of the final sections and the signed token.

Optionally, the final Hash Value/Tag, or parts thereof, is concatenated to data stream which includes a voucher with a

Optionally, a central computer is aware of all coupons e.g. vouchers out there and does not allow a voucher to be presented more than once.

Also provided is a computer program product, comprising a computer usable medium or computer readable storage medium, typically tangible, having a computer readable program code embodied therein, and the computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a computer readable storage medium.

Any suitable processor, display and input means may be used to process, display e.g. on a computer screen or other computer output device, store, and accept information such as information used by or generated by any of the methods and apparatus shown and described herein; the above processor, display and input means including computer programs, in accordance with some or all of the embodiments of the present invention. Any or all functionalities of the invention shown and described herein may be performed by a conventional personal computer processor, workstation or other programmable device or computer or electronic computing device, either general-purpose or specifically constructed, used for processing; a computer display screen and/or printer and/or speaker for displaying; machine-readable memory such as optical disks, CD ROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of a computer.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

### BRIEF DESCRIPTION OF THE DRAWINGS

Certain embodiments of the present invention are illustrated in the following drawings:

FIG. 1a is a simplified semi-block diagram semi-pictorial illustration of an example system for facilitating computerized negotiations between populations of computerized first and second entities, according to certain embodiments of the present invention.

FIG. 1b is a simplified semi-block diagram semi-pictorial illustration of a Registration Process for partners to a computerized negotiation using a computerized voucher to represent a status or outcome of the computerized negotiation, all operative according to certain embodiments of the present invention, which is useful e.g. for generating input for block 18 of FIG. 1a.

FIG. 1c is a simplified semi-block diagram semi-pictorial illustration of a scheme, useful e.g. in optionalizing block 18 of FIG. 1a, whereby a Vendor Creates negotiated computerized voucher Term rules according to certain embodiments of the present invention.

FIG. 1d is a simplified semi-block diagram semi-pictorial illustration of a Negotiation initiating client Managed Voucher Negotiation Process, useful e.g. in operationalizing block 1011 of FIG. 1a, according to certain embodiments of the present invention.

FIG. 1e is a simplified semi-block diagram semi-pictorial illustration of a negotiated computerized voucher Redemption Process, useful e.g. in operationalizing block 1013 of FIG. 1a, according to certain embodiments of the present invention.

FIGS. 1f and 1g, taken together, form a simplified logic flow diagram of a Voucher Negotiation Engine useful e.g. in operationalizing block 1010 of FIG. 1a, all according to certain embodiments of the present invention.

FIG. 2a is a simplified flow chart illustration of a method, including some or all of the illustrated steps, suitably ordered e.g. as shown, for negotiation of a Negotiation initiating client Managed Voucher.

FIG. 2b demonstrates a simplified schematic that describes how a potential negotiation initiating client activates an account with an intended vendor.

FIG. 3 is a simplified schematic of a Vendor's computation engine operative to automatically negotiate sales with pre-defined set of terms of agreement.

FIG. 4 is a simplified schematic of components and processes involved in an automated negotiation initiating client motivated voucher negotiation.

FIG. 5 a simplified flow chart illustration of a method, including some or all of the illustrated steps, suitably ordered e.g. as shown, for culminating a negotiation, with either a rejection or an issuance of negotiation initiating client redeemable means.

FIG. 6 is a simplified flow chart illustration of a method, including some or all of the illustrated steps, suitably ordered e.g. as shown, for a sequential negotiation of term.

FIG. 7 is a simplified flow chart illustration of a method, including some or all of the illustrated steps, suitably ordered e.g. as shown, for a completed negotiated computerized voucher (CMV) multistep authenticated negotiation with concatenated intermittent and final Hash Value authentications; wherein all data exchanges are in Clear Text.

FIG. 8 is a simplified flow chart illustration of a method, including some or all of the illustrated steps, suitably ordered e.g. as shown, for a complete negotiated computerized voucher (CMV) multistep negotiation with concatenated intermittent and final Hash Value authentications; wherein all data exchanges encrypted. Steps in FIG. 7 and FIG. 8 are interchangeable, as messages are optionally sent in the Clear or Encrypted, both generate identical Chaining & Hash Values.

FIG. 9 is a block diagram from U.S. Ser. No. 13/143,172, published as US2011/0286596, wherein both sender and receiver identically Hash Digest initialization values; both in the of sender and receiver's pseudo random function, PRF (Pseudo Random Function), engines; operating in sender cipher feedback mode; said engines are functionally equivalent to previous versions of the FortressGB ZK-Crypt.

FIG. 10 is an enhanced block diagram adapted from U.S. Ser. No. 13/143,172, published as US2011/0286596, of a sender Hash Digesting m Clear Text Message Words in sender's cipher feedback mode PRF (Pseudo Random Function), said sender transmitting said Clear Text messages; and a receiver receiving an assumed accurate transmission which receiver similarly Hash Digests in receivers PRF (Pseudo Random Function), in sender cipher feedback mode. Errors in transmission corrupt the Chaining Values in the receiver's internal PRF (Pseudo Random Function) variables, i.e., precluding an optional decryption and an authentic Hash Digest.

FIG. 11 similar to FIG. 10, is an enhanced block diagram adapted from U.S. Ser. No. 13/143,172, published as US2011/0286596, of a sender Hash Digesting and encoding m Clear Text Message Words in sender's cipher feedback mode PRF (Pseudo Random Function), said sender transmitting said encoded Clear Text messages; and a receiver receiving an assumed accurate transmission which receiver Hash Digests and decrypts in receivers PRF (Pseudo Random Function), configured in receiver cipher feedback mode. Errors in transmission corrupt the Chaining Values in the receiver's internal PRF (Pseudo Random Function) variables preventing a proper decryption and corrupting the sequenced trial Hash Value.

FIG. 12 is an enhanced block diagram adapted from U.S. Ser. No. 13/143,172, published as US2011/0286596, of a sender generating a Hash Value, launched from the Chaining Value of a clear or enciphered Clear Text message. The sender's generated Hash Value is an encryption of a string of t All ‘5’ Words in sender's cipher feedback mode PRF (Pseudo Random Function). The sender having transmitted a Clear Text message; transmits sender's generated Hash Value. The receiver having received an assumed accurate transmission of the clear or enciphered Clear Text, and having Hash Digested said text; outputs the decryption of sender's Hash Value to receiver's portion of the Automaton which in FIG. 12, synchronously detects and trial authenticates, in receiver's PRF (Pseudo Random Function), configured in receiver cipher feedback mode. The Automaton section of FIG. 12 triggers the Automaton circuitry of FIGS. 19 and 20 either to save the last Chaining Value, if authenticated, in Shadow Memory, or to reconcile said Chaining Value in the event of a faulty transmission to the last authentic Chaining Value; thereby enabling a repeated trial transmission of cipher or Clear Text and Hash Value.

FIG. 13 is a block diagram of an adapted ZK-Crypt procedure from U.S. Ser. No. 13/143,172, published as US2011/0286596, designed for negotiated computerized voucher (CMV) negotiations wherein sender's Clear Text messages with appended Hash Values are transmitted; received and trial authenticated by receiver; with saved and reconciled Chaining Values; enabling receiver to continue to exchange new negotiation messages, or to request a resend of the last faulty transmission.

FIG. 14 is a block diagram of an adapted ZK-Crypt procedure from U.S. Ser. No. 13/143,172, published as US2011/0286596, for negotiated computerized voucher (CMV) negotiations, wherein sender's cipher text messages with appended Hash Values are transmitted; received and trial authenticated by receiver; with saved and reconciled Chaining Values; enabling receiver to continue to exchange new negotiation messages, or to request a resend of the last faulty transmission.

FIG. 15 is a procedural ZK-Crypt schematic rendition of a final approval step following a successful negotiated computerized voucher (CMV) negotiation, wherein the vendor sends, unencrypted, a voucher with a Proforma Invoice and a draft token to be signed by the negotiation initiating client. The draft token is optionally hashed by the PRF (Pseudo Random Function), or by any other agreed upon hash method.

FIG. 16 is a procedural ZK-Crypt schematic rendition of a final approval step following a successful negotiated computerized voucher (CMV) negotiation, wherein the vendor sends an encrypted voucher with a Proforma Invoice and a draft token to be signed by the negotiation initiating client. The draft token is optionally hashed by the PRF (Pseudo Random Function), or by any other agreed upon hash method.

FIG. 17 is schematic of a prior art conventional RSA signature scheme, operative to bind a negotiation initiating client to the authenticated agreement.

FIG. 18 is an annotated circuit diagram unique to a ZK-Crypt stream cipher negotiated computerized voucher (CMV) rendition, demonstrating the link between one bit of a Chaining Value and an authenticated stored in the Shadow Memory last authenticated Chaining Value bit.

FIG. 19 is a, unique to a ZK-Crypt stream cipher negotiated computerized voucher (CMV) rendition, annotated circuit diagram, demonstrating the Automaton which stores authenticated Chaining Values in Shadow Memory and reconciles faulty Chaining Values with last authenticated Chaining Values.

FIG. 20 is an enhanced block diagram of a ZK-Crypt stream cipher switching mechanism circuitry in U.S. Ser. No. 13/143,172, published as US2011/0286596, wherein the authenticating circuit is changed to be synchronized to the Hash Value reception. The Result/Feedback Processor ZK-Crypt circuitry includes two orthogonal feedback streams, as proven in the U.S. issued U.S. Ser. No. 12/439,556, which preclude Message Modification in Hash Digests. The result/orthogonal sender and receiver cipher feedback mode processor includes; a pre-salting of each feedback stream with two non-correlated pseudo random values; and two unique 32 bit pseudo random word count markers on chronological Chaining Values.

FIG. 21 is the block diagram of a ZK-Crypt, adapted from U.S. Ser. No. 13/143,172, published as US2011/0286596. The new rendition includes unique circuitry and an Automaton, see FIGS. 12-14 and 19-10, designed to efficiently process negotiated computerized voucher (CMV) and other secured negotiation procedures over noisy networks.

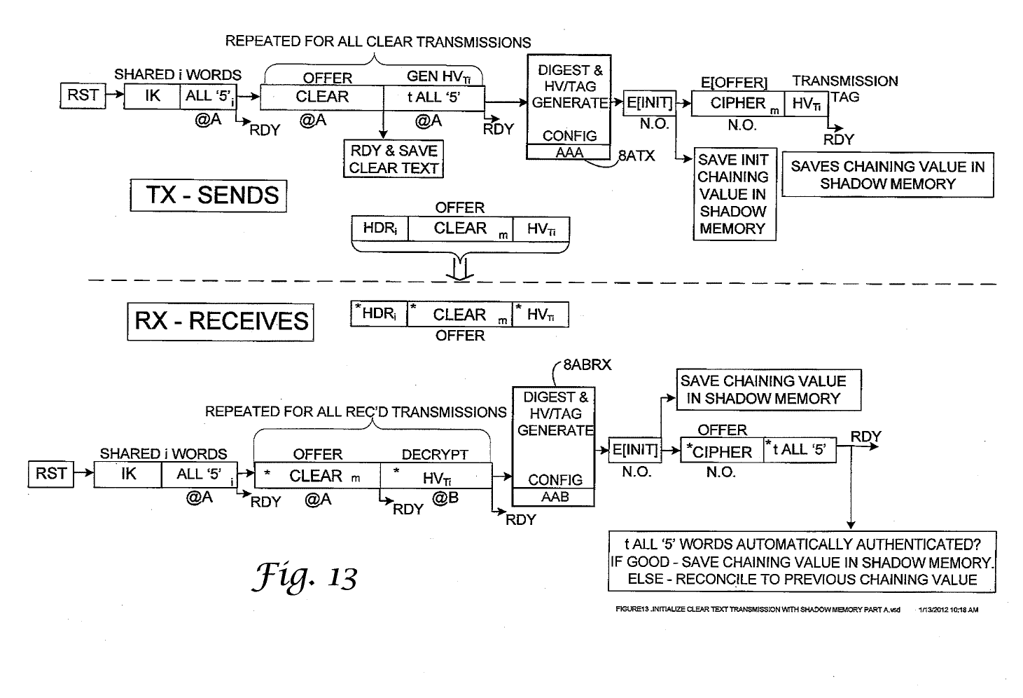

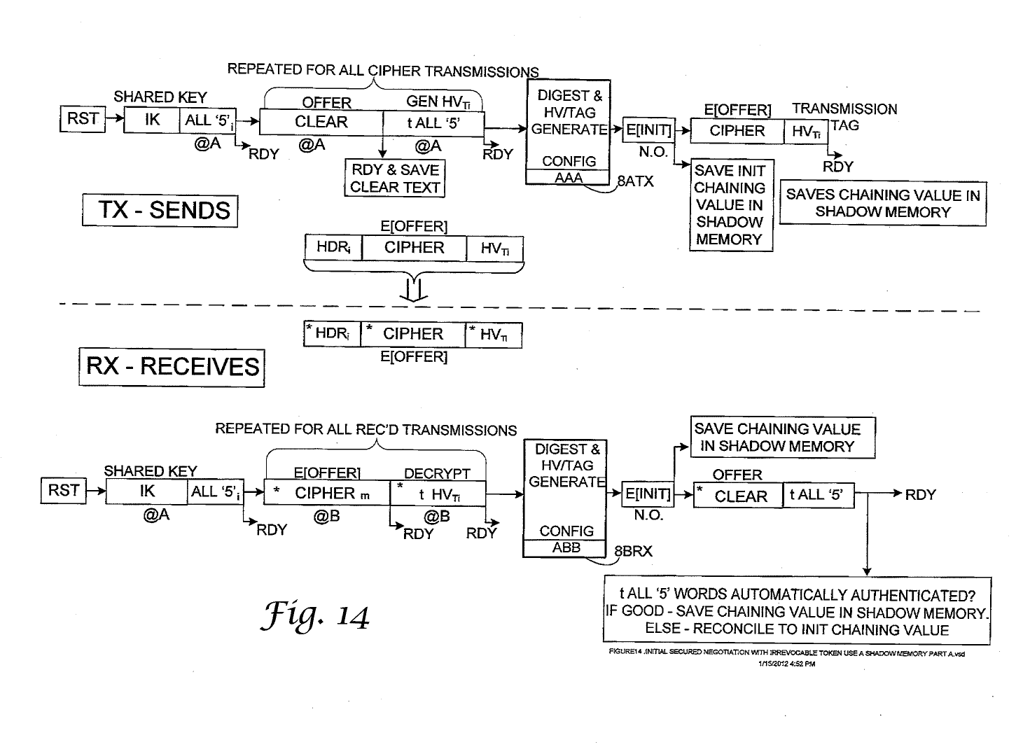

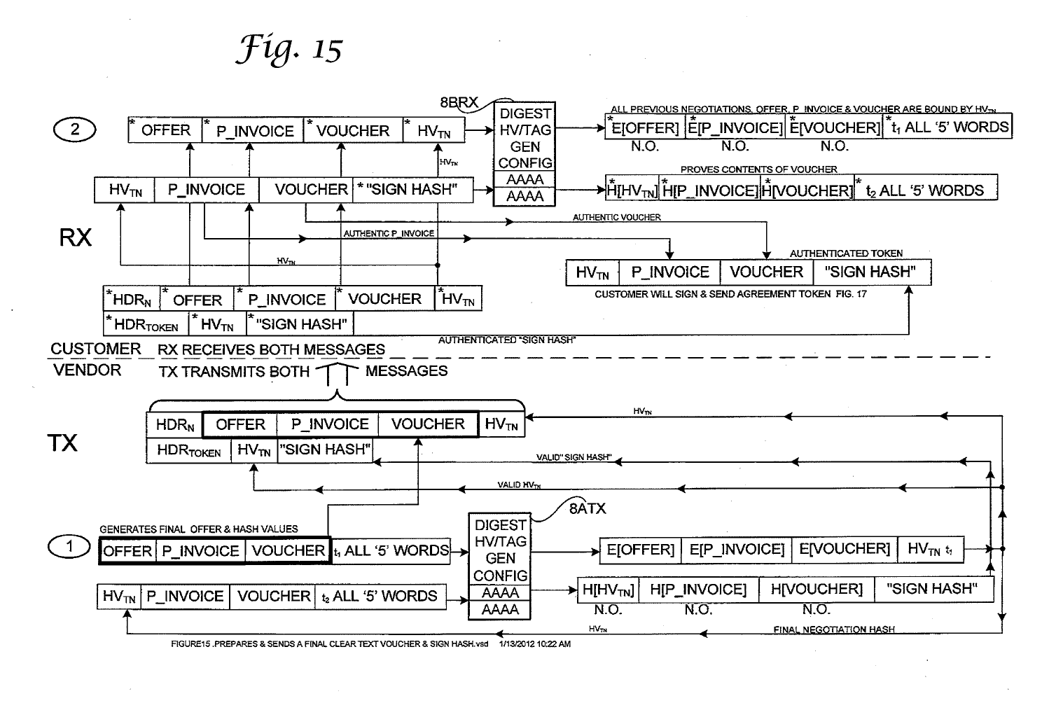

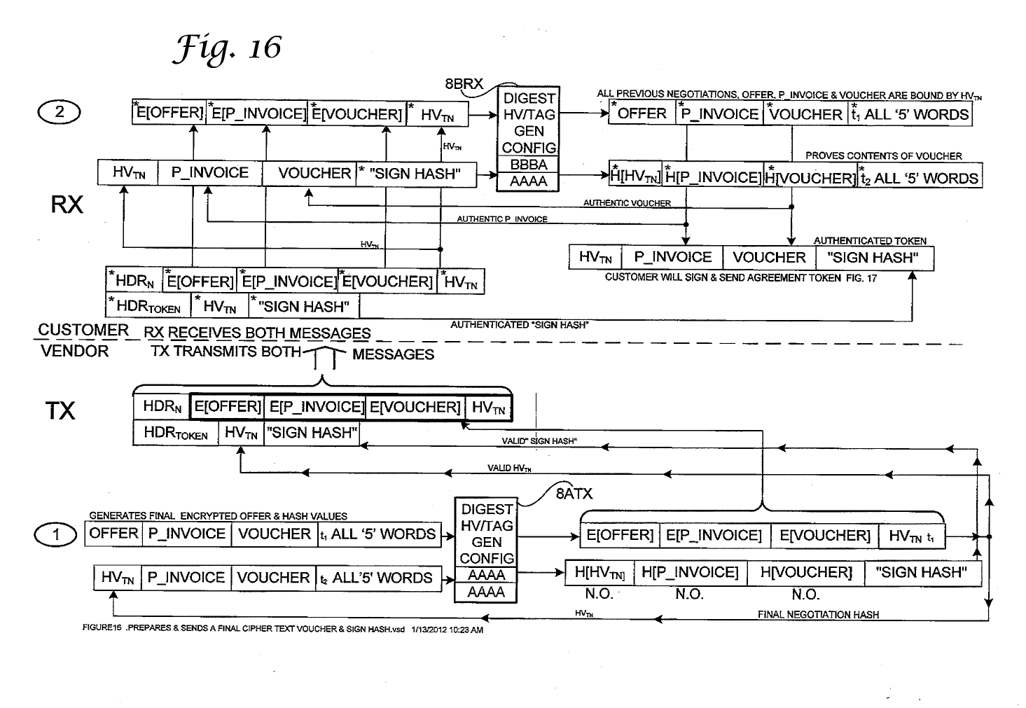

The following terminology is employed in the drawings:
FIG. 4: a-voucher=acceptance response;
   r-voucher=reoffer response/request;
   n-voucher=rejection response.
FIGS. 7 and 8: HV=hash value; a concatenated HV binds all previous hash values.
FIGS. 13 and 14:
defines the number of initialization (init) words including optional IV & Scrambles;
m defines the number of Message Words
t defines the number of Hash Value words (includes prefixed Scramble Words)
N.O. defines a data portion that is “Not Output” or “Read” or sent to a Host Port
* the asterisk typically defines a value that was transmitted of a noisy network; until Hash Value proves otherwise, True is Assumed.
FIG. 15:
P_INVOICE defines a non-negotionable invoice.
VOUCHER defines a Token Voucher.

### DETAILED DESCRIPTION OF CERTAIN EMBODIMENTS

Described herein is an accelerated transparent authenticated Data Exchange system wherein the chronology of alternating senders' and receivers' messages is authenticated typically at each step; e.g. each time a message is sent or received, with an easy to use provision for resending, in the event of faulty transmission, typically such that the final message hash value authenticates the negotiation chronologically from first to final message, wherein the final hash value is operative to enable a signature of an entity or entities which binds such entity to the whole data exchange, which signature may be in clear text, encoded, and/or encrypted with authentication integrity. The system is useful for managing computerized negotiations including client-initiated computerized negotiations and including computerized financial transactions.

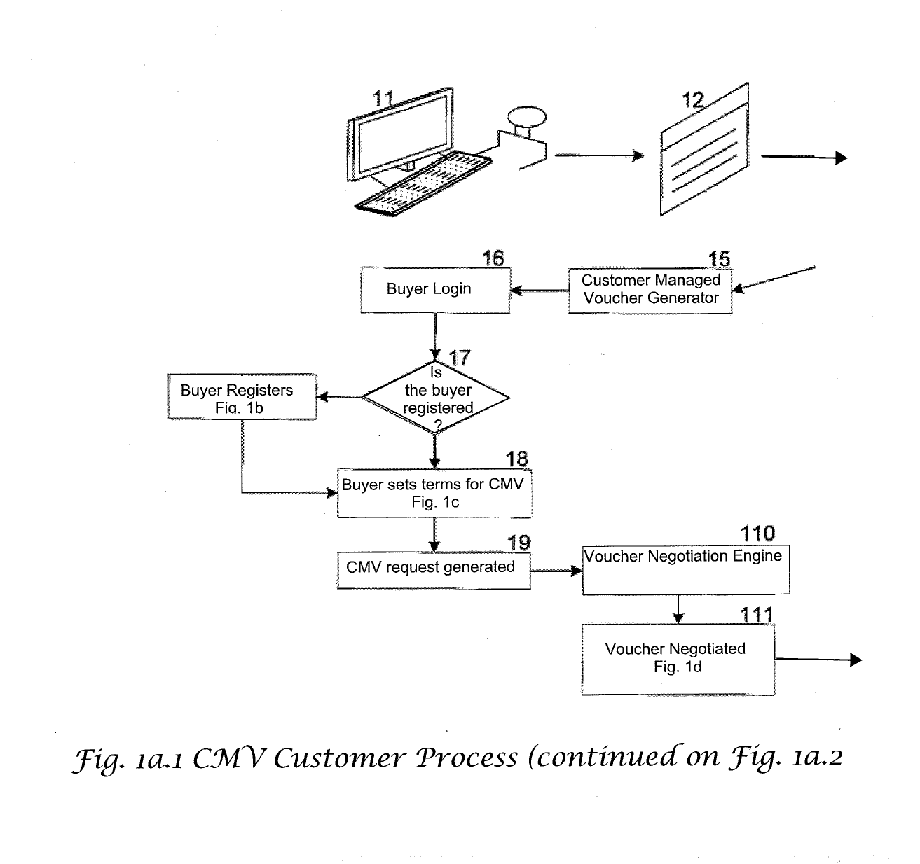

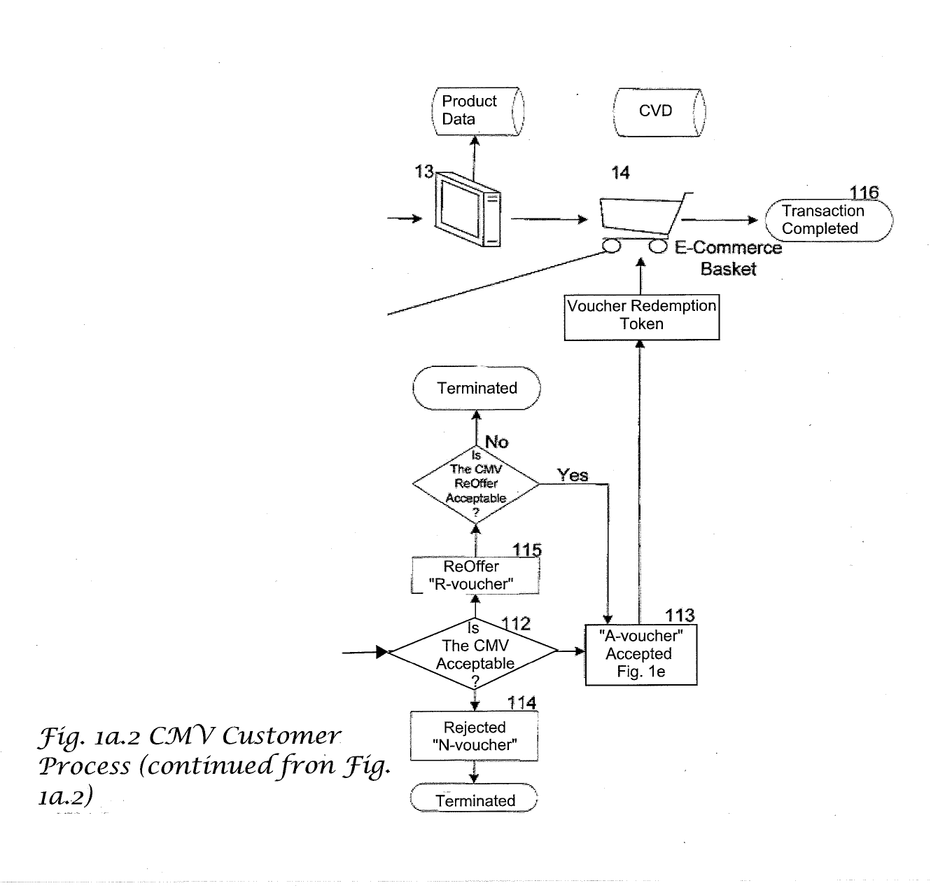

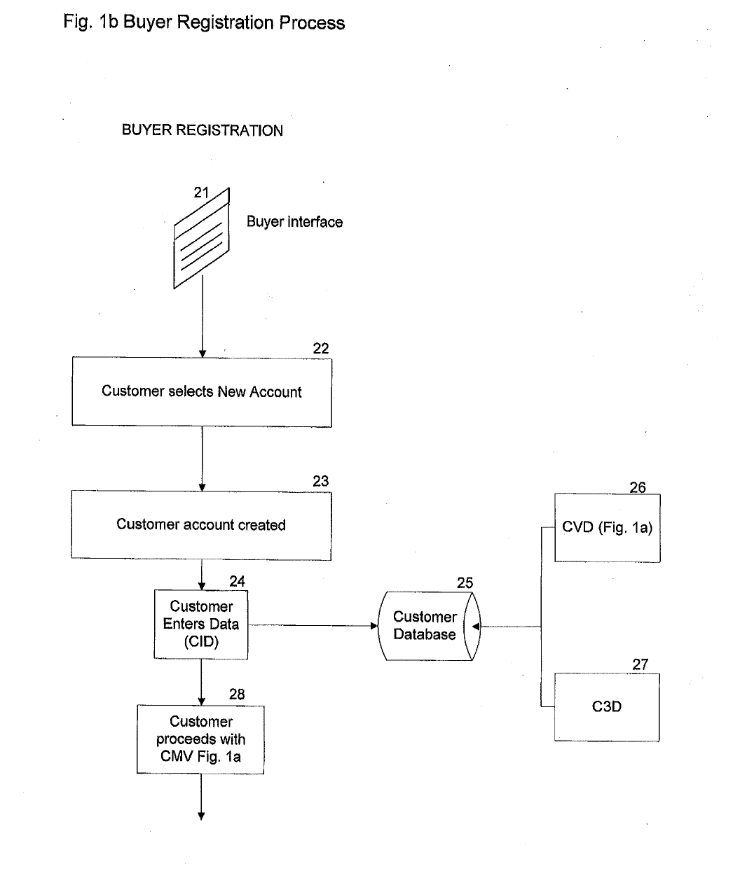

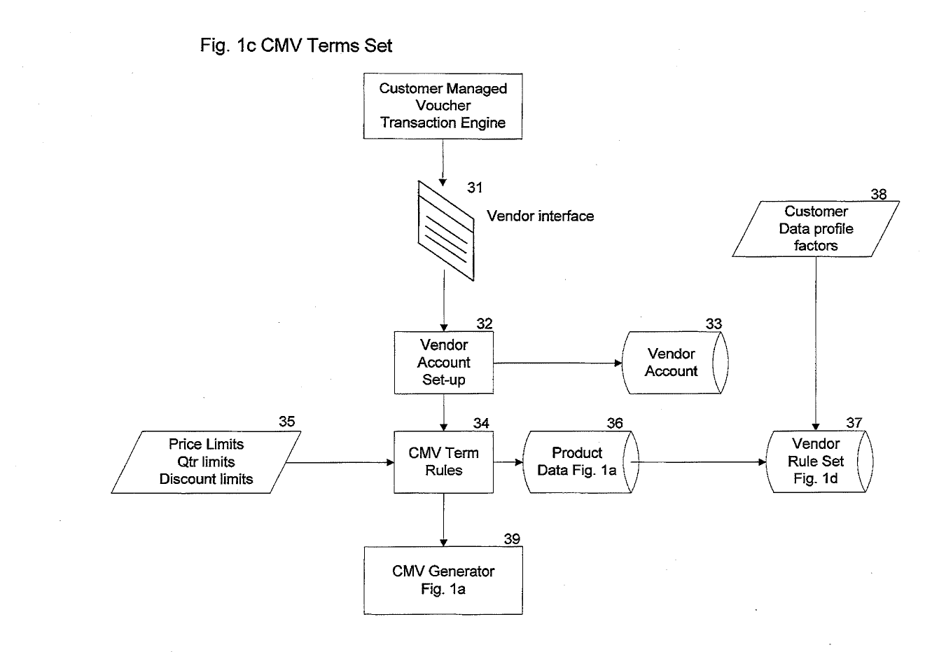

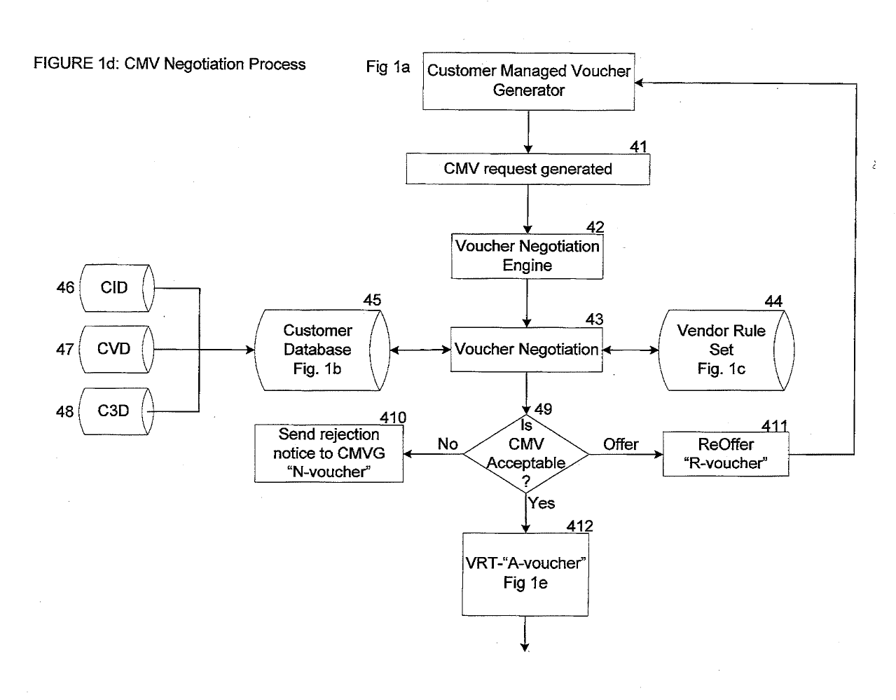

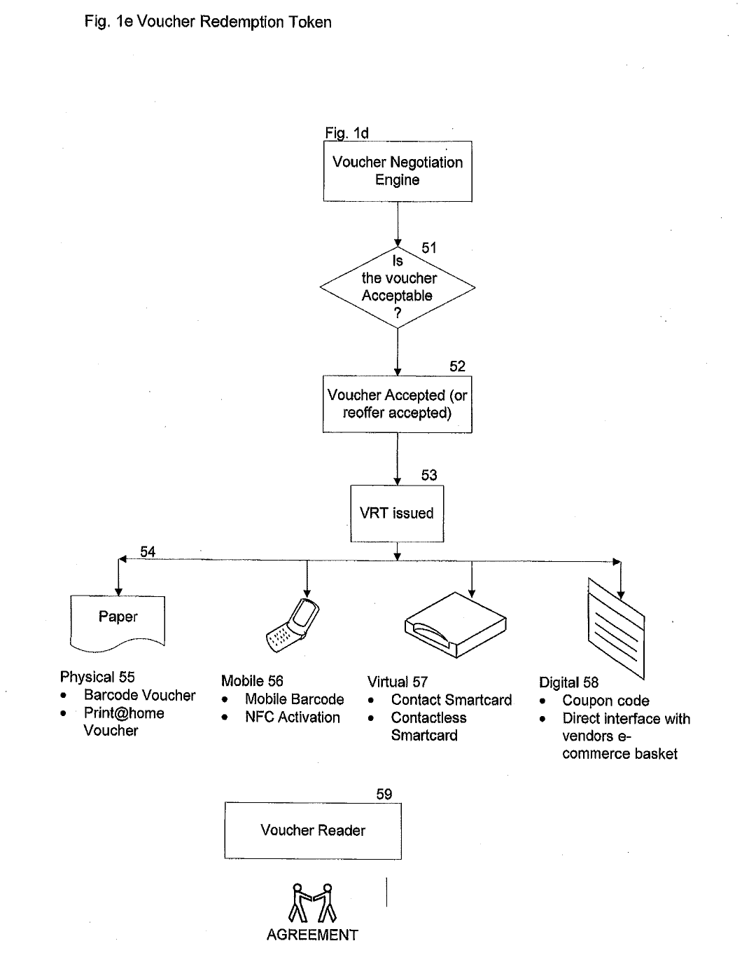

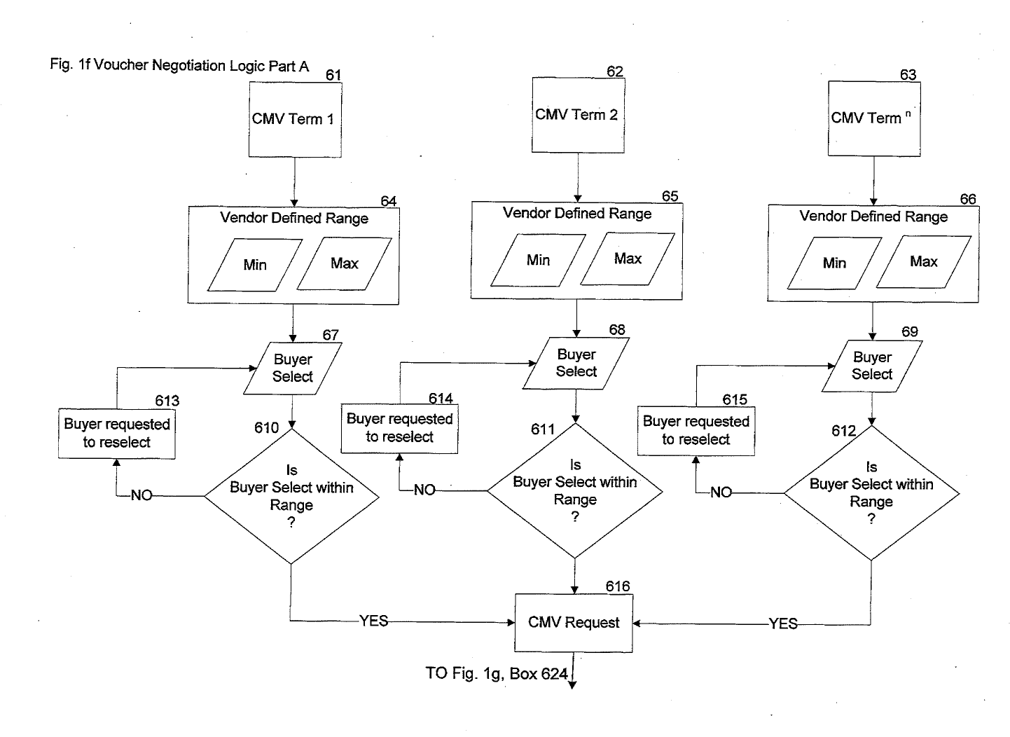

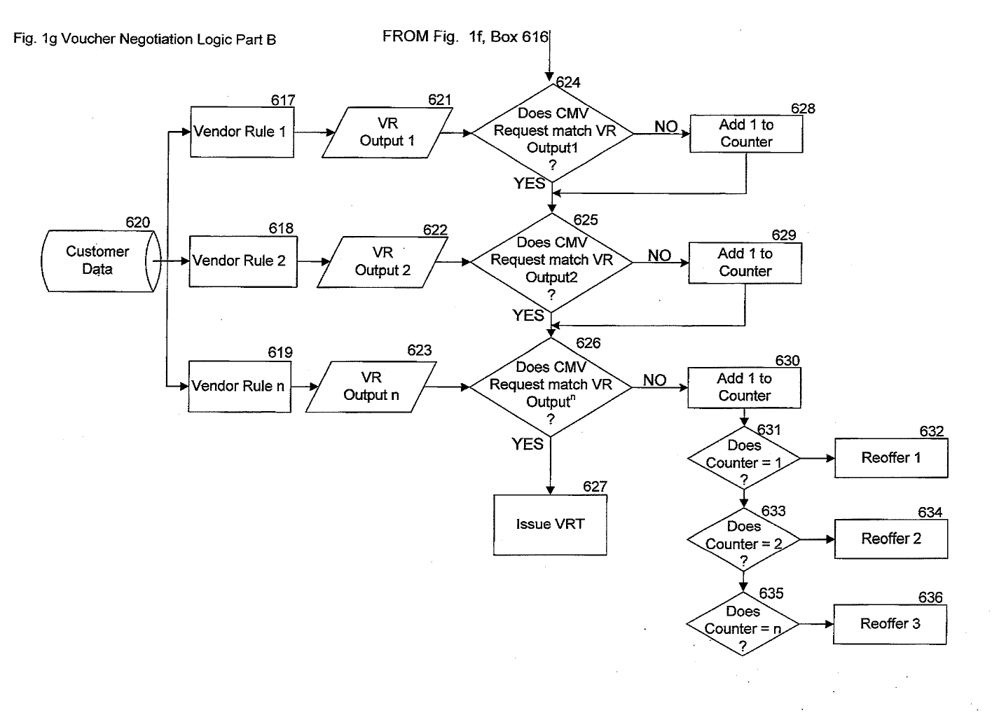

Reference is now made to FIG. 1a which illustrates a Negotiation initiating client Managed Voucher Negotiation initiating clients Process according to certain embodiments of the present invention. The steps of FIG. 1a may include some or all of the following, suitably ordered, e.g. as shown:

11 Negotiation initiating client goes to the vendor's website online
12 Negotiation initiating client login's and browses website as per normal activities
13 Negotiation initiating client selects products to purchase (data held in Negotiation initiating clients standard e-commerce product database).
14 Negotiation initiating client sends product selection to basket of vendor's website. Once negotiation initiating client has selected all the products/services it requires the recipient moves to the basket section of the vendors website as if to complete the transaction.
15 The Vendor's website contains an interface to the Negotiation initiating client Managed Voucher Generator (CMVG) in the basket section. At this stage the recipient can opt to create a negotiated computerized voucher (or of course they can just complete their purchase as normal).
16 If they opt to create negotiated computerized vouchers for the goods they have selected then they need to login to the Negotiation initiating client Managed Voucher Generator (CMVG) with their username and password.
17 If the recipient is registered then the recipient can move straight to creating the negotiated computerized voucher Request, if not then the recipient may need to register with the negotiated computerized voucher transaction engine through the Negotiation initiating client Managed Voucher Generator (CMVG); e.g., in FIG. 1b).
18. The recipient can create a negotiated computerized voucher and set his/her own terms (CMVT), subject to the Vendor Rule Set (VRS) for that product (e.g. in FIG. 1c).
19. Once completed the recipient can generate a negotiated computerized voucher Request (CMVR) which is sent to the Voucher Negotiation Engine (VNE) component of the system to be negotiated (110)
1011. The negotiated computerized voucher is negotiated (e.g. in FIG. 1d) using the Vendor Rule Set and the Negotiation initiating client data.
1012. If the voucher falls outside the Vendor Rule Set (VRS) and is rejected then a rejection notice is sent to the recipient via the Negotiation initiating client Managed Voucher Generator (CMVG) interface (114).
1013. If the voucher is acceptable then a Voucher Redemption Token (VRT) is issued (e.g. in FIG. 1e) for that voucher and the recipient can complete the transaction on the terms agreed through the basket of the vendors website (1.16).
1015. The Voucher Negotiation Engine can also send an amended offer to the recipient via the Negotiation initiating client Managed Voucher Generator (CMVG) interface for the recipient to accept or reject. If they accept this amended offer then a Voucher Redemption Token (VRT) is created (e.g. in FIG. 1e), if they reject the offer, then the request is terminated.

FIG. 1b illustrates a process for registering as a recipient according to certain embodiments of the present invention. The steps of FIG. 1b may include some or all of the following, suitably ordered, e.g. as shown:

21. Through the Negotiation initiating client Managed Voucher Generator (CMVG) interface a new recipient can register for a recipient account on the negotiated computerized voucher transaction engine system.
22. Negotiation initiating client selects new recipient set-up
23. A new account is created in the Negotiation initiating client database with a unique username and password
24. The new recipient is prompted to enter profile data (CID) which is stored in the Negotiation initiating client Database (CD).
25. The Negotiation initiating client Database (CD) holds all the information on the recipient and contains both the Negotiation initiating client Input Data (CID) and additional information from the vendors own recipient databases (e.g. CVD) (26) (e.g. in FIG. 1a) and other 3^{rd} party databases (e.g. C3D) (27). This recipient data is used as part of the Voucher Negotiation process (e.g. in FIG. 1d).
28. Once the recipient account has been created the recipient can start to generate negotiated computerized voucher Requests via the Negotiation initiating client Managed Voucher Generator (CMVG) interface.

FIG. 1c illustrates a process whereby a Vendor creates the negotiated computerized voucher Terms according to certain embodiments of the present invention. The steps of FIG. 1c may include some or all of the following, suitably ordered, e.g. as shown:

31. The Vendor can manage the negotiated computerized voucher Terms via the negotiated computerized voucher transaction engine Vendor interface. This component enables the vendor to set the limits of the negotiated computerized voucher Terms that the recipient can select for each product.
32. The Vendor can create an account on the negotiated computerized voucher transaction engine using the account set-up routine.
33. The Vendor account information is stored in the Vendor Database.
34. The Vendor can create a rule set for each product/service defining the variable terms that the Negotiation initiating client can use in creating the negotiated computerized voucher Request.
35. The limits can be set for price, volume, discount, dates.
36. And can be attributed to each item in the vendor's product database, on an item by item basis, group of product items or as a whole.
37. The negotiated computerized voucher Terms rules are stored in the Vendor Rule Set (VRS) and are used as part of the Voucher Negotiation process.
38. The Vendor can also specify Negotiation initiating client profile factors as part of the Vendor Rule Set (VRS); i.e., previous purchases of the recipient, age, profile etc.
39. The negotiated computerized voucher Terms are applied to the Negotiation initiating client Managed Voucher Generator (CMVG) and used by the recipient when they create a negotiated computerized voucher request.

FIG. 1d illustrates a negotiated computerized voucher Request Negotiation Process operative according to certain embodiments of the present invention. The steps of FIG. 4 may include some or all of the following, suitably ordered, e.g. as shown:

41. Negotiation initiating client may create a negotiated computerized voucher Request using the Negotiation initiating client Managed Voucher Generator (CMVG) interface (e.g. in FIG. 1a)
42. Request is posted to the Voucher Negotiation Engine (VNE) a component of the negotiated computerized voucher transaction engine
43. The automated voucher negotiation process is undertaken by the Voucher Negotiation Engine (VNE). The process involves the system comparing the negotiated computerized voucher Terms in the negotiated computerized voucher Request against the Vendor Rule Set (44) for that product.
44. Where the Vendor Rule Set (VRS) specifies a specific recipient profile factor (i.e. prior spend, age, etc) the system may utilise the data in the Negotiation initiating client Database (45). This data is created using Negotiation initiating client Input Data (CID) (46), Negotiation initiating client Vendor Data (CVD) (47) and Negotiation initiating client 3rd Party Data (C3D) (48).
49. The system may analyse the CMVR (negotiation initiating client managed voucher response OR negotiated computerized voucher Request, depending on context) and compare to the Vendor Rule Set (VRS) for each product and if the terms of the CMVR are within the tolerance of the Vendor Rule Set (VRS) rules then the CMVR is accepted, if delta tolerance is within reoffer range then the system may reoffer the negotiated computerized voucher at restated terms or if not then the offer may be rejected.
4010. If the CMVR is rejected this is communicated to the recipient via the Negotiation initiating client Managed Voucher Generator (CMVG) Interface
4011. If the offer is within the reoffer tolerances then the system may create a Reoffer negotiated computerized voucher for the recipient. This is communicated to the recipient via the Negotiation initiating client Managed Voucher Generator (CMVG) Interface.
4012. If the offer is accepted then a Voucher Redemption Token (VRT) may be issued by the Voucher Negotiation Engine (VNE), FIG. 1e.

FIG. 1e illustrates a negotiated computerized voucher Redemption Process according to certain embodiments of the present invention. The steps of FIG. 5 may include some or all of the following, suitably ordered, e.g. as shown:

51. In the event that the Voucher Negotiation Engine (VNE) has accepted (52) the CMVR or the Negotiation initiating client has accepted the CMVR reoffer then Voucher Negotiation Engine (VNE) may generate a Voucher Redemption Token (VRT).
53. The voucher redemption token can be generated in different formats (Voucher Formats); the format generated may depend on the vendor's preference for the product or service being offered.
54. The voucher token formats are as follows:
55. The Voucher Redemption Token (VRT) can be issued as a physical paper or printed voucher carrying a unique barcode that can be identified and redeemed at the vendors point of sale. The recipient can print this direct from the Negotiation initiating client Managed Voucher Generator (CMVG) or delivered via email.
56. The Voucher Redemption Token (VRT) can be issued as a mobile barcode sent to the mobile phone of the recipient or as an activation of the NFC smart chip in the recipients mobile.
57. The Voucher Redemption Token (VRT) can be issued as a virtual activation of the smartcard device held by the recipient (either a contact or contactless card).
58. The Voucher Redemption Token (VRT) can be issued as a voucher code that the recipient can input into the website of the vendor to redeem the offer or as a direct database link to the vendors e-commerce basket so that the recipient can complete the purchase transaction at the new agreed terms.
59. The negotiated computerized voucher transaction engine also comes with a Voucher Reader designed to work directly with the negotiated computerized voucher transaction engine. The voucher reader can read and redeem all physical, mobile and digital Voucher Redemption Token (VRT) s created by the system. The Voucher Reader is a standalone unit or can be integrated into the vendor's point of sale systems.

FIGS. 1f-1g, taken together, illustrate an example logic flow for a Voucher Negotiation Engine according to certain embodiments of the present invention. The steps of FIGS. 1f-1g may include some or all of the following, suitably ordered, e.g. as shown:

A Two stage process may be employed:

Stage 1: the negotiated computerized voucher Generator checks the negotiated computerized voucher terms input by the recipient against the min and max negotiated computerized voucher range established by the vendor:

61, 62 and 63 negotiated computerized voucher Terms 1 to n established by vendor
64, 65 and 66 Maximum and Minimum range set by vendor for each term
67, 68 and 69 Negotiation initiating client inputs term request within the negotiated computerized voucher Generator for each term.
610, 611 and 612 each input is checked against vendor range, if within range then accepted and a negotiated computerized voucher Request is generated (616)
613, 614 and 15 If a term is not within the range then the recipient is notified via the Negotiation initiating client Managed Voucher Generator (CMVG) interface and has the opportunity to adjust until within vendor range. If they do want this option then the process is terminated.

Stage 2: the negotiated computerized voucher Request is checked against the Vendor Rules.

617, 618 and 19 The Vendor Rule Set set-up by the vendor within the negotiated computerized voucher transaction engine.
620, 621, 622 and 23 Queries against the Negotiation initiating client Database (one for each Vendor Rule Set (VRS)) and the output is created (VRO).
624, 625 and 26, For each item of the Vendor Rule Set (VRS) the VRO is matched against the negotiated computerized voucher Request if the terms are in accordance with all the VRO's then the negotiated computerized voucher Request is accepted and a Voucher Redemption Token (VRT) (627) is issued for the recipient to use.
628, 629 and 30 If for each Vendor Rule Set (VRS) the VRO does not match against the negotiated computerized voucher Request then a digit of 1 is added to the rejection counter and the negotiated computerized voucher Request is matched against the next item of the Vendor Rule Set (VRS). For each rejection the counter is progressed by one.
631 and 32 once all the Vendor Rule Set (VRS) have been checked a reoffer can be issued. The nature of the reoffer is predetermined by the vendor. The system enables multiple re-offers to be issued depending on the number of Vendor Rule Set (VRS) mismatches. For 1 mismatch (counter 1) then Reoffer 1 can be issued.
633, 634, 635 and 36 for each additional mismatch (counter 2 . . . n) then another one of the predetermined reoffers can be issued. In this way a negotiated computerized voucher Request for a recipient that is a close match to the Vendor Rule Set (VRS) can get a better reoffer than a recipient with only a loose match to the Vendor Rule Set (VRS); i.e., a recipient that spends more (if spend is a Vendor Rule Set (VRS)) gets a better reoffer than a recipient that has a limited prior spend with the vendor.

Examples of applications for the negotiated computerized voucher transaction engine shown and described herein include but are not limited to the following:

1) Computerized negotiations in the Airline Industry—A recipient wants to book a flight to Amsterdam, on a certain date, with a specific airline; wherein he is known to be loyal. He wants to obtain an incentive to travel. The recipient can go to the airline website, select the flight details, click on the airlines negotiated computerized voucher generator and build their negotiated computerized voucher request: This request maybe for a price discount, an upgrade, or even access to a lounge, a willingness to accept a late night flight, a willingness to spend discounted loyalty points, a discount on food or on board duty free purchases, agree not to accept free on board food or drink, get full or extra frequent flyer points for a discounted or super economy ticket, a discount on a hotel room, etc. This request may be analysed against the criteria selected by the airline and based on the recipient profile a response may be issued. If accepted the voucher may serve as the standard electronic ticket or the recipient may be sent a digital Voucher Redemption Token (VRT) that they can redeem online as part of the purchasing process.

2) Computerized negotiations in Retail purchasing—A recipient wants to purchase a specific item from a retailer (or wholesaler or manufacturer). The recipient generates a recipient managed voucher direct from the retailers (vendors) negotiated computerized voucher generator attached to the retailer's website. The negotiated computerized voucher Request is analysed by the retailer using the negotiated computerized voucher transaction engine and an automatic response is generated based on the profile of the recipient and other computerized management factors (such as stock levels).

3) Computerized negotiations in the Entertainment Industry—A football fan wants to obtain a ticket to a specific game. The fan generates a recipient managed voucher via the teams own website. This request is analysed by the teams negotiated computerized voucher transaction engine. In response to the negotiation the fan may receive an acceptance (A-voucher), a rejection (N-voucher) or a re-offer (R-voucher); e.g., the fan may receive the voucher as requested; or a standard price offer with added hospitality as an incentive or in a typically rarer case, an outright rejection.

The methods shown and described herein may be operative to safely prove identity of a valid entity in a system, to supply information to a cryptographically operated reader, with relative small memory size able to allow off-line entry to an applicant for entrance pendant on recent or immediate status of the applicant, as to the point of entry, the expected time interval of entry, and in some instances to revert in due time to an on-line mode as would be necessary in a crowd control environment, or time and attendance entrance points for university or hotel employees.

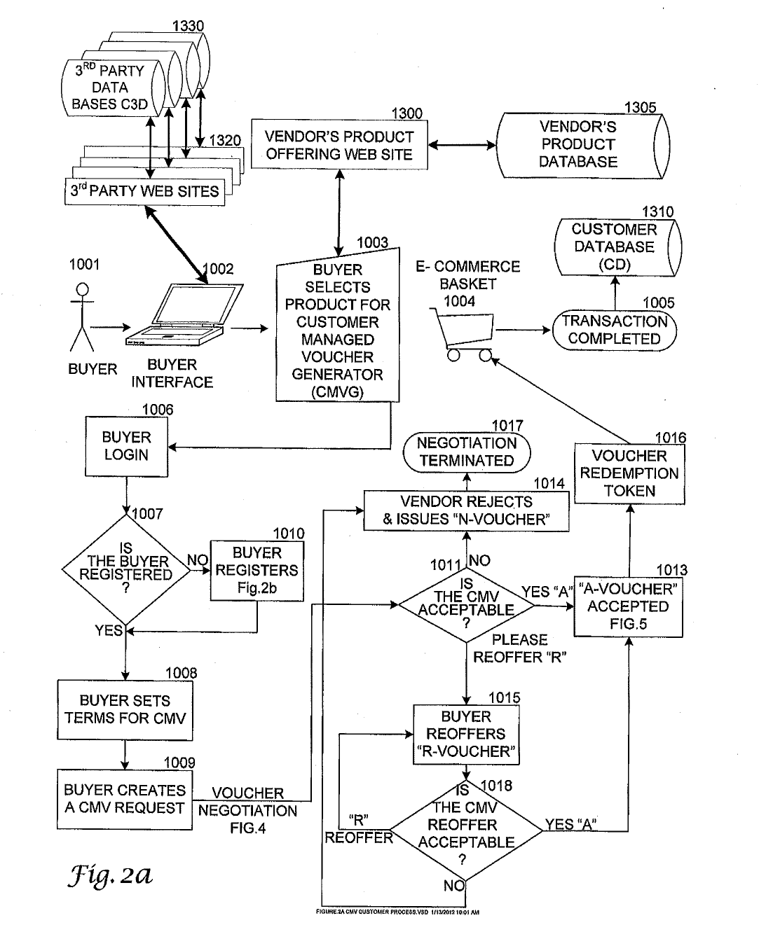

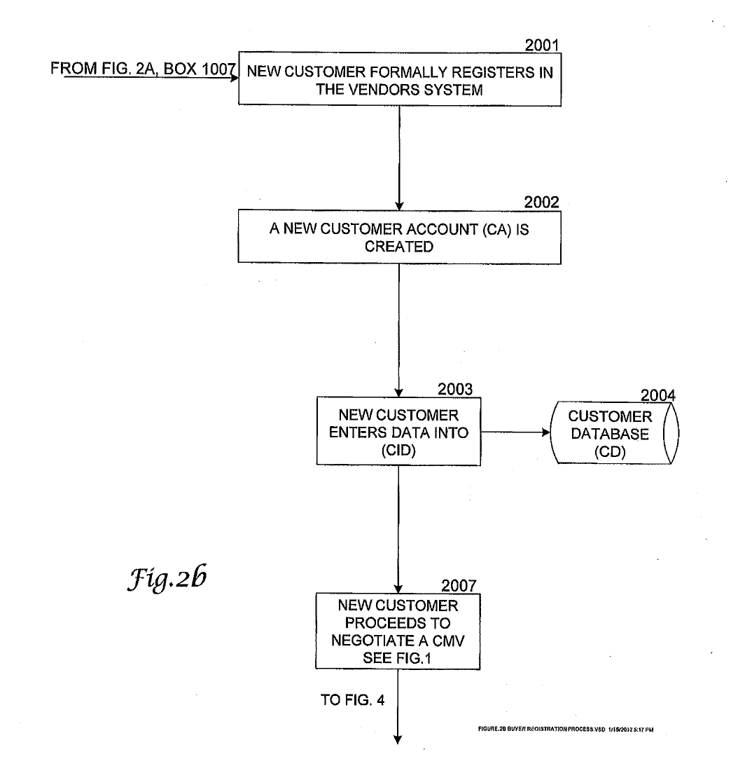

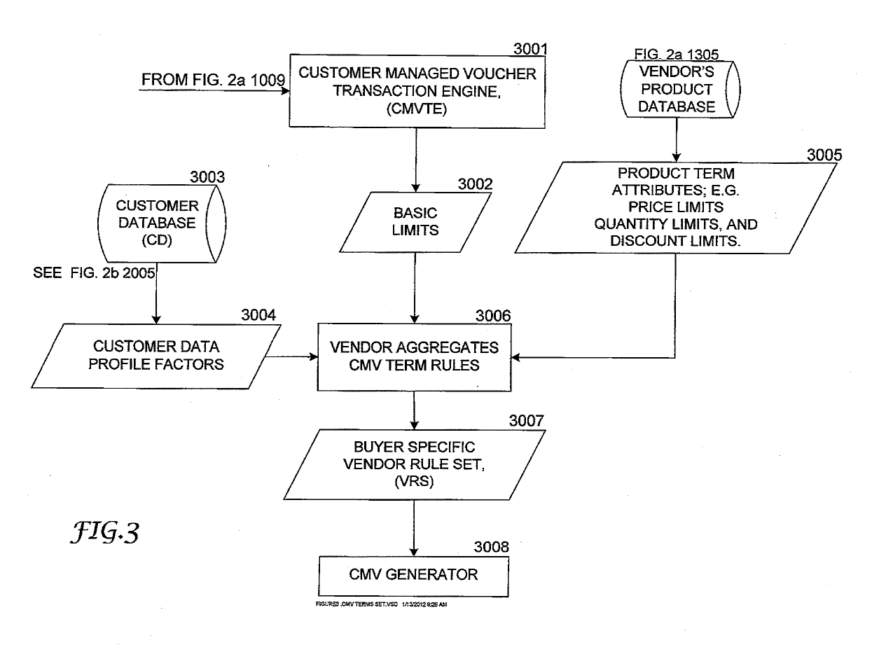

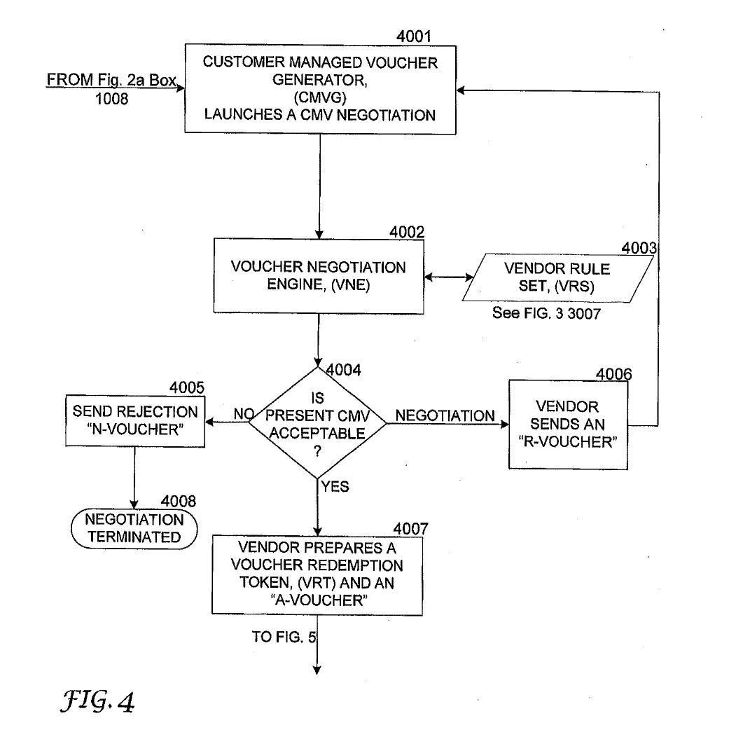

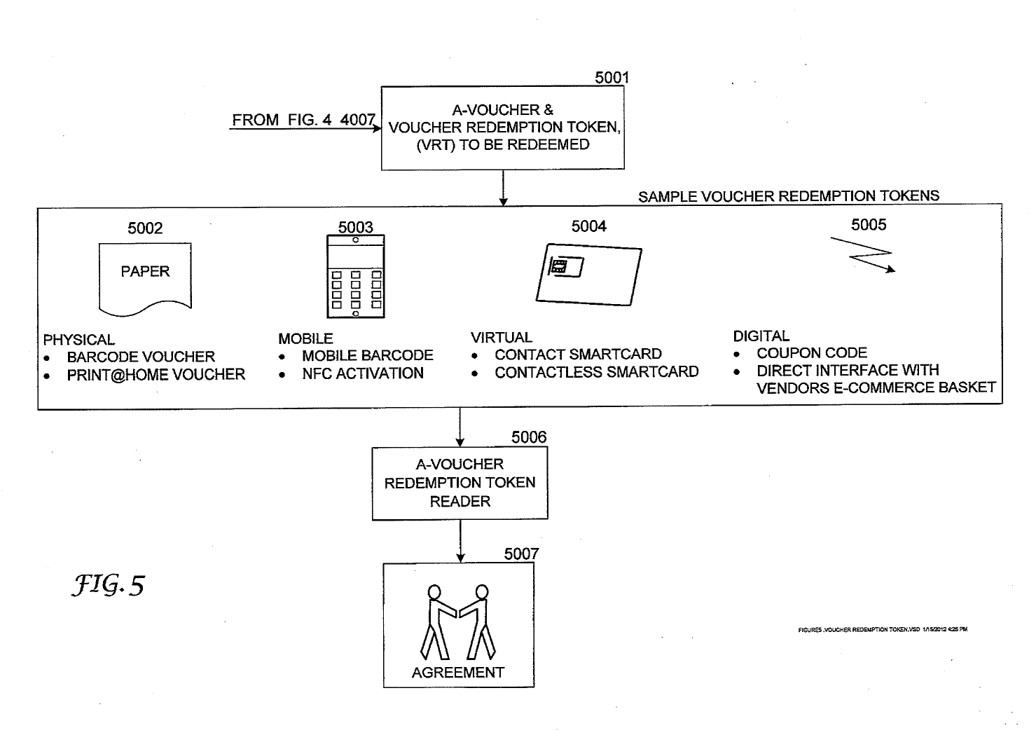

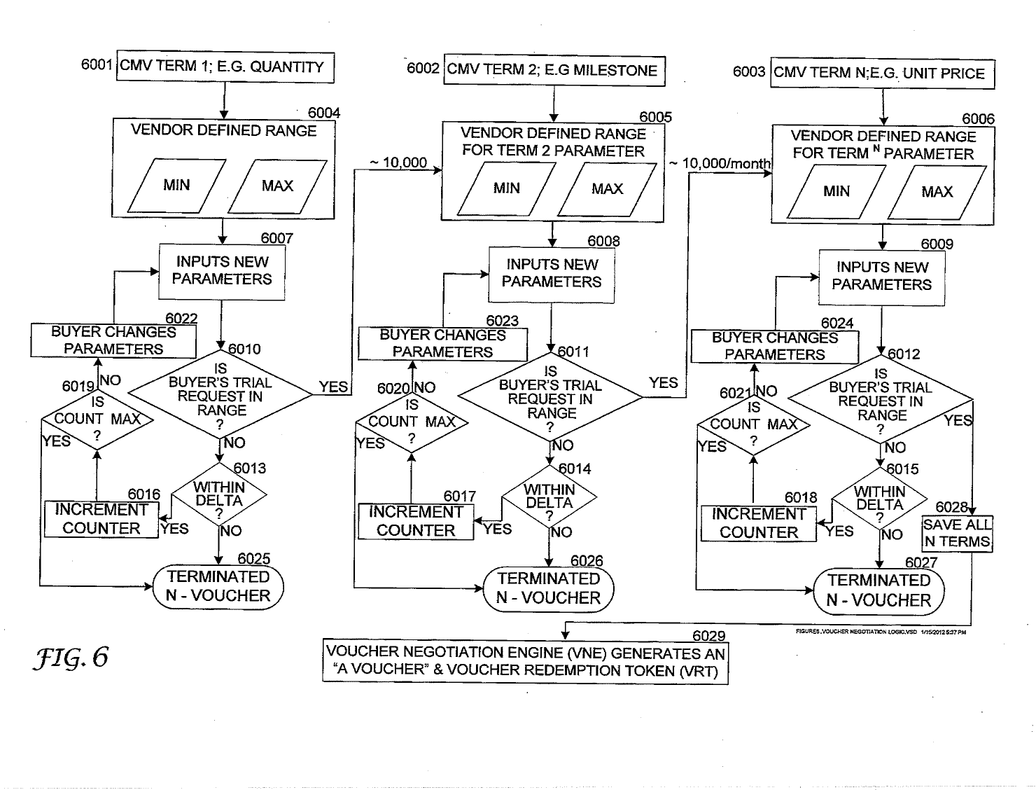

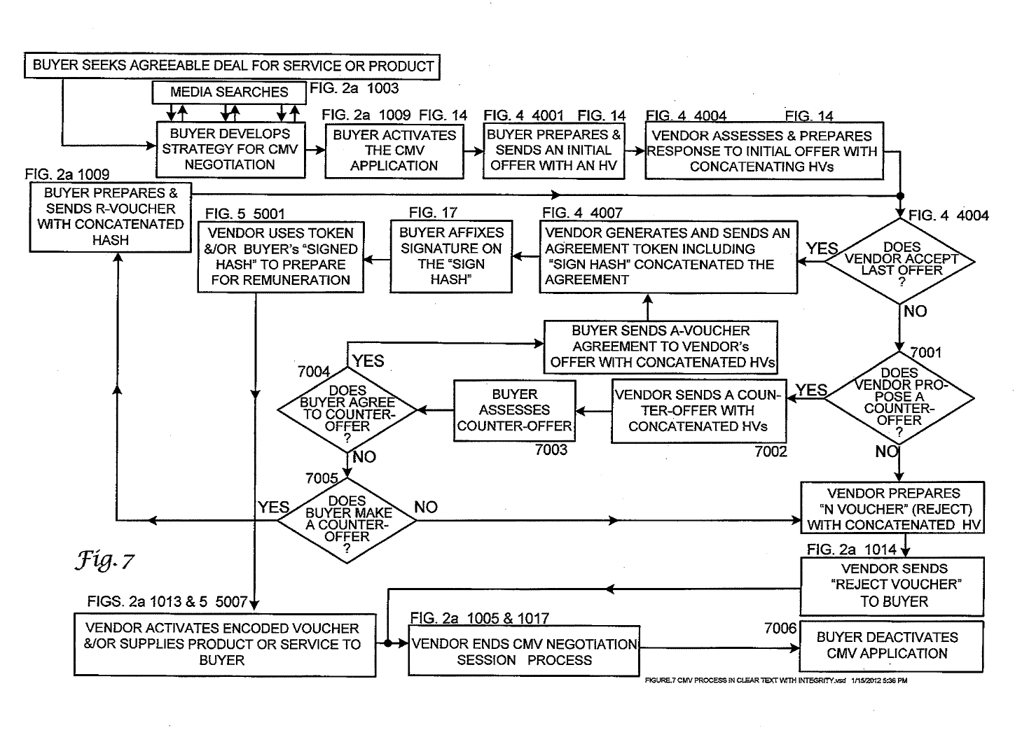

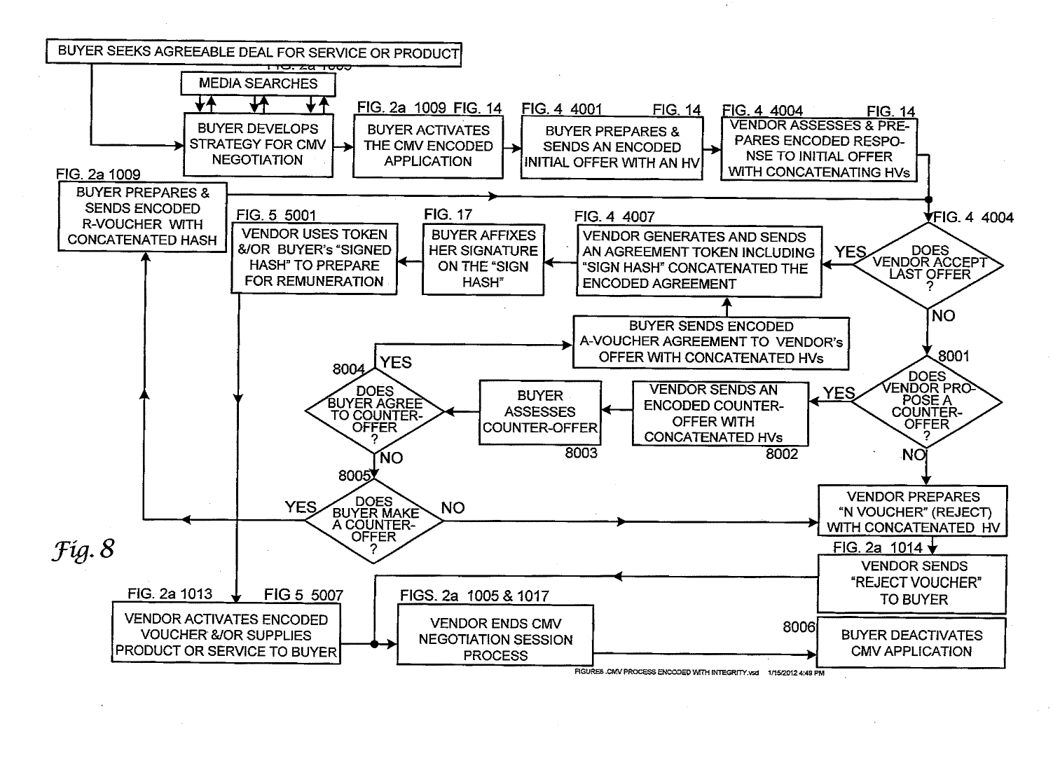

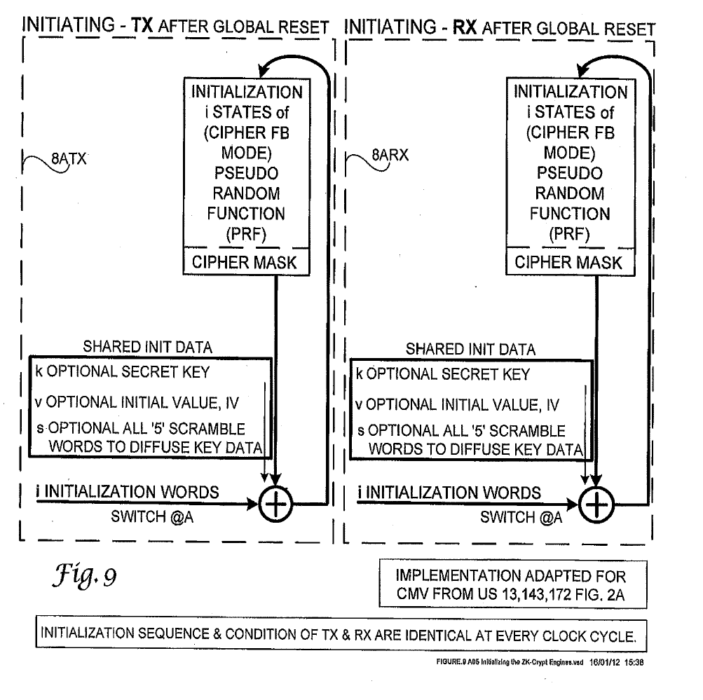

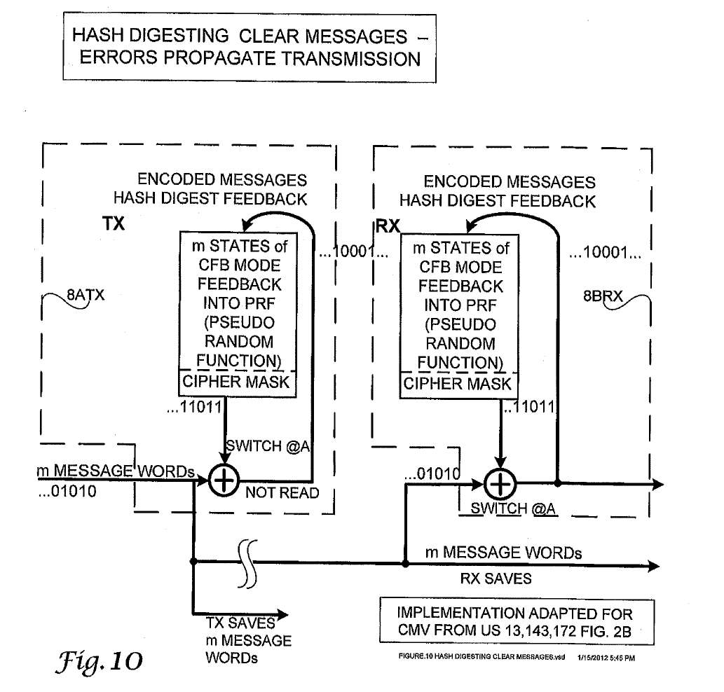

Automatic transactions may take place in hardware e.g. as described herein with reference to the embodiments of FIGS. 2a onward.

Older, commercially available Fortress GB Ltd. systems, some of which were deployed several years ago, handle up to 50,000 dynamically changing system clients, and presently deployed systems are able to accommodate up to 250,000 system clients in a disbursed environment with a plurality of entry points. Fortress GB Ltd's competitors have not been able to control access to such large clientele. The new systems may accommodate up to 1,000,000 potential users of such a system, where each of the 1,000,000 applicants for entry are recognizable in any one of the plurality of off-line points of entry. With new low-cost orders of magnitude large non-volatile memory, future entry controllers may accommodate, off-line, hundreds of millions of users' tokens and tens of millions of reader devices, embedded in a plurality of conventional and futuristic devices.

These systems have been and are being deployed with a multiplicity of security levels, methods and devices. Typically, the connections between the readers, servers, issuing computers and door and gate controllers have been protected with Public Key and symmetric Cryptographic means, e.g., RSA, DES, 3DES and Wolfram methods. Multi-application and multi-vendor applications have typically been implemented on public key protected smart cards and SIM chips. Users have had the benefit of multi-application public key protected smart cards and a plurality of emulated public key applications, using contactless Inside and Mifare devices.

In applicant's Provisional U.S. application No. 60/565,393, methods and apparatus for communicating with contactless smart cards are described, wherein the antenna in the terminal device, e.g., mobile phones, USB secured mass memory devices (Intellifiers) depicted in FIGS. 14 and 15 are integrated into the keypad of the terminal devices. In this patent we suggest that the antenna may also be included in the front plastic case or plastic clam shell cover of a terminal, to reduce power consumption, especially important for very near field NMR (nuclear magnetic resonance) used in unique substance detection, e.g., the materials manufactured by Micro Tag Temed Ltd., wherein such materials and means of detection are revealed in U.S. Pat. No. 5,986,550.
Any suitable technology may be employed to operationalize the embodiments shown and described herein, such as dynamic website technology and database management system technology.
It is appreciated that software rules and procedures need not be as shown and described herein and may use any suitable teachings of artificial intelligence; a dynamic website environment may optionally be employed.
According to Wikipedia, “A dynamic website is one that changes or customizes itself frequently and automatically, based on certain criteria. Dynamic websites can have two types of dynamic activity: Code and Content. Dynamic code is invisible or behind the scenes and dynamic content is visible or fully displayed. Dynamic code is code constructed dynamically on the fly using active programming language instead of plain, static HTML.”

According to Wikipedia, “A dynamic web page is . . . prepared with fresh information (content and/or layout), for each individual viewing. It is not static because it changes with the time (e.g. news content), the user (e.g. preferences in a login session), the user interaction (e.g. web page game), the context (e.g. parametric customization), or any combination thereof.”

A dynamic web page may be generated on the fly e.g. by piecing together blocks of code, procedures or routines. A dynamically-generated web page may recall information items from a database and put them together in a pre-defined format to present the reader with a coherent page. A dynamically-generated web page may interact with users e.g. by reading cookies recognizing users' previous history, session variables, server side variables etc., or by using direct interaction such as but not limited to form elements and mouse rejections. A dynamically-generated web page may display the current state of a dialogue between users, and/or provide information specific to an individual user.

A website may have with dynamic content displayed in plain view. Variable content is displayed dynamically on the fly e.g. by retrieving content stored in a database. According to Wikipedia, “A website with dynamic content refers to how its messages, text, images and other information are displayed on the web page and more specifically how its content changes at any given moment. The web page content varies based on certain criteria, either pre-defined rules or variable user input.”

There is a wide range of software systems, such as but not limited to ANSI C servlets, Java Server Pages (JSP), the PHP, Perl, Python, and Ruby programming languages, ASP.NET, Active Server Pages (ASP), YUMA and ColdFusion (CFML) that are available to generate dynamic web systems and dynamic sites. Sites may include content that is retrieved from one or more databases or by using XML-based technologies such as RSS.

Such databases may employ a database management system (DBMS) such as but not limited to Oracle, IBM DB2, Microsoft SQL Server, PostgreSQL, MySQL and SQLite.

Dynamic web sites may be Client-side scripted or server-side scripted. Client-side scripting and content creation may be employed to change interface behaviors within a specific web page, in response to mouse or keyboard actions or at specified timing events. Wikipedia describe that such web pages may use presentation technology called rich interfaced pages. Client-side scripting languages such as but not limited to JavaScript or Action Script, used for Dynamic HTML (DHTML) and Flash technologies respectively, may be used to orchestrate sound, animations, changing text, and other media items of the presentation. Client-side scripting may involve remote scripting, by which a DHTML page requests additional information from a server, using any suitable technology such as but not limited to hidden Frame, XML Http Requests, or a Web service.

Client-side content may be generated on a website user's computer. The web browser may retrieve a page from the server; process in the JavaScript (e.g., code embedded in the page) and displays the retrieved page's content to the user. The inner HTML property (or write command) is useful for client-side dynamic page generation.

Server-side scripting and content creation are now described. According to Wikipedia, “Server-side scripting is a web server technology in which a user's request is verified by running a script directly on the web server to generate dynamic web pages.” Server-side scripting may be used “to provide interactive web sites that interface to databases or other data stores. This is different from client-side scripting where scripts are run by the viewing web browser, usually in JavaScript.” Server-side scripting yields “the ability to highly customize the response based on the user's requirements, access rights, or queries into data stores.” According to Wikipedia, “A program running on the web server (server-side scripting) is used to change the web content on various web pages, or to adjust the sequence of or reload of the web pages. Server responses may be determined by such conditions as data in a posted HTML form, parameters in the URL, the type of browser being used, the passage of time, or a database or server state. Such web pages are often created with the help of server-side languages such as ASP, ColdFusion, Perl, PHP, and other languages. These server-side languages often use the Common Gateway Interface (CGI) to produce dynamic web pages. Two notable exceptions are ASP.NET and JSP, which reuse CGI concepts in their APIs but actually dispatch all web requests into a shared virtual machine. Server-side dynamic pages can also use the first kind of dynamic content on the client side.”

Combining client and server side technology is also known. For example, Ajax is a web development technique for dynamically interchanging content with the server-side, without reloading the web page.

Optionally, a transaction participant may be prompted to input a price and a source establishing the reasonableness of the suggested price e.g. a webpage offering the same or a related price.

Optionally, a transaction participant's Time to Answer No to a Vendor's last offer is recorded since certain windows of values for this parameter may indicate that the transaction participant is just fishing.

Optionally, a transaction participant's Time to Answer Yes to a Vendor's last offer is recorded. U.S. application Ser. No. 13/143,172 describes how we use cipher mode feedback to encrypt and hash, or to encrypt without hash, or to hash without reading the encryption. This is operable in the system described herein because in this system, optionally, hashing and encryption need not employ two different initializations and/or keys.

Typically, a long set of frames, or words encrypted as file data, is sent. The sender affixes a string of All ‘5’ (say) hexadecimal words e.g. 5555 5 55 . . . 5555 (binary 010101010 . . . ). The receiver decrypts the encrypted all ‘5’s; assuming that no false bit was sent (the encryption of data would also output gibberish but this might not be detected), and the receiver's machine detects and counts the All ‘5’s, and knows that all previous bits in the transmission are correct. Hash Digest herein typically comprises the feedback of encrypted words into what might be termed a pseudo random function PRF (Pseudo Random Function). The output of the PRF (Pseudo Random Function), the cipher mask, is identical in both Sender and receiver; it encrypts clear text, and deciphers cipher text. In the Cipher Feedback Mode, every Message bit diffuses into all of the variable bits in the cipher machine.

Elements which may, some or all, be provided in secured Negotiated Network Purchasing Based on Encryption with Integrity are now described in detail with reference to FIGS. 2a to 8.

In FIGS. 2a to 8, the words “buyer” and “customer” are both examples of a negotiation initiating client which seeks to initiate a computerized negotiation e.g. in order to activate a privileged purchase of goods and/or services.

FIG. 2a is an overview describing the negotiation of a Negotiation initiating client Managed Voucher negotiated computerized voucher (CMV) process according to certain embodiments of the present invention. The steps of FIG. 2a may include some, as shown, or all of the following, suitably ordered e.g. as shown:

1001 Negotiation initiating client logs on to the Internet 1002.

1002 Negotiation initiating client researches 3^{rd} Party product offering websites 1320 thereby drawing information from 3rd Party Data (C3D) Data Bases 1330 in preparation for creating a privileged CMV.

Negotiation initiating client logs into Vendors Negotiation initiating client Managed Generator website 1300; selects product to purchase from data held in Vendor's Product Offering website 1300 drawing product information from 1305 Vendor Product Database. At this stage the Negotiation initiating client is ready to prepare a negotiated computerized voucher (CMV) in the Negotiation initiating client Managed Voucher Generator.

1003. At the end of negotiation process, Negotiation initiating client's eCommerce Basket receives an A-Voucher and a Voucher Redemption Token enabling Negotiation initiating client to receive purchased Product.

1004 When a transaction is completed, Negotiation initiating client logs off, and Negotiation initiating client Managed Voucher Generator (CMVG) stores relevant data in the Negotiation initiating client Database CD 1310.

1005 Negotiation initiating client logs into Negotiation initiating client Managed Voucher Transaction Engine, CMVTE FIG. 3001.

1006 If the Negotiation initiating client is not Registered, Negotiation initiating client formally Registers in FIG. 2b; else:

1007 Negotiation initiating client prepares Term parameters for Negotiation initiating client's proposed CMV.

1008 The Negotiation initiating client creates a negotiated computerized Voucher and defines the Negotiation initiating client's own terms in Negotiation initiating client Managed Voucher Transaction Engine CMVTE, subject to the Vendor Rule Set VRS for product in FIG. 3 at element 3007.

1011: The Vendor's Voucher Negotiation Engine VNE assesses Negotiation initiating client's CMV, and decides either: to Reject 1014 and Terminate in 1017; or to accept and issue an A-Voucher in 1013; or to request a new Reoffer R-Voucher from the Negotiation initiating client 1015.

1016 The Vendor issues a Voucher Redemption Token with an A-Voucher.

1018 The Vendor assesses the negotiated computerized voucher (CMV) and decides either to: Accept and issue an A-Voucher in 1013; to Terminate in 1017; or to request a Reoffer from the Negotiation initiating client in 1015.

FIG. 2b illustrates a process for registering a new Negotiation initiating client according to certain embodiments of the present invention. The steps of FIG. 2b may include some or all of the following, suitably ordered, e.g. as shown:

2001 The Negotiation initiating client's Registration Interface BRI formally accepts a new Negotiation initiating client.

2002 A new Negotiation initiating client account CA is created granting the Negotiation initiating client a unique Username and Password.

2003 The Negotiation initiating client is prompted to enter Negotiation initiating client Input profile Data CID which is stored in; the Negotiation initiating client Database CD 2004 2007 When the Negotiation initiating client's account is activated and relevant, Negotiation initiating client launches a Negotiation initiating client Managed Voucher Generator Negotiation initiating client Managed Voucher Generator (CMVG) Negotiation, e.g. as shown in FIG. 4.

FIG. 3 illustrates a process whereby the Negotiation initiating client Managed Voucher Transaction Engine, CMVTE, creates the negotiated computerized Voucher Term parameters according to certain embodiments of the present invention. The steps of FIG. 3 may include some or all of the following, suitably ordered, e.g. as shown:

3001: The Vendor's Negotiation initiating client Managed Voucher Transaction Engine, CMVTE, creates a set of attributes for a negotiation process, including,

3002: Stored data of product basic limits.

3003: The Vendor's Negotiation initiating client Database CD contains each Negotiation initiating client's profile;

3004: from which relevant data for specific terms of negotiation are collected to be aggregated in element 3006.

3005: Chosen product attributes, e.g., stock, cost price, availability, etc. are drawn from Vendor's Product Database CVD FIG. 2a 1305 to be aggregated in—

3006: wherein Vendor Aggregates negotiated computerized voucher (CMV) Term parameters with Basic Limits 3002, graded by the Negotiation initiating client Profile Factors 34 and Product Term Attributes—to develop (at element 3007) a Vendor Rule Set, VRS, for a specific Negotiation initiating client's CMV—said VRS is processed in—3008 the negotiated computerized voucher (CMV) Generator CMVG, to launch a negotiation.

FIG. 4 is a simplified schematic of components and processes involved in an automated Negotiation initiating client Managed Voucher negotiation CMV. The steps of FIG. 4 may include some or all of the following, suitably ordered, e.g. as shown:

4001 Using the Negotiation initiating client Managed Voucher Generator (CMVG), the Negotiation initiating client launches a negotiated computerized Negotiation initiating client Voucher Request or Response in 4002 the automated Voucher Negotiation Engine (VNE) following the 4003 Vendor Rule Set VRS to decide—e.g. at element 4004—how to process the CMV; either in, 4005 the Voucher Negotiating Engine (VNE) 4002 which sends a Rejection N-Voucher, and the Negotiation is Terminated in 4008; or, 4006 the Voucher Negotiating Engine (VNE) 4002 which sends a request to Reoffer, an R-Voucher to the Negotiation initiating client Managed Voucher Generator (CMVG) to aid the Negotiation initiating client to assemble a Reoffer; or, if the negotiated computerized voucher (CMV) is acceptable the Vendor prepares an A-Voucher and a Voucher Redemption Token, VRT.

FIG. 5 demonstrates the process of culminating a successful negotiation the issuance a Voucher Redemption Token and an A-Voucher. The steps of FIG. 5 may include some or all of the following, suitably ordered, e.g. as shown:

5001: Culminating the process, the Vendor issues a Voucher Redemption Token and an A-Voucher in any one of the at least four sample formatted Voucher Redemption Tokens, VRT:

5002: the Voucher Redemption Token (VRT) may be issued as a commercially pre-printed or a home, over the Internet, printed Voucher 5005 carrying a unique barcode that can be identified and redeemed at the Vendor's Redemption Token and A-Voucher Reader 5006; wherein the Redemption Token 5002 is transmitted over the Internet, or delivered via email or by post mail; or,

5003: the Voucher Redemption Token (VRT) may be issued as a mobile barcode sent to or copied onto the Mobile Phone 5006 of the Negotiation initiating client or as a network activation via an NFC smartcard chip in the Negotiation initiating client's mobile phone; or,

5004: the Voucher Redemption Token VRT may be a remotely activated virtual Voucher Redemption Token VRT in the Negotiation initiating client's contact or contactless smartcard device 5007, transmitted by fix line or wireless telephone or over the Internet; or,

5005: the Voucher Redemption Token VRT may be issued as a Voucher code that the Negotiation initiating client may download from the Vendor's website FIG. 2a 1300, encoded digitally 5008 as a coupon code, or securely in the Vendor's eCommerce Basket FIG. 2a 1004.

5006: The Vendor's Voucher Readers may be designed to work directly with the negotiated computerized Voucher Transaction Engine FIG. 3 3001. The Voucher Redemption Token Readers are designed to read and redeem all physical, mobile and digital VRT s created by the system. The Vendor's Voucher Readers are typically standalone units or may be integrated into Vendors' point of sale systems.

FIG. 6 is a simplified flow chart describing a sequential negotiation of terms wherein the Voucher Negotiating Engine, VNE FIG. 4 4002 sequentially assesses the N Term Parameters input by the Negotiation initiating client's negotiated computerized voucher (CMV) 6001, 6002 and 6003 against the Min-Max Ranges in 6004, 6005 and 6006 prepared in the Vendor Rule Set VRS FIG. 3 3007, and readapted from prefixed Min-Max by previous settled Min-Max Range Terms, e.g., during the negotiation the Negotiation initiating client changes his/her Term Parameter order of 10,000 widgets to 100,000 widgets with new milestone delivery dates.

Into element 6007, 6008 and 6009 Term Parameters, the Negotiation initiating client optionally enters new Parameter requests/response wherein, elements 6010, 6011 and 6012 each input is checked against the adapting Min-Max ranges; if the 2 to N−1 negotiated computerized voucher (CMV) Term is within the range the term is accepted and the Term negotiation sequence proceeds to the next term; From accepted Term N the sequence proceeds to Save All N Terms in 6002.

In elements 6013, 6014 and 6015 the Voucher Negotiating Engine (VNE) checks to see if a term is within a reasonable small Delta proximity near to the Min-Max Range, the Negotiation initiating client is allowed to proceed to make a new offer; if Terms are not included in the small Delta of the Range, the negotiation is terminated in 6025, 6026 and 6027.

In elements 6016, 6017 and 6018 a Trial Counter is incremented at each attempt by the Negotiation initiating client to modify the CMVR Term; wherein, elements 6019, 6020 and 6021 the Voucher Negotiating Engine (VNE) rejects any trial Reoffer in excess of the Count Max and Terminates in—elements 6025, 6026 and 6027 with an N-Voucher; wherein via elements 6022, 6023 and 6024 the Negotiation initiating client submit s a changed Term Parameter to—6007, 6008 and 6009; wherein the Voucher Negotiating Engine (VNE) reassesses the new Parameters in 6010, 6011, and 6012, and from which the negotiation process is repeated.

FIGS. 7 and 8 are simplified flow chart wherein each figures describes a completed negotiated computerized voucher (CMV) multistep negotiation with concatenated intermittent and final hash value authentications; wherein all data exchanges in FIG. 7 are in Clear Text and in FIG. 8 the exchanges are implemented in authenticated Cipher Text. Clear and Cipher Text Chaining Values, and Hash Digests are identical in all steps of Hash Digesting and Hash Value generation. If the Initialization, FIG. 9, includes a secret shared key and a unique initial value, all data exchanges are optionally any mix of clear or cipher data exchanges.

The processes of FIGS. 7 and 8, in addition to being authentic, include a sequence of Negotiation initiating client amended Vendor's offers. In blocked steps 7001 to 7005 in FIGS. 7 and 8001 to 8005 in FIG. 8 either Negotiation initiating client or Vendor is enabled to make counter offers. All other blocked steps refer to vending and cryptographic functions explained in figures as denoted on the relevant blocks. In blocked steps 7&8001 and 7&8002 Vendor proposes a counter offer, in blocked steps 7&8003 to 7&8005 the Negotiation initiating client assesses Vendor's counter offer and decides to accept Vendor's offer or to make a counter offer or to reject.

FIGS. 9 to 12 schematically demonstrate the innovative steps of Cipher Feedback mode single stream Hash Digesting, encryption, and automatic authentication with an asynchronous automaton.

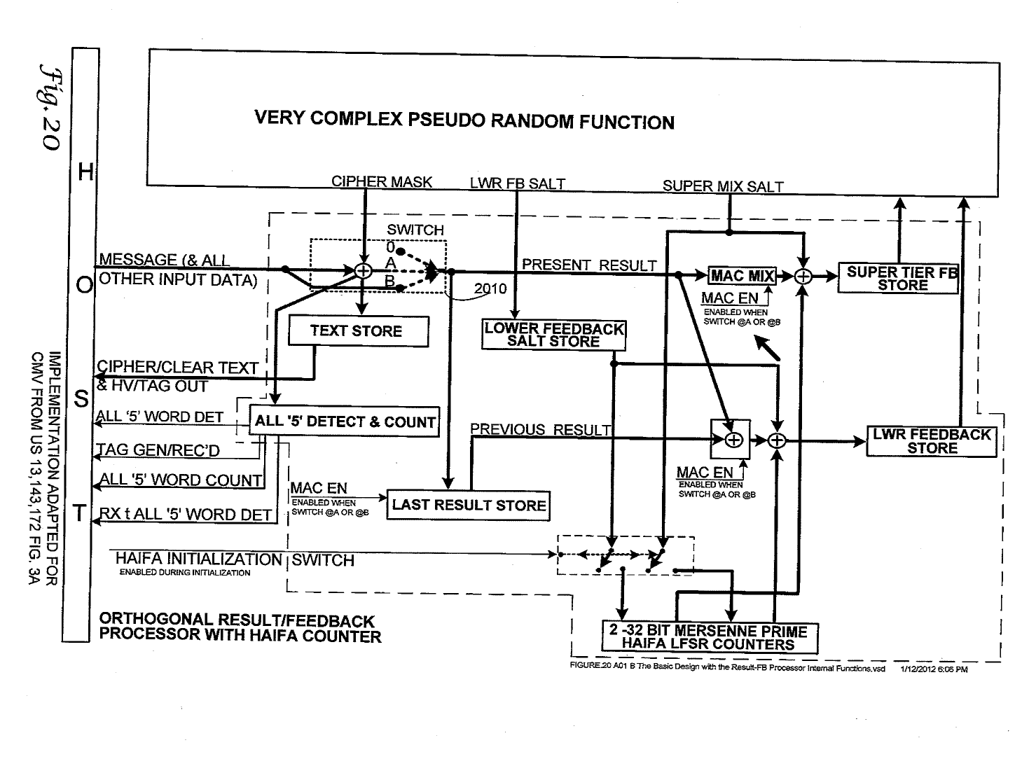

FIG. 9 is a block diagram copied from U.S. Ser. No. 13/143,172, published as US2011/028,6596, wherein both TX sender 8ATX PRF (Pseudo Random Function) and RX receiver's 8ARX PRF (Pseudo Random Function) identically hash digest initialization values; both in the of sender and receiver's pseudo random function, PRF (Pseudo Random Function), engines; operating in sender Cipher Feedback mode; said engines are functionally equivalent to previous versions of the FortressGB ZK-Crypt. If processes are simple Unkeyed Hash operations, without keyed hash or encryption, either a Global Reset with or without a known Initial Value is sufficient for universal un-keyed hashing. Cipher Feedback mode Switch, FIG. 20 is set @A, to insure that i Init Words affect the PRF (Pseudo Random Function) Chaining Values.

The above U.S. Ser. No. 13/143,172, published as US2011/0286596, describes at least the following embodiments which may be used in conjunction with systems and methods shown and described herein:

### Embodiment 1

A method comprises: applying a share encoding function on data to produce a plurality of encoded shares; generating a plurality of random numbers; obtaining a set of personalized authenticating values regarding user access to the data; generating a plurality of hidden passwords based on the set of personalized authenticating values; for each encoded share of the plurality of encoded shares: generating an encryption key based on a corresponding one of the plurality of hidden passwords and a corresponding one of the plurality of random numbers; and encrypting the encoded share utilizing the encryption key to produce an encrypted share; and facilitating storage of the plurality of random numbers and each of the encrypted shares.

### Embodiment 2

The method of Embodiment 1, wherein the share encoding function comprises at least one of a dispersed storage error encoding function; and a secret sharing function.

### Embodiment 3

The method of embodiment 1, wherein the generating the corresponding plurality of random numbers comprises: obtaining a plurality of base random numbers; and expanding each base random number of the plurality of base random numbers based on security parameters to produce the corresponding plurality of random numbers.

### Embodiment 4

The method of embodiment 1, wherein the set of personalized authenticating values includes at least one of: a user device identifier (ID); a user ID; a personal information number (PIN); a badge ID; a district ID; a work-shift ID; an assignment ID; a mission ID; a passcode; a password; a picture file; a video file; an audio file; a retinal scan; a facial scan; a fingerprint scan; a personal secret; and a password index number.

### Embodiment 5

The method of embodiment 1, wherein the generating the corresponding plurality of hidden passwords comprises: transforming the set of personalized authenticating values in accordance with a set of transformation functions to produce a set of transformed personalized authenticating values; and for each password of the corresponding plurality of hidden passwords: combining, in accordance with a combining function, one of the set of transformed personalized authenticating values with at least one of a constant and another one of the set of transformed personalized authenticating values to produce the password.

### Embodiment 6

The method of Embodiment 5, wherein the transformation function includes at least one of: a null function; a concatenation function; an inverting function; a hashing function; an encryption function; a compressing function; and a mask generating function.

### Embodiment 7

The method of embodiment 5, wherein the combining function includes at least one of: an addition function; a subtraction function; a multiplication function; a division function; a logical exclusive OR function; a logical OR function; and a logical AND function.

### Embodiment 8

The method of embodiment 1, wherein the generating the encryption key comprises: transforming the corresponding one of the plurality of hidden passwords utilizing a mask generating function, security parameters, and the corresponding one of the plurality of random numbers.

### Embodiment 9

The method of embodiment 1, wherein the facilitating storage of the corresponding plurality of random numbers and the encrypted shares comprises at least one of: sending the encrypted share and the corresponding one of the corresponding plurality of random numbers to a dispersed storage (DS) processing unit; dispersed storage error encoding the encrypted share to produce a plurality of encoded share slices and outputting the plurality of encoded share slices for storage; and dispersed storage error encoding the corresponding one of the corresponding plurality of random numbers to produce a plurality of encoded random number slices and outputting the plurality of encoded random number slices for storage.

### Embodiment 10

A computer comprises: an interface; a memory; and a processing module operable to: apply a share encoding function on data to produce a plurality of encoded shares; generate a plurality of random numbers; obtain a set of personalized authenticating values regarding user access to the data; generate a plurality of hidden passwords based on the set of personalized authenticating values; for each encoded share of the plurality of encoded shares: generate an encryption key based on a corresponding one of the plurality of hidden passwords and a corresponding one of the plurality of random numbers; and encrypt the encoded share utilizing the encryption key to produce an encrypted share; and facilitate storage of the plurality of random numbers and each of the encrypted shares.

### Embodiment 11

The computer of embodiment 10, wherein the share encoding function comprises at least one of: a dispersed storage error encoding function; and a secret sharing function.

### Embodiment 12

The computer of Embodiment 10, wherein the processing module functions to generate the corresponding plurality of random numbers by: obtaining a plurality of base random numbers; and expanding each base random number of the plurality of base random numbers based on security parameters to produce the corresponding plurality of random numbers.

### Embodiment 13

The computer of embodiment 10, wherein the set of personalized authenticating values includes at least one of: a user device identifier (ID); a user ID; a personal information number (PIN); a badge ID; a district ID; a work-shift ID; an assignment ID; a mission ID; a passcode; a password; a picture file; a video file; an audio file; a retinal scan; a facial scan; a fingerprint scan; a personal secret; and a password index number.

### Embodiment 14

The computer of embodiment 10, wherein the processing module functions to generate the corresponding plurality of hidden passwords by: transforming the set of personalized authenticating values in accordance with a set of transformation functions to produce a set of transformed personalized authenticating values; and for each password of the corresponding plurality of hidden passwords: combining, in accordance with a combining function, one of the set of transformed personalized authenticating values with at least one of a constant and another one of the set of transformed personalized authenticating values to produce the password.

### Embodiment 15

The computer of Embodiment 14, wherein the transformation function includes at least one of: a null function; a concatenation function; an inverting function; a hashing function; an encryption function; a compressing function; and a mask generating function.

### Embodiment 16

The computer of embodiment 14, wherein the combining function includes at least one of: an addition function; a subtraction function; a multiplication function; a division function; a logical exclusive OR function; a logical OR function; and a logical AND function.

### Embodiment 17

The computer of embodiment 10, wherein the processing module functions to generate the encryption key by: transforming the corresponding one of the plurality of hidden passwords utilizing a mask generating function, security parameters, and the corresponding one of the plurality of random numbers.

### Embodiment 18

The computer of embodiment 10, wherein the processing module functions to facilitate storage of the corresponding plurality of random numbers and the encrypted shares by at least one of: sending, via the interface, the encrypted share and the corresponding one of the corresponding plurality of random numbers to a dispersed storage (DS) processing unit; dispersed storage error encoding the encrypted share to produce a plurality of encoded share slices and outputting, via the interface, the plurality of encoded share slices for storage; and dispersed storage error encoding the corresponding one of the corresponding plurality of random numbers to produce a plurality of encoded random number slices and outputting, via the interface, the plurality of encoded random number slices for storage.

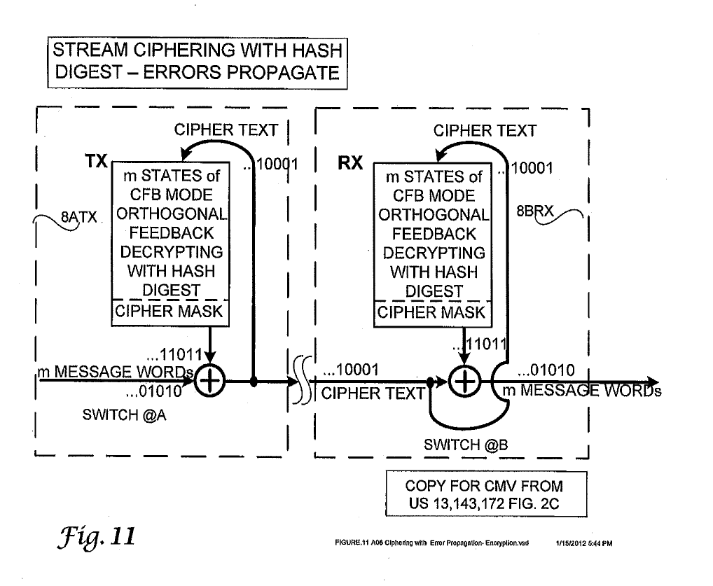

FIG. 10 is a block diagram adapted from U.S. Ser. No. 13/143,172, published as US2011/0286596's FIG. 2C, hereby to explain an authenticatable Clear Text transmission. Herein a sender, TX, hash digests m Clear Text Message Words in sender's Cipher Feedback mode PRF (Pseudo Random Function) 8ATX, Switch @A, e.g. as shown in FIG. 20; said sender transmitting said Clear Text messages (does not read coded output); and a receiver receiving an assumed accurate Clear Text transmission which receiver similarly hash digests in receivers PRF (Pseudo Random Function) 8ARX Switch @A, in sender Cipher Feedback mode. Errors in transmission corrupt the Chaining Values in the receiver's internal PRF (Pseudo Random Function) 8A RX variables, i.e., precluding an authentic optionally read decryption and an authentic hash digest.

FIG. 11 similar to FIG. 10 is a block diagram copied from U.S. Ser. No. 13/143,172, published as US2011/028,6596's FIG. 2C, hereby to explain the process of simultaneous enciphering and hashing. Herein a sender, TX, hash digests and encrypts m Clear Text Message Words in sender's Cipher Feedback mode PRF (Pseudo Random Function) 8ATX, Switch @A, e.g. as shown in FIG. 20; said sender transmitting Cipher Text messages; and a RX receiver, receiving an assumed accurate Cipher Text transmission which receiver decrypts and hash digests in receivers PRF (Pseudo Random Function) 8ARX Switch @B, in sender Cipher Feedback mode. Errors in transmission corrupt the Chaining Values in the receiver's internal PRF (Pseudo Random Function) 8ARX variables, i.e., precluding an authentic read decryption and an authentic hash digest.

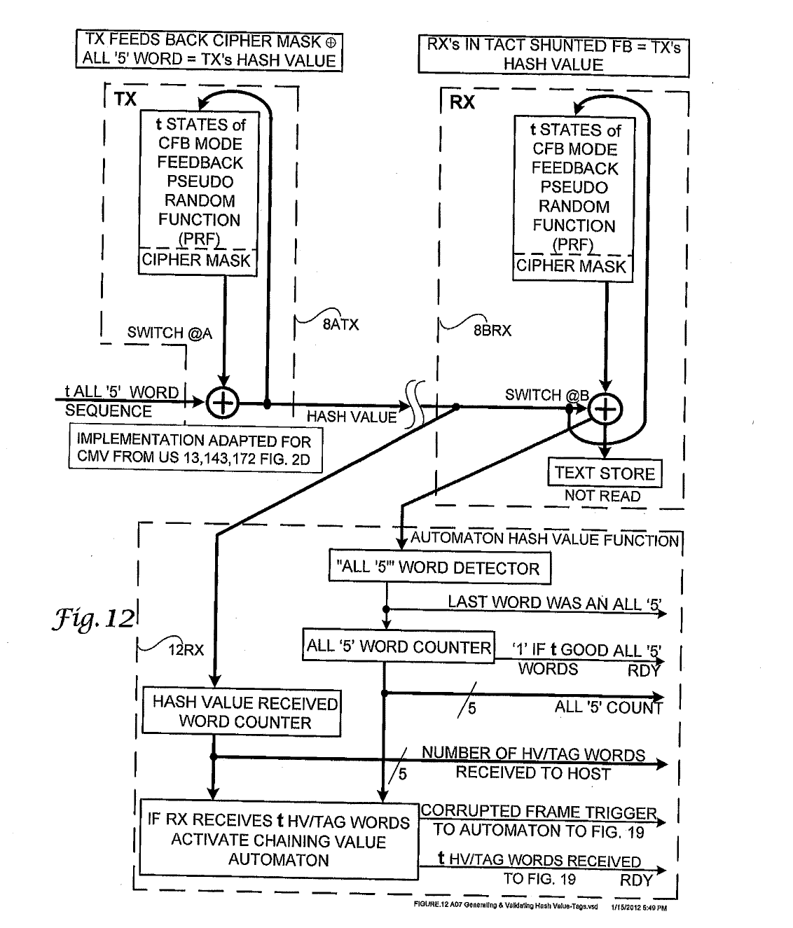

FIG. 12 is an enhanced block diagram adapted from U.S. Ser. No. 13/143,172, published as US2011/0286596's FIG. 2D, hereby to explain a process of a negotiated computerized voucher (CMV) authentication mechanism with a Chaining Value Reconciliation Automaton. Sender TX 8ATX PRF (Pseudo Random Function) Switch @A, e.g. as shown in FIG. 20, generates (enciphers t All ‘5’ Words) in sender Cipher Feedback mode; following the processes of FIGS. 10 and 11. Sender transmits the generated Hash Value to Receiver's 8BTX PRF (Pseudo Random Function), Switch @B.

From the Receiver RX 8BTX PRF (Pseudo Random Function) input, Hash Value Function Automaton, 12RX, counts the number of received alleged Hash Value Words. Simultaneously, Receiver RX 8BTX PRF (Pseudo Random Function), Switch @B, decrypts the t alleged Hash Value Words, and outputs the decryption, ideally a sequence of All ‘5’ Words to the Hash Value Function Automaton, 12RX.

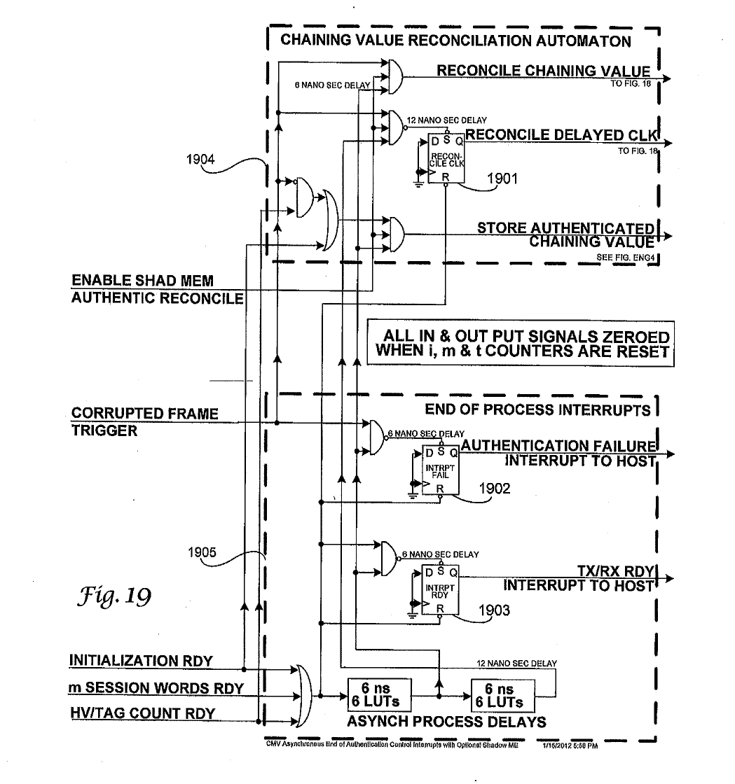

Following the input of t alleged Hash Value Words into Receiver RX 8BTX PRF (Pseudo Random Function), the Hash Value Function Automaton 12RX outputs two binary signals to the Chaining Value Reconciliation Automaton FIG. 19:

### Corrupted Frame Trigger=‘1’, if Hash Value Authentication Failed; and

t HV/Tag Words Received=‘1’; if Hash Value Received Word Counter output equals t.

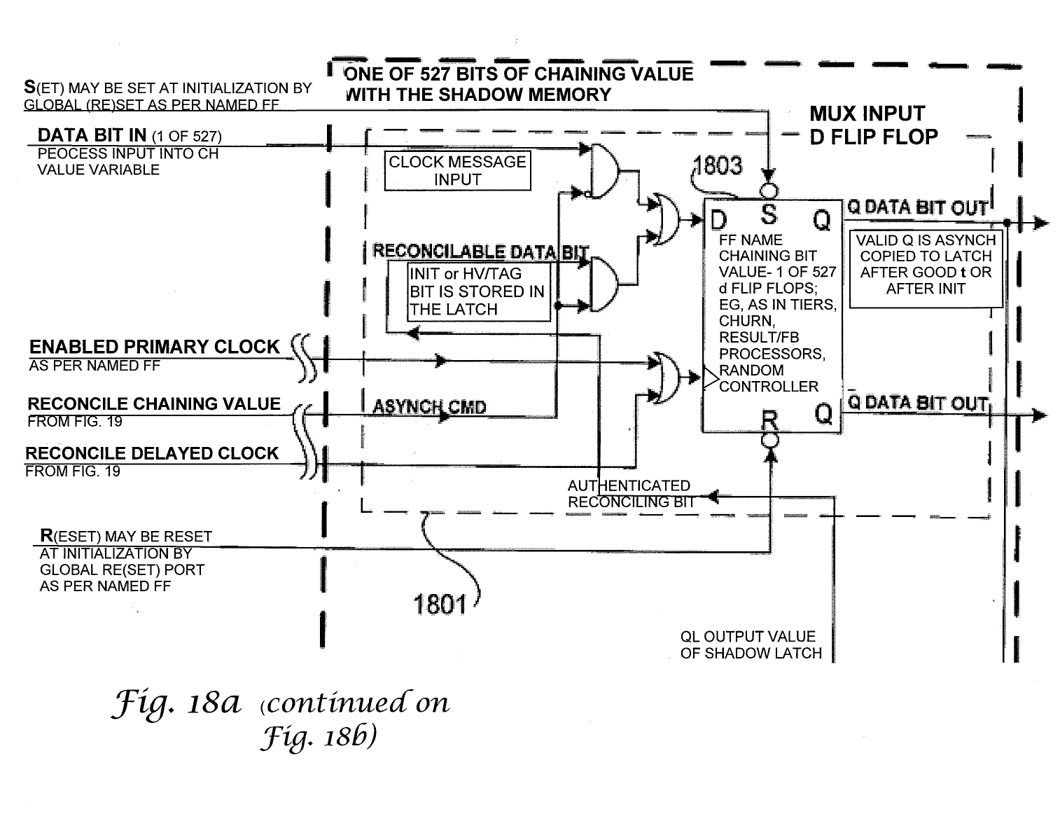

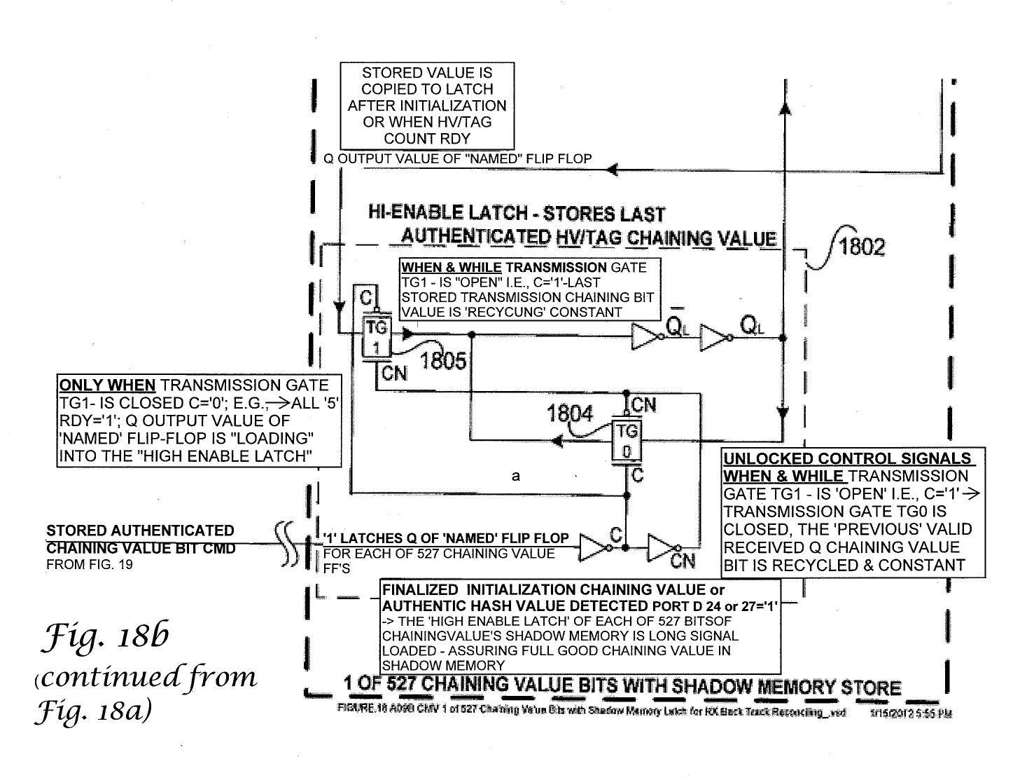

FIGS. 13 and 14 are block diagrams adapted from U.S. Ser. No. 13/143,172, published as US2011/0286596,'s FIGS. 7C and D, implementing the Cipher Feedback mode processes demonstrated in FIGS. 9-12 and the Automaton reconciliation of Chaining Values demonstrated in FIGS. 18 and 19. Typically, a Negotiation initiating client is the first TX-SENDS, and the Vendor is the first RX-RECEIVES. At each negotiation stage, typically, the negotiating last TX-SENDS becomes the next RX-RECEIVES.

The Shared Word Init Values, input into TX 8ATX PRF (Pseudo Random Function) Switches @A, and RX 8AB Switches @A are identical in FIGS. 13 and 14 first TX-SENDS and RX-RECEIVES.

In FIG. 13, TX-SEND and RX-RECEIVES demonstrate the negotiated computerized voucher (CMV) negotiation process exchanges, assuming that all Messages are sent in the Clear. The m Clear Text Words and the t Hash Value authenticators are processed in TX's sender Cipher Feedback mode PRF (Pseudo Random Function) 8ATX and transmitted by TX-SEND in a formatted transmission with a Header, HDR. TX saves the Clear Text Messages, and the suffixed HV_{Ti} Hash Value. TX SENDS' Automaton Asynchronously Saves Chaining Values in Shadow Memory following E[INIT] and subsequently after all HV_{Ti} Hash Values.

FIG. 13 RX-RECEIVES receives the *formatted transmission Clear Text and Hash Value. The *m Clear Text Words are processed in RX's RX 8AB PRF (Pseudo Random Function) with Switch @A and the appended *t Hash Values are deciphered with Switch @B; wherein the output anticipated *t All ‘5’ Words are tested by the Automaton of FIG. 12. FIG. 20's Reconciliation Automaton Saves the Init Chaining Value and also all successfully received Hash Value Chaining Values. If Authentication fails, FIG. 20's Reconciliation Automaton replaces the failed Hash Value Chaining Value, with the previous true Hash Value Chaining Value. RX-RECEIVES requests TX-SEND to repeatedly send the last transmission; RX-RECEIVES reprocesses the received transmission, typically only once, until RX-RECEIVES is ready for the next exchange.

By following the steps in FIG. 13, steps in FIG. 14 are self evident; wherein successful encryption and hashing are intractable, if the shared key is unknown to an intruder. Hash Values are obviously identical for all shared key negotiation steps in FIGS. 13 and 14. Likewise, in practice, the negotiation m Message Words exchanges are optionally a mix of Clear and Cipher Texts. It is assumed that Vendors and privileged Negotiation initiating clients prefer confidential encrypted exchanges.

Each HV_{Ti} in FIGS. 13 and 14 is an authenticator of all data exchanges from the 1^{st} to the Ti^{th} exchange. All previous and last exchanges are now the aggregate of Hash Digested data.

Procedural block renditions of final approval steps following successful negotiated computerized voucher (CMV) negotiations, as shown in the repeated FIGS. 13 and 14, are culminated here in FIGS. 15 and 16. Remember, the Chaining Value, following the (i−1)^{th} transmission, “launches” the i^{th} negotiated data exchange.

In this, the final N′th negotiation data exchange, the Vendor, TX, inputs agreement documents, herein, for example, an abstract of the offering, a Proforma Invoice and an A-Voucher, and generates the final aggregating Hash Value HV_{TN}.

Now, the sender prepares a hashed token, with HV_{TN}, a pseudo random number, with the “Sign Hash” Hash Value, which proves to any negotiator of the token, the verity of “Sign Hash” Hash Value. If either the Negotiation initiating client and/or the Vendor affixes a verifiable (manual or digital) signature on the “Sign Hash” Hash Value he becomes a responsible party to the whole negotiation, and the token; similar to a signer's committing him/herself to a third party when he/she manually signs a cheque or a contract. The third party processor of the token, for example a bank, typically neither would know, or care to know the details and intentions of a negotiation proceeding.

The final “Sign Hash” Hash Value will typically be implemented with a standard efficient in software Hash method, e.g., SHA-1, or SHA-256, not with a hardware PRF (Pseudo Random Function), which must be owned by the verifier. Notwithstanding, to simplify the explanation, we have demonstrated a hash using the same Cipher Feedback PRF (Pseudo Random Function).

The TN'th Hash Value, HV_{TN}, is a number, meaningless to an intruder who was not party to the original shared Init value; but which provably binds the whole negotiation proceedings, provably, only to an entity who shared the Initial Value and has access to a total transcription of the data exchange.

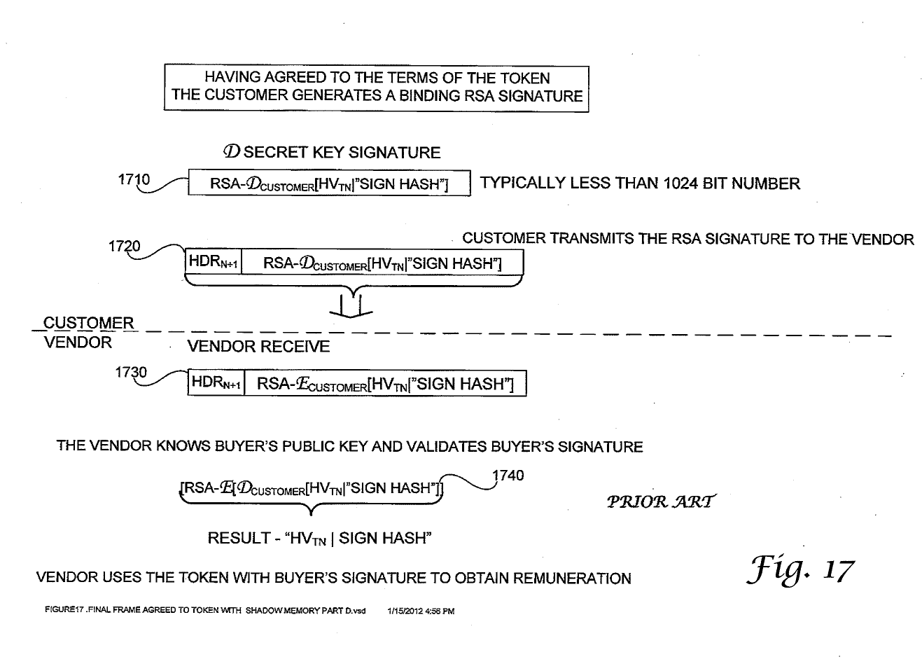

FIG. 17 is schematic example of use of the popular RSA signature scheme, operative to bind a Negotiation initiating client to an authenticated agreement. The Negotiation initiating client's signature on the “Sign Hash” bound to the Token can be used by the Vendor as proof of Negotiation initiating client's commitment and intentions. In this schematic:

Having agreed to the terms of the token, the Negotiation initiating client generates a binding RSA signature; where element 1710 is a schematic of Negotiation initiating client's signature on the concatenation, HVTN|“Sign Hash”, executed with the Negotiation initiating client's secret (D) RSA key. The concatenation is typically (in year 2012) a 1023 bit sized unique number. The negotiation initiating client transmits the signature, in 17.20 to the Vendor.

If the transmission 17.30 is accurately received, the Vendor, knowing the Negotiation initiating client's Public RSA Key, verifies, i.e., the result is the HV_{TN}|“Sign Hash”. The Vendor is entitled to use the Token with the Negotiation initiating client's signature to obtain agreed upon remuneration. Other legal identifiers not limited by this patent may be used to bind the “Sign Hash” Hash Value to a Negotiation initiating client or Vendor.

FIGS. 18 and 19 together show a single two part asynchronous Automaton circuit, 1904 and 1905 activating all and each Chaining Value Flip Flop circuit 1801 to its paired Shadow Memory Latch 1802, storing a last authenticated binary Hash Value.

Receivers are ready for a new data exchange with the Chaining Value of the previous authenticated exchange, ready to launch a new Hash Digest. If the next received data exchange is corrupted, RX requests TX to repeat the last exchange, which can only be processed with the previous authenticated Chaining Value.

At the end of an authenticated Hash Value reception, the Chaining Value the output of each multiplexed Chaining Value Bit 1801 is asynchronously input into the Hi-Enable Latch 1802, activated by the “Store Authenticated Chaining Value Bit Command” from FIG. 19.

Following a failed Transmission, two asynchronous Commands are sent from FIG. 19, Reconcile Chaining Value, which sets the Multiplexed Input to Data Bit 1801 enabled to receive the output value Shadow Memory Q_{L}, and 6 nano seconds later the Reconcile Delayed Clock which later clocks/updates the Flip Flop 1801.

1802 Hi-enable latch—stores the last authenticated Hash Value Chaining Value and records the finalized initialization Chaining Value into each and all Multiplexed Chaining Value Flip Flops.

The two part asynchronous Automaton Controller, with delay circuits which enable activation of the Automaton only after a settling period of potentially unstable data.

As the input signals to the Automaton Controller are generated during a rising Primary Clock, when data lines are typically in an as yet undefined state, the delays assure activation of the Save and Reconciliation signals at least 6 nano seconds (implementation dependent) after the end of a defined length of process sequence.

Control circuit 1905 relays to Control Circuit 1904 a Corrupted Frame Trigger command, to reconcile the Chaining Value to the last authentic Chaining Value in the event of a failed Data Exchange.

All Activating Flip Flops 1901, 1902 and 1903 are voltage level enabled:

Reconciliation Clock Flip Flop 1901 activation is delayed at least 12 nano seconds, to assure that the signal clocking FIG. 18 1803 Chaining Value flip flop arrives 6 nano seconds after the Shadow Memory data bit has “arrived” at the “gate”; i.e., propagated through the multiplexer circuit in 1801.

Authenticating Failure Interrupt to Host—Flip Flop 1902 commands the Host to Request a Resend of the last Data Exchange

TX/RX RDY Interrupt Flip Flop 1903—Notifies the Host that the last portion of Message or Hash Value has been TX sent or RX received.

The Store Authenticated Chaining Value input signal at ‘1’ input to FIG. 18 latch 1802, opens the “valve” 1805 in the Data Latch 1802 and closes the “valve” 1804 thereby loading the Last Authenticated Hash Value Chaining Value bit.

The Store Authenticated Chaining Value default input signal at ‘0’ input to FIG. 18 latch 1802, closes the “valve” 1805 in the Data Latch 1802 and opens the “valve” 1804 thereby isolating the latch 1802 leaving the last stored binary value to “circulate” a constant output “sitting” on the input Multiplexer to the Chaining Value Flip Flop 1801, ready to reconcile.

Control circuit 1905 relays to Control Circuit 1904 a Corrupted Frame Trigger command, to reconcile the Chaining Value to the last authentic Chaining Value in the event of a failed Data Exchange.

Control circuit 1905 also sends to the Host a RDY signal at the end of an Initialization, a Message or a TX Hash Value sequence. Simultaneously the Automaton sends an RX Hash Value Word Count Received signal, if and only if, the expected Hash Value is true.

FIG. 20 is an adapted prior art block diagram Cipher Feedback mode Result/Orthogonal Feedback Processor switching mechanism circuitry 2010, adapted from U.S. Ser. No. 13/143,172, published as US2011/0286596, FIG. 3A, and is of particular interest in this application wherein sender's encrypting and hash value generation are both encryption operations, Switch @A; and receiver's decryption and hash value authentication operations are decryption operations, Switch @B; are implemented in a single uninterrupted stream, Message In and Result Out in a single 100 MHz clock cycle.

Switch @0 is for conventional stream ciphering over noisy media. Not relevant to this patent. Switch @A is mandated for confidential Initializing of Engines using shared initialization data used for all encoding and hashing function initialization procedures;

Switch @A is the TX Sender Mode for all data exchanges. TX Sender's encrypted data is the feedback source.

Switch @B shunts Sender's incoming encrypted data directly into RX Receiver's Feedback, guaranteeing that the Chaining Values of Sender and Receiver are identical at every clock cycle, assuming that the transmission path is reliable.

FIGS. 9 to 12 simplified schematics graphically explain TX Sender and RX Receiver's identical Chaining Value.

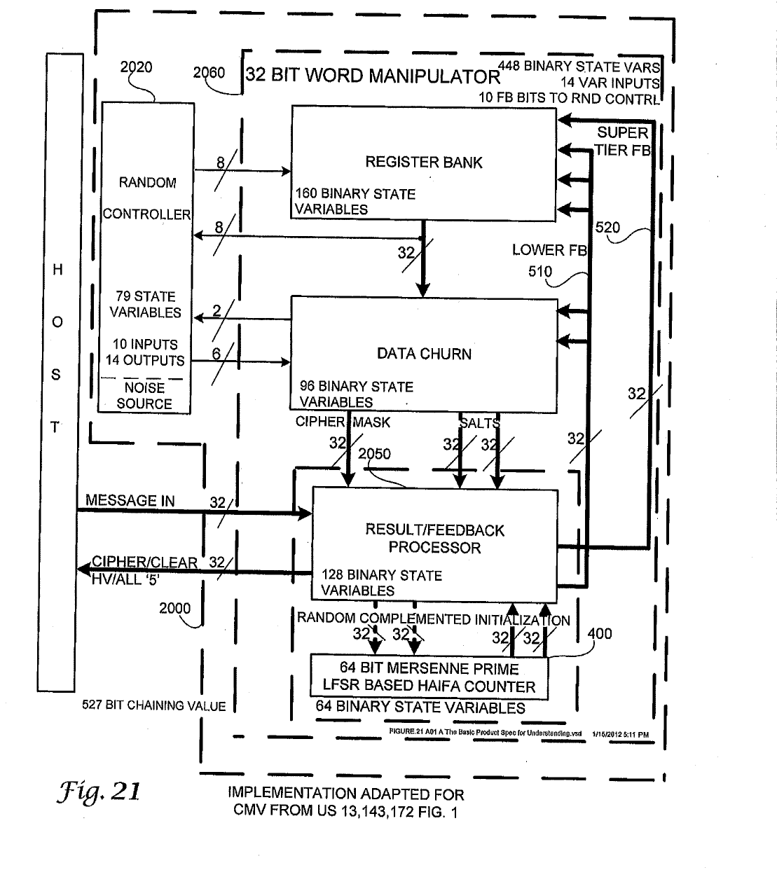

FIG. 21 is the block diagram of the enhanced ZK-Crypt, adapted from U.S. Ser. No. 13/143,172, published as US2011/0286596. The new rendition includes unique new deterministic randomizing circuitry and an Automaton, e.g. as shown in FIGS. 13-14, and 19-20, designed to efficiently process the negotiated computerized voucher (CMV) and other negotiation data exchanges over potentially noisy networks.

It is believed that a long life device that Encrypts and Authenticates accelerated confidential data exchanges securely is best implemented in hardware, with permutations that are robust, and pass the tests of un-keyed hashing, wherein, we can be assured that one bit of Message Input, if modified, cannot cause a distinguishable change of any variable bit or cluster of bits in the PRF (Pseudo Random Function) binary variables.

The ZK-Crypt PRF (Pseudo Random Function) 2000 comprises or consists of two multi-permutation interacting PRFs (Pseudo Random Functions). The 32 bit Word Manipulator 2060 if it were a standalone, would resemble a one-way symmetric encryption apparatus, with 30 permutations. The Random Controller 2020 serves both to randomly activate 31 other discrete permutations 8 of which are 32 bit random displacements; but also randomizes itself, with remote feedback from the Word Manipulator. The Result/Feedback Processor 2050 permutes input Message data with orthogonal feedback streams in a way that provably precludes Message Modification, e.g., it is provably impossible to move a decimal point and subsequently with a correcting Message reconcile the Chaining Value, the Hash Digest and the Hash Value.

Two initially randomized unique 32 bit Mersenne Prime Linear Feedback Shift Based HAIFA Counters 400 each put a unique random 2⁶³ count the flip flop variables, assuring that no sequence can be repeated; simultaneously whitening the Lower 510 and Super Tier 520 Orthogonal Feedback Streams.

According to certain embodiments, hash as described herein is used for authentication purposes and may or may not be used to encrypt a message before sending it.

It is appreciated that terminology such as “mandatory”, “required”, “need” and “must” refer to implementation choices made within the context of a particular implementation or application described here within for clarity and are not intended to be limiting since in an alternative implantation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software.

Also provided is a method for making any of the systems shown and described herein including providing all or any suitable subset of the system components shown and described herein, using any suitable conventional methodology, and a method for using any and all such systems and such components as would be apparent from the structure and function thereof as described herein.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

Features of the present invention which are described in the context of separate embodiments may also be provided in combination in a single embodiment. Conversely, features of the invention, including method steps, which are described for brevity in the context of a single embodiment or in a certain order may be provided separately or in any suitable sub-combination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, Home PNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps there within, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

1. A system for facilitating multi-step authenticated computerized customer motivated purchasing negotiations between populations of computerized buyer and vendor entities, the system including:
a buyer entity-controlled joint venture processor enabling a buyer entity in a population of computerized buyer entities, to present to at least one vendor entity in a population of computerized vendor entities, a first version of a proposed joint venture between the buyer entity and at least one vendor entity, the first version including a first set of values for each of a corresponding set of joint venture parameters; and
a vendor entity-controlled joint venture processor enabling a vendor entity in the population of computerized vendor entities, to receive the first version of the proposed joint venture from the buyer entity and to communicate to the buyer entity, a selectable communication from among a joint venture acceptance communication and a joint venture modification communication including a change of at least one value in said first set of values, thereby to define a second version of the proposed joint venture including a second set of values for each of the corresponding set of joint venture parameters,
wherein the buyer entity-controlled joint venture processor is also operative to enable the buyer entity to receive the second version of the proposed joint venture from the vendor entity and to communicate to the vendor entity, a selectable communication from among a joint venture acceptance communication and a joint venture modification communication including a change of at least one value in said second set of values as most recently received from the vendor entity-controlled joint venture processor, thereby to define an additional version of the proposed joint venture including an additional set of values for each of the corresponding set of joint venture parameters;
wherein the buyer entity-controlled joint venture processor and the vendor entity-controlled joint venture processor are operative to enable a chaining value of a robust one-way function hash authenticator that binds each previous step of the negotiation to the next negotiated steps, such that the hash value on the last typically contractual step can be signed by either or both entities with a public key signature function, thereby binding the at least one signing entity to the entire negotiated process.

2. A system according to claim 1, wherein the buyer entity-controlled joint venture processor and the vendor entity-controlled joint venture processor are operative to enable a one way authenticating function designed to preclude the necessity of a repeat of the previous authentication processes from the initialization state in the event of a transmission error of the last negotiated step, wherein, at each successful authentication the chaining value of the receiving entity is stored in a shadow memory operative to limit the repeat process on the faulty transmission to include only the authentication of the last negotiating stage, allowing transferring back of the stored reconciliation value from the shadow memory to the receivers chaining value' memory; ready to accept an authenticatable version of the transmission.

3. A system according to claim 1 and wherein at least one of the joint venture processors determines whether to communicate a joint venture acceptance communication or a joint venture modification message, using pre-programmed joint venture processor-specific accept vs. reoffer negotiating rules.

4. A system according to claim 1 wherein at least one of the joint venture processors is operative to communicate to the other of the joint venture processors, a selectable communication from a joint venture acceptance message, a joint venture modification message, and a joint venture refusal message.

5. A system according to claim 1 and wherein at least one of the joint venture processors determines whether and how to change at least one of the parameter values as most recently received from the other of the joint venture processors, using pre-programmed joint venture processor-specific re-offer generation rules.

6. A system according to claim 5 and wherein the pre-programmed re-offer generation rules comprise joint venture processor-specific rules for:
determining a joint venture partner desirability score based at least partly on parameter values as most recently received from the other of the joint venture processors;
determining weights of unit gaps between values presented by the first and second joint venture processors for each of the parameters, and
at least reducing gaps between values most recently presented by the first and second joint venture processors such that a sum of resulting gap reductions, over all parameters, respectively weighted by said weights, corresponds to said desirability score.

7. A system according to claim 6 wherein the sum of resulting gap reductions, over all parameters, respectively weighted by said weights, corresponds to said joint venture partner desirability score in that the greater the joint venture partner desirability score of an individual joint venture processor, computed using rules of a negotiating joint venture processor negotiating with the individual joint venture processor, the greater the gap reduction between values most recently presented by the individual and negotiating joint venture processors, that is mandated by the rules used by the negotiating joint venture processor.

8. A system according to claim 5 and wherein the pre-programmed re-offer generation rules comprise joint venture processor-specific rules for determining a joint venture partner desirability score of a specific joint venture processor based at last partly on prior knowledge regarding the specific joint venture processor.

9. A system according to claim 1 wherein said first entity-controlled joint venture processor interfaces with human users via a website including presenting information to and receiving information from, the human users.

10. A system according to claim 1 wherein the joint venture includes provision of a resource from a provider to a recipient and wherein the first entity, who presents the first version, comprises the recipient and the second entity comprises the provider.

11. A system according to claim 1 and wherein at least one of the joint venture processors determines whether and how to change at least one of the parameter values as most recently received from the other of the joint venture processors.

12. A system according claim 1 where in the first and second and any following multi-step negotiating steps; the negotiation data are authenticated with verifiable intermittent hash values; each of which is affixed to transmitted negotiation data; wherein each hash value is an encoding of a mutually known, to sender and receiver, constant value; decoding of an unaltered verifiable hash value by either sender or receiver reproduces the same mutually known constant at the end of each negotiation authentication procedure step.

13. A system according claim 1, wherein each step intermittent hash value is operable to verify the combined contents of negotiation data and hash values of all previous negotiation steps.

14. A system according to claim 1, wherein a first authenticated negotiated step is not accessible to a third party; said third party is unable to authenticate any or all subsequent negotiated steps.

15. A system according to claim 1, wherein the circuitry of both the sender and the receiver includes a shadow memory operative to record authenticated chaining values of transmitted negotiating steps; thereby to save the last authenticated chaining value of a negotiated transmission; operative to provide for joint venture continued authenticated negotiation procedures, irrespective at each step of whether the joint venturer is the sender or the receiver of the next negotiating procedure.

16. A system according to claim 1 wherein the circuitry of the receiver of a transmitted allegedly authenticated negotiating step detects a failed authenticating hash value; thereby causing an automatic re-insertion of the previous recorded authenticated chaining value from the shadow memory; thereby reconciling the receiver's faulty chaining value to the previous negotiation step true state chaining value; thereby enabling at least one further trial resend and a and one further trial hash value authentication of the previous failed transmission, potentially enabling continuation of the stream of authenticated negotiated frames. The reconciliation process is typically repeated, following the assumption that faulty authentication verification is a result of not perfect or not error corrected transmission means.

17. A system according to claim 1 and wherein one of the joint venture processors determines whether and how to change at least one of the parameter values as most recently received from the other of the joint venture processors, optionally using second joint venture changes to pre-programmed joint venture processor-specific re-offer generation rules.

18. A system according to any of claim 1 wherein the first and second and any following multi-step negotiating step is operative to regulate adaptations of second party agreement rules typically relevant to first party choice of agreement parameters.

19. A system according to claim 5 wherein the pre-programmed re-offer generation rules comprise joint venture processor-specific rules for determining a joint venture partner desirability score of a specific joint venture processor based at last partly on prior knowledge regarding the specific joint venturer and the specific joint venturer processor.

20. A computerized system for maintaining data integrity of an exchange of at least one computerized frame, each frame including at least one message, each message including at least one word, between first and second exchange participants, the system comprising:
a receiver operative for receiving at least a first message frame and a second hash value from the first participant;
a hasher operative for reconstructing a first hash value from the at least first message frame and the second hash value; and
an encoder operative for using said first hash value as a secret key for continued exchange of at least one frame with the first participant.
